(19) United States
(12) Patent Application Publication
(10) Pub. No.: US 2011/0224942 A1
(43) Pub. Date: Sep. 15, 2011

(54) GPS-tracking ground heat exchanger (GHE) performance test instrumentation network supporting a plurality of wireless portable GPS-based enthalpy-based GHE performance test instrumentation systems

(76) Inventor: John E. Kidwell, Tulsa, OK (US)

(21) Appl. No.: 12/798,827

(22) Filed: Apr. 12, 2010

Related U.S. Application Data
(63) Continuation-in-part of application No. 12/661,176, filed on Mar. 11, 2010.

(51) Int. Cl. G06F 15/00; F24J 3/08; G01K 17/00

(52) U.S. Cl. 702/136; 165/45; 702/188; 702/182

(57) ABSTRACT

A mobile-wireless GPS-tracking ground heat exchanger (GHE) performance test instrumentation network supporting a plurality of wireless portable GPS-based enthalpy-based GHE performance test instrumentation systems, each being connectable to a ground heat exchanger (GHE) installation, and capable of collecting GPS-indexed performance data relating to the heat transfer rate (HTR), flow work rate (FWR), energy efficiency ration (EER)/coefficient of performance (COP), and heat transfer efficiency (HTE) of a ground heat exchanger (GHE) installation under performance testing.

### RELATED CASES

The present application is a Continuation-in-Part of copending U.S. application Ser. No. 12/661,176 filed Mar. 11, 2010, and assigned to Kelix Heat Transfer Systems, LLC, incorporated herein by reference as if set forth fully herein.

### BACKGROUND OF THE INVENTION

1. Field of Invention

The present invention relates to improved methods of and apparatus for measuring the energy conversion performance of ground heat exchangers (GHEs) and ground loop heat exchangers (GLHE) installed in deep Earth environments, and improved methods of and apparatus for engineering geothermal ground loop subsystems using the same.

2. Brief Description of the State of Knowledge in the Art

In general, most geothermal system engineering projects involve four phases, namely: analysis/planning; design; implementation/construction; and testing.

The analysis and planning phase involves determining the size of the total thermal load that the geothermal system under design must handle during heating and/or cooling modes of operation. During this stage, the thermal loads of individual heat sources and sinks in the building environment are identified and modeled, using conventional software tools, to estimate total load during heating and cooling seasons. There are many excellent tools and methods currently available for supporting this phase of the systems engineering project.

During the design and construction phases, the designer and engineer currently have several vertical-type ground heat exchanger (GHE) technology options available, namely: “closed-loop” vertical U-tube construction; “closed-loop” vertical concentric-tube construction; and “open-loop” standing column well construction.

While open-loop standing column well heat exchangers are known to have excellent performance characteristics, they are typically very expensive to construct and can present serious environmental risks to groundwater and aquifers, making this technology an unpopular choice in many geographic regions.

In contrast, closed-loop vertical U-tube ground heat exchangers have gained great popularity over the past two decades, and have eclipsed conventional closed-loop concentric tube ground heat exchangers. Notably, such growth in U-tube ground heat exchangers has occurred despite the fact that (i) concentric-type heat exchangers have been shown to exhibit greater heat transfer performance capacities than U-tube ground heat exchangers, and (ii) U-tube ground heat exchangers typically require significantly greater borehole drilling depths than concentric-tube ground heat exchangers, to achieve a given amount of heat transfer capacity measured in [BTUs/Hr] or [Tons].

Over the past 25 years, a number of conventional software tools have been developed in Sweden and in the USA, to assist in the design of ground loop heat exchangers (GLHEs) for commercial and institutional buildings, using U-tube and concentric-tube ground heat exchanger (GHE) technology.

Currently, the most popular PC-based software systems support a three-dimensional computer “simulation” of the temperature response of various proposed ground loop heat exchange (GLHE) configurations, each comprising an arrangement of thermally-interacting vertical ground heat exchangers (GHEs) having a particular borehole depth and spacing between neighboring boreholes—and specified by a geometry-dependent thermal response function, called its g-function. To date, over a thousand different g-functions have been developed for ground loop heat exchanger (GLHE) configurations to help ground loop designers and engineers meet the thermal load and ground loop field layout requirements of diverse commercial and institutional geothermal projects.

Such computer simulation systems employ a mathematical heat transfer model for each constituent ground heat exchanger (GHE), based on either the “finite line-source” or “infinite line-source” method, which uses an average “thermal conductivity” parameter [BTU/Hr-ft-° F.], and “thermal diffusivity” parameter [ft²/sec] for the ground which must be measured in the field through in situ testing procedures. During set up operations, these simulation systems request empirically measured thermal conductivity and thermal diffusivity values, along with other ground input parameters, such the deep Earth's volumetric heat capacity [BTU/ft³-F], and if not available, offer the user a list of options from a database.

The aim of such ground loop computer simulation tools is to three-fold: (i) predict the temperature field intensity at the boreholes of various ground heat exchanger configurations (specified by g-functions) to expected monthly heating and cooling loads and monthly peak heating and cooling demands, up to a hundred years; (ii) based on the predicted temperature gradients at each borehole, estimate the transfer of heat energy injected into the deep Earth during cooling demands, and extracted from the deep Earth during heating demands, and account for heat energy injections into and extractions from the thermal mass of simulated ground loop field, for up to 100 years; and (iii), adjust the ground loop heat exchanger (GLHE) configurations and sizes during simulation operations to meet user-specified minimum or maximum heat pump entering fluid temperatures, while satisfying the required heating and cooling loads supplied as input to the computer simulation system.

Based on theoretical simulations of proposed ground loop configurations, the ground loop engineer is urged to select, for construction, the ground loop field configuration having the best simulated performance.

However, it should be noted that all conventional ground loop simulation systems make several simplifications and assumptions during borehole temperature and heat transfer simulations, which cannot not be ignored without risk of predictive error.

First, conventional computer simulation systems assume that the deep-Earth environment is homogeneous over the depths of modeling involved (e.g. 0-600 feet deep) which is certainly not true for most geological environments, which include many geological strata.

Secondly, such computer simulation systems completely ignore the presence of underground water, including aquifers, and the effects that such resources have on the thermal conductivity and diffusivity properties of the Earth's mass in ground loop fields, and the transfer of heat energy by operation of thermal transfer and groundwater hydraulics.

Thirdly, such computer simulation systems assume that the temperature along each ground heat exchanger (i.e. borehole) is constant along its length, which is certainly not the case for concentric-tube ground heat exchangers which exchange heat energy with the deep Earth along its outer flow channel as the water flows back up towards the surface of the Earth.

Also, as a general rule, conventional ground loop simulation systems only employ in situ methods for estimating the thermal conductivity and thermal diffusivity parameters for the ground environment, where a GLHE is being designed and planned for construction. Then, the computer simulation uses these estimated ground parameters to predict the temperature characteristics of the boreholes in different ground loop heat exchanger (GLHE) configurations, generated in response to the expected thermal loads of the building involved in the simulation.

While conventional ground loop simulation systems represent the industry's best efforts to mathematically model and simulate the performance characteristics of potential ground loop heat exchanger (GLHE) arrangements, using analytical and numerical solutions to the thermal problems which they address, the simplifications and assumptions made such by such software simulation systems do not recognize the complex realities of most ground loop heat exchanger (GLHE) environments.

Also, conventional ground heat exchangers (GHEs) have not been designed or constructed to perform with heat energy transferring efficiencies or capacities as otherwise physically and thermodynamically possible.

Also, conventional techniques for in situ measurement of the thermal conductivity and thermal diffusivity of the ground environment have not provided adequate insight into the actual performance of GHEs and GLHEs in particular deep Earth environments in which they are installed.

Consequently, the available thermal energy reserves stored within deep Earth environments have not been fully, efficiently and economically harnessed for cooling and heating applications, placing the benefits of geothermal energy out of the hands of most in America and around the world.

Thus, there has been a great need in the geothermal ground source heat pump industry for an alternative approach to conventional “simulation-driven” ground loop design methodologies, including better ways to measurement the performance of ground heat exchangers (GHEs) and ground loop heat exchangers (GLHEs), while avoiding the shortcomings and drawbacks of prior art apparatus and methodologies.

### OBJECTS AND SUMMARY OF THE PRESENT INVENTION

Accordingly, it is a primary object of the present invention to provide a new and improved method of and apparatus for designing and constructing geothermal ground loop subsystems, free of the shortcomings and drawbacks of prior art apparatus and methodologies.

Another object of the present invention is to provide a new and improved apparatus for in situ measuring the capacity of ground heat exchanger installations to transfer heat energy with the surrounding deep Earth environment.

Another object of the present invention is to provide a new and improved method of in situ measuring the capacity of ground heat exchanging system installations to transfer heat energy with the surrounding deep Earth environment.

Another object of the present invention is to provide such a method of in situ measuring the capacity of concentric-tube and U-tube type ground heat exchanging systems installed in diverse deep Earth environments.

Another object of the present invention is to provide a new and improved spreadsheet enthalpy-based heat transfer rate calculator program for use in measuring the performance of ground heat exchanging systems installed in deep Earth environments.

Another object of the present invention is to provide a new and improved apparatus for heating a controlled flow of water during an enthalpy-based method of measuring the heat transfer rate of a ground heat exchanging system installed in a deep Earth environment.

Another object of the present invention is to provide a new and improved method designing and constructing a geothermal ground loop subsystem using ground heat exchangers that have been assigned heat transfer rate (HTR) performance characteristics that have been empirically-tested in particular deep Earth environments.

Another object of the present invention is to provide a recursive-type method designing and constructing a geothermal ground loop subsystem involving (i) designing a preliminary ground loop subsystem design using ground heat exchangers that have been assigned heat transfer rate (HTR) performance characteristics determined through empirical performance testing in particular deep Earth environments, (ii) then installing at least one such ground heat exchanger in a deep Earth environment at a ground loop field test site and measuring its actual heat transfer rate performance characteristics, and (iii) modifying the preliminary ground loop subsystem design using the actual heat transfer rate performance characteristics empirically determined for the ground loop field test site.

Another object of the present invention is to provide a method and apparatus for better guaranteeing geothermal system performance, as required in performance-contract based energy saving programs.

Another object of the present invention is to provide novel methods of and instrumentation for measuring the heat transfer rate (HTR), flow work rate (FWR) and energy efficiency ratio (EER), and heat transfer efficiency (HTE) of ground heat exchanger (GHE) installations so that engineers can make rational decisions on whether or not to use a particular class, type or design of ground heat exchanger to construct a ground loop heat exchanging (GLHE) subsystem for a particular geothermal system project, planned for construction at a specific ground loop site.

Another object of the present invention is to provide a wireless portable ground heat exchanger (GHE) performance testing and monitoring system capable of acquiring performance data on ground heat exchanger (GHE) installations, in diverse geological environments and operating environments, so that empirical heat transfer rate (HTR) surveys can be produced using a standardized closed-loop concentric-type ground heat exchanger (GHE).

Another object of the present invention is to provide a such wireless ground heat exchanger performance testing and monitoring system for documenting the performance characteristics of test ground heat exchangers (GHEs) installed in diverse geological and operating environments, and providing geothermal engineers with a useful performance data to help design and construct high-performance ground loop heat exchangers (GLHEs) of optimized design.

Another object of the present invention is to provide a method of measuring and recording incremental changes in the deep Earth temperature in a ground loop test site, using multiple portable enthalpy-based ground heat exchanger test systems.

Another object of the present invention is to provide an Internet-based Network of Wireless Enthalpy-Based GPS-Tracking Ground Heat Exchanger (GHE) Performance Test Instrumentation Systems deployed over the Earth, and communication with a centralized data logging and recording station, and accessible by a remote database server and a plurality of client systems supporting Web-based communication interfaces.

Another object of the present invention is to provide a method of creating a GPS-indexed heat transfer rate (HTR) performance database using empirically obtained heat transfer rate (HTR) performance surveys taken using a closed-loop concentric-type ground heat exchanger and GPS-tracking enthalpy-based HTR performance test instrumentation, so that geothermal engineers have empirical knowledge of the potential capacity of specific regions of Earth mass to exchange heat energy with such types of ground heat exchangers, based on scientific research and empirical investigation.

Another object of the present invention is to provide a method of creating a GPS-indexed heat transfer rate (HTR) performance database, by combining empirical heat transfer rate (HTR) measurements with spatially corresponding hydro-geological measurements of underground ground water conditions.

Another object of the present invention is to provide a method of and apparatus for in situ measuring the thermal banking characteristics of a ground heat exchanging system installed within a deep Earth environment.

Another object of the present invention is to provide a method of and apparatus for in situ measuring the thermal storage capacity characteristics of a ground heat exchanging system installed within a deep Earth environment, during performance testing operations.

Another object of the present invention is to provide a novel method of measuring and creating records of deep Earth temperature changes in the ground loop field of a geothermal heat pump system.

Another object of the present invention is to provide a novel method of creating GPS-indexed heat transfer rate (HTR) performance measurement maps of the Earth's subsurface.

Another object of the present invention is to provide a method of performance-based ground loop engineering, that employs scientific instruments and techniques to measure and gauge the actual performance of GHE installations on ground loop construction sites, prior to designing GHLE systems for construction.

Another object of the present invention is to provide a portable enthalpy-based ground heat exchanger (GHE) performance test instrumentation system, and enthalpy-based ground heat exchanger (GHE) performance calculator program, which allows ground loop engineers to accurately measure four very useful performance figures for ground heat exchangers (GHEs) and ground loop heat exchanging (GLHE) systems.

Another object of the present invention is to provide performance-based ground loop engineering techniques that provide a better way to design and construct high-performance ground loop subsystems in diverse geological conditions, and also predict and verify the performance characteristics of such subsystems during the lifetime of geothermal systems in they are deployed.

Another object of the present invention is to provide a portable enthalpy-based test instrumentation system that measures the Heat Transfer Rate (HTR) of any ground heat exchanger, measured in units of [BTU/Hr], and based on the volume/mass flow rate and the inlet and outlet temperature and pressure of water flowing through the ground heat exchanger during performance testing operations.

Another object of the present invention is to provide a portable enthalpy-based test instrumentation system that measures the Flow Work Rate (FWR) of any ground heat exchanger, measured in units of [BTU/Hr] and [HP], and based on the volume/mass flow rate and the inlet and outlet pressure of water flowing through the ground heat exchanger during performance testing operations.

Another object of the present invention is to provide a portable enthalpy-based test instrumentation system that measures the Energy Efficiency Ratio (EER)) of any ground heat exchange (GHE), measured in dimensionless units, and equal to the ratio of the empirically measured HTR and FWR of the GHE during performance testing operations. Essentially, the EER for a GHE, as well as a GLHE subsystem, is a coefficient of performance (COP) measure, based on the ratio of desired (heat) output [BTU/Hr] to the required work (energy) input [BTU/HR].

Another object of the present invention is to provide a portable enthalpy-based test instrumentation system that measures the Heat Transfer Efficiency (HTE) of any ground heat exchanger (GHE) installation, measured in dimensionless units, and equal to the ratio of (i) the empirically-measured enthalpy difference between the inlet and outlet ports of the GHE when input and outlet water temperatures are unequal and in thermal equilibrium, to (ii) the ideal enthalpy difference between the inlet and outlet ports of the GHE when outlet water temperature is equal to and in thermal equilibrium with the deep Earth temperature about the GHE.

Another object of the present invention is to provide a portable enthalpy-based test instrumentation system which provide new forms of thermodynamic evidence which engineers can use when recommending a particular geothermal system design as part of an energy-saving building solution, based on an energy savings performance contract, demanding specific levels of performance and accountability during its lifetime.

Another object of the present invention is to provide a enthalpy-based test instrumentation system that measures the HTR, FWR, EER and HTE measures of performance for ground loop heat exchanging (GLHE) subsystems formed from an arrangement of GHEs, based on similar measurements taken on the GLHE subsystem, providing a new and improved way of assessing the performance of GLHEs.

Another object of the present invention is to provide a portable enthalpy-based test instrumentation system that can be used to test the performance of virtually all types of concentric-tube ground heat exchangers, as well as U-tube ground heat exchangers installed in boreholes up to 500 feet deep, in diverse deep Earth environments.

Another object of the present invention is to provide a portable enthalpy-based test instrumentation system which measures, during a performance test, the average deep Earth temperature of the test site, thermal banking characteristics of the test ground heat exchanger (GHE), as well as its HTR, FWR, EER (COP) and HTE performance figures, which can be used to a design ground loop heat exchanging (GLHE) subsystem for construction at the test site.

Another object of the present invention is to provide a method of ground loop engineering involving the use of ground heat exchangers (GHEs) that have been assigned heat transfer rate (HTR) performance characteristics determined through empirical performance testing in particular deep Earth environments.

Another object of the present invention is to provide a method of ground loop engineering for medium-to-large scale projects, involving a recursive-type method used to design and construct ground loop subsystems.

Another object of the present invention is to provide such a method of ground loop engineering involving first designing a preliminary GLHE subsystem using ground heat exchangers (GHEs) assigned heat transfer rate (HTR) performance characteristics determined through empirical performance testing in particular deep Earth environments; then, at least one such ground heat exchanger (GHE) is installed in the deep Earth environment at a ground loop field test site, and its actual heat transfer rate (HTR) performance characteristics are measured; and thereafter, the preliminary GLHE subsystem design is modified using the actual heat transfer rate performance characteristics empirically determined for the ground loop field test site.

These and other objects of the present invention will become apparent hereinafter and in the Claims to Invention appended hereto.

### BRIEF DESCRIPTION OF THE DRAWINGS

For a more complete understanding of how to practice the Objects of the Present Invention, the following Detailed Description of the Illustrative Embodiments can be read in conjunction with the accompanying Drawings, briefly described below.

FIG. 1A is a schematic illustration view showing the Portable Enthalpy-Based GHE Performance Test Instrumentation System of the present invention connected to a geothermal ground heat exchanger (GHE) installed in a deep Earth environment, during heat transfer rate (HTR), flow work rate (FWR), energy efficiency ratio (ERR), and heat transfer efficiency (HTE) energy-based performance testing operations, using a RF transceiver station to receive measured inlet and outlet temperatures and pressures and mass flow rates through the ground loop, and a remote data logger/recorder and database server, operably connected to the infrastructure of the Internet, for processing collected data and computing performance measures in accordance with the principles of the present invention so that one or more Web-enabled remote client computers can access such performance data and generated reports for ground loop system engineering purposes;

FIG. 1B is a schematic diagram of the Portable Enthalpy-Based GHE Performance Test Instrumentation System shown in FIG. 1B, operably connected to a concentric-tube type geothermal ground heat exchanger, and showing its primary components, namely, a ground loop water pumping module, a ground loop pumping and heating module, a power relay control module, a data logger/recorder, a portable computer system interfaced with the data logger/recorder and running a spreadsheet enthalpy-based spreadsheet GHE performance (i.e. HTR/FWR/EER) calculator program, and a system controller for controlling the components of the enthalpy-based GHE Performance Test Instrumentation System;

FIG. 2A is a schematic diagram of the Portable Enthalpy-Based GHE Performance Test Instrumentation System of FIGS. 1A and 1B, illustrating the location of its temperature and pressure transducers and mass/volume flow rate meter, and the various subcomponents of the concentric-tube ground heat exchanger to which its connected by way of its system inlet and outlet pipes;

FIG. 2B is a schematic diagram of the Portable Enthalpy-Based GHE Performance Test Instrumentation System of FIGS. 1A, 1B and 2A, illustrating the various subcomponents of the ground loop water heating module including its electrically-powered heating elements, and the ground loop pumping module and its hand-operated fluid flow balancing valve, configured together for supplying a constant flow of water to the ground heat exchanger (GHE) at a constant inlet (i.e. entering) temperature during heat transfer rate (HTR), flow work rate (FWR), energy efficiency ratio (EER) and heat transfer efficiency (HTE) performance testing operations supported by the Enthalpy-Based GHE Performance Test Instrumentation System;

FIG. 3 schematic diagram of the Portable Enthalpy-Based GHE Performance Test Instrumentation System of FIGS. 1A and 1B, shown connected to a conventional U-tube type ground heat exchanger by way of its system inlet and outlet pipes, and supplying a constant flow of water to the ground heat exchanger, at a constant inlet temperature during HTR and FWR performance testing operations;

FIG. 4 is a schematic representation of an energy conservation balance conducted for a generalized thermodynamic system involving heat transfer rate and work rate functions;

FIG. 4A is a schematic representation of an energy conservation balance conducted for any concentric-type ground heat exchanging system when operating at temperatures Tᵢₙ≠Tₒᵤₜ≠T_{de} with Tᵢₙ=95° F. and the system is at thermal equilibrium;

FIG. 4B is a schematic representation of an energy conservation balance conducted for any U-tube type ground heat exchanging system when operating at temperatures Tᵢₙ≠Tₒᵤₜ≠T_{de} with Tᵢₙ=95° F. and the system at thermal equilibrium;

FIG. 5A is a schematic representation defining the system boundaries/control volume for any concentric-type ground heat exchanging system, being analyzed for energy conservation balance as illustrated in FIG. 4A;

FIG. 5B is a schematic representation defining the system boundaries/control volume for any U-tube type ground heat exchanging system, being analyzed for energy conservation balance as illustrated in FIG. 4B;

FIG. 6A is a schematic representation defining the system boundaries/control volume for ground loop water pumping and heating module, being analyzed for energy conservation balance as illustrated in FIG. 6B, when operating at temperatures Tᵢₙ≠Tₒᵤₜ≠T_{de} with Tᵢₙ=95° F. and the system is at thermal equilibrium;

FIG. 6B is a schematic representation of an energy conservation balance conducted for the ground loop water pumping and heating module of FIG. 6A when operating at temperatures Tᵢₙ≠Tₒᵤₜ≠T_{de} with Tᵢₙ=95° F. and the system is at thermal equilibrium;

FIG. 7A is a schematic representation defining the system boundaries/control volume for any concentric-type ground heat exchanging (GHE) system, being analyzed for energy conservation balance when operating at temperatures Tᵢₙ=Tₒᵤₜ=T_{de} and the system is at thermal equilibrium;

FIG. 7B is a schematic representation defining the system boundaries/control volume for any concentric-tube type ground heat exchanging system, being analyzed for energy conservation balance as illustrated in FIG. 7A;

FIG. 7C is a schematic representation defining the system boundaries/control volume for any U-tube ground heat exchanging (GHE) system, being analyzed for energy conservation balance when operating at temperatures Tᵢₙ=Tₒᵤₜ=T_{de} and the system is at thermal equilibrium;

FIG. 7D is a schematic representation of an energy conservation balance conducted for any U-tube ground heat exchanging system, being analyzed for energy conservation balance when operating at temperatures Tᵢₙ=Tₒᵤₜ=T_{de} and the system is at thermal equilibrium;

FIG. 7E is a schematic representation defining the system boundaries/control volume for the ground loop water pumping and heating module, being analyzed for energy conservation balance, depicted in FIG. 7F, when operating at temperatures Tᵢₙ=Tₒᵤₜ=T_{de} and the system is at thermal equilibrium;

FIG. 7F is a schematic representation of an energy conservation balance conducted for the ground loop water pumping and heating module of FIG. 7E, when operating at temperatures Tᵢₙ=Tₒᵤₜ=T_{de} and the system is at thermal equilibrium;

FIG. 7G is a schematic representation of an energy conservation balance conducted for any “real” concentric-tube or U-tube ground heat exchanger (GHE) system when operating at temperatures Tᵢₙ≠Tₒᵤₜ≠T_{de} the system is at thermal equilibrium;

FIG. 7H is a schematic representation of an energy conservation balance conducted for any “ideal” concentric-tube or U-tube ground heat exchanger (GHE) system when operating at temperatures Tᵢₙ≠Tₒᵤₜ=T_{de} and the system is at thermal equilibrium;

FIG. 7I is a definition of heat transfer efficiency (HTE) for any concentric-tube or U-tube ground heat exchanger (GHE) based on the measured enthalpy of water entering and leaving the ground heat exchanger (GHE);

FIGS. 8A through 8F, taken together, provide a flow chart describing the primary steps of the method of measuring the heat transfer rate (HTR), flow work rate (FWR) and the energy efficient ratio (EER) of a ground heat exchanger (GHE) installation, using the Portable Enthalpy-Based GHE Test Instrumentation System shown in FIGS. 1A through 2B;

FIG. 9 is a table listing the specific enthalpy (h) values of sub-cooled water over a particular range of pressure and temperature values, expressed in units of [BTUs/lbm];

FIG. 10 is a schematic representation of the graphical user interface (GUI) component of the spreadsheet enthalpy-based GHE performance calculator program of the present invention, used to calculate the actual heat transfer rate (HTR), flow work rate (FWR), energy efficiency ratio (EER) and the heat transfer efficiency (HTE) energy-based performance figures for a ground heat exchanger (GHE) installation under performance testing;

FIG. 11 is schematic representation illustrating multiple of Portable Enthalpy-Based GHE Performance Test Instrumentation Systems being used to measure incremental changes in deep Earth temperature about a ground heat exchanger (GHE) installation, in response to thermal influences from the thermal loads of neighboring ground heat exchanger (GHE) installations;

FIGS. 12A and 12B are a flow chart describing the primary steps of the method of measuring incremental changes of deep Earth temperature about a ground heat exchanger (GHE) installation in response to thermal influences from the thermal loads of neighboring ground heat exchanger (GHE) installations, at a test site as schematically depicted in FIG. 11, using multiple Portable Enthalpy-Based Ground Heat Exchanger Test Systems, shown in FIGS. 1A through 2B;

FIG. 13 is a schematic representation of the globally-extensive, Mobile-Wireless GPS-Tracking Ground Heat Exchanger (GHE) Performance Test Instrumentation Network of the present invention comprising a plurality of wireless Portable GPS-Based Enthalpy-Based GHE Performance Test Instrumentation Systems, each being connectable to a ground heat exchanger (GHE) installation, and capable of collecting GPS-indexed performance data relating to the heat transfer rate (HTR), flow work rate (FWR), energy efficiency ration (EER)/coefficient of performance (COP), and heat transfer efficiency (HTE) of a ground heat exchanger (GHE) installation under performance testing;

FIG. 14A is a schematic representation of a first completed geothermal heat pump system including a ground loop heat exchanging (GLHE) subsystem employing a pair of ground heat exchangers (GHEs) installed in the loop field and connected together via underground piping to a geothermal heat pump and associated ground loop water pumps, and showing an Enthalpy-Based Ground Loop Performance Monitoring Module of the present invention, mounted within the pump room of a building in which the completed geothermal heat pump system has been installed and is operating, in cooperation with its air handling subsystem, under the control of the central environmental control system of the building;

FIG. 14B is a schematic representation defining the system boundaries/control volume for the completed geothermal heat pump system and associated ground loop of FIG. 14A, being analyzed for energy conservation balance when operating at temperature Tᵢₙ≠Tₒᵤₜ≠T_{de} and the system is otherwise in a state of thermal equilibrium or quasi-equilibrium; and

FIG. 15 is schematic representation of a second completed geothermal heat pump system including a ground loop heat exchanging (GLHE) subsystem employing five ground heat exchangers (GHEs) installed in the loop field and connected together via underground piping and manifolds to the ground loop water pumps of five geothermal heat pumps, and showing an Enthalpy-Based Ground Loop Performance Monitoring Module of the present invention configured to monitor and record the performance of the GLHE subsystem during geothermal system operation.

### DETAILED DESCRIPTION OF THE ILLUSTRATIVE EMBODIMENTS OF THE PRESENT INVENTION

Referring to the figures in the accompanying Drawings, the various illustrative embodiments of the Portable Enthalpy-Based GHE Performance Test Instrumentation System, and HTR test method of the present invention, will be described in great detail, wherein like elements will be indicated using like reference numerals.

### Brief Overview on Designing and Constructing Geothermal Ground Loop Heat Exchanging (GLHE) Subsystems Using the Performance-Based Ground Loop Engineering (GLE) Process of the Present Invention

The performance-based ground loop engineering (GLE) process according to the present invention provides a practical way to engineer high-performance ground loop heat exchanging (GLHE) subsystems from component ground heat exchangers (GHEs). It recognizes that all GHEs and GLHE subsystems follow basic principles of energy conservation established by the laws of thermodynamics. It demands empirical knowledge of the actual heat transfer rate (HTR) performance of a GHE installation in its deep Earth environment, prior to designing and constructing a GLHE subsystem employing the GHE as a system component. It also demands that such knowledge be acquired using scientific principles that have helped engineers design and construct fossil-fueled steam power plants, gas turbine jet engines, spark-ignition reciprocating engines, and the Saturn rocket which took Man to the Moon.

The GLE Process of the present invention involves learning the following techniques:

(1) how to use the Portable Enthalpy-Based Ground Heat Exchanger (GHE) Performance Test Instrumentation System of the present invention, and its Enthalpy-Based GHE Performance Test Methods at ground loop test sites around the world;

2) how to accurately and reliably measure the average deep Earth temperature T_{de} about any test site borehole, and four (4) important “energy” performance characteristics of any GHE test installation, allowing for objective comparisons against competing GHE technologies, installed at the same location;

(3) how to design and construct high-performance ground loop heat exchanging (GLHE) subsystems, based on the actual energy performance measurements of a GHE test installation, taken at a ground loop test site using the Portable Enthalpy-Based Ground Heat Exchanger (GHE) Performance Test Instrumentation System and Methods of the present invention;

(4) how to test and tune an GLHE subsystem after it is installed and operating with its geothermal heat pump, chiller and/or HVAC equipment; and

(5) how to monitor and record the energy performance characteristics of GLHE subsystems during the lifetime of the geothermal systems to which they are connected.

It is appropriate as this juncture to concisely review the four “energy performance measurements” taken by the Portable Enthalpy-Based Ground Heat Exchanger (GHE) Performance Test Instrumentation System of the present invention, when carrying out a performance test on any ground heat exchanger (GHE) installation, in accordance with the GLE Process.

The first energy performance measurement is the Heat Transfer Rate (HTR) of any ground heat exchanger (GHE) installation, measured in units of [BTU/Hr], and based on the volume/mass flow rate and the inlet and outlet temperature and pressure of water flowing through the ground heat exchanger during performance testing operations.

The second performance figure is the Flow Work Rate (FWR) of any GHE installation, measured in units of [BTU/Hr], and based on the specific volume of water, the mass flow rate through the GHE, and the inlet and outlet pressure of water flowing through the GHE during performance testing operations.

The third performance figure is the Energy Efficiency Ratio (EER) of any GHE installation, measured in dimensionless units, and equal to the ratio of the empirically (i.e. experimentally) measured HTR and FWR of the GHE installation during performance testing operations. Essentially, the EER for a GHE, as well as a GLHE subsystem, is its coefficient of performance (COP) measure, based on the ratio of desired (heat) output [BTU/Hr] to the required work (energy) input [BTU/HR].

The fourth performance figure is the Heat Transfer Efficiency (HTE) of any GHE installation, measured in dimensionless units, and equal to the ratio of (i) the actual real (empirically-determined) enthalpy difference between the inlet and outlet ports of the GHE when input and outlet water temperatures are unequal and in thermal equilibrium, to (ii) the ideal enthalpy difference between the inlet and outlet ports of the GHE when outlet water temperature is equal to and in thermal equilibrium with the deep Earth temperature about the GHE installation.

When used in conjunction with the techniques of the GLE Process, these energy-based performance figures (i.e. HTR, FWR, EER and HTE) provide a superior way to measure the energy performance characteristics of any GHE test installation, and GLHE subsystems constructed from such GHEs, in diverse geological conditions, anywhere around the world.

When used in conjunction with the deep Earth temperature at the ground loop test site, these GHE performance figures provide a new form of evidence which engineers can use with confidence to recommend a particular GLHE subsystem design, typically as part of an energy-saving building solution, which might be based on an energy savings performance contract demanding specific levels of performance and accountability over its lifetime.

By design, the Portable Enthalpy-Based GHE Performance Test Instrumentation System can be used to test the performance of virtually any kind of concentric-tube ground heat exchanger, as well as any kind of U-tube ground heat exchanger (GHE) installed in boreholes up to 500 feet deep, in diverse deep Earth environments.

At the end of each GHE performance test, the Portable Enthalpy-Based Test Instrumentation System generates a Performance Test Report containing all of performance figures (HTR, FWR, EER/COP and HTE) measured during the test.

This Performance Test Report is then used by engineers to a design and construct a ground loop heat exchanging (GLHE) subsystem at the test site, following the Performance-Based Ground Loop Engineering Process of the present invention.

For small-scale geothermal projects (i.e. having thermal loads of less than 15 tons), a library-based method is recommended to design and construct ground loop subsystems. This method involves using ground heat exchangers (GHEs) assigned average heat transfer rate (HTR) performance characteristics, through empirical performance testing in various deep Earth environments.

For medium-to-large scale projects (i.e. having thermal loads of 15 or more tons), a recursive-type method is recommended to design and construct ground loop subsystems. This method involves first designing a preliminary GLHE subsystem using GHEs assigned average heat transfer rate (HTR) performance characteristics determined through empirical performance testing in particular deep Earth environments. Then, at least one GHE is installed in the deep Earth environment at the ground loop field test site, where its actual heat transfer rate (HTR), flow work rate (FWR), energy efficiency ratio (EER) and heat transfer efficiency (HTE) energy performance characteristics are measured—using the Portable Enthalpy-Based Test Instrumentation System and Method of the present invention. Thereafter, the preliminary GLHE subsystem design is modified using the actual performance characteristics of the GHE, empirically determined for the specific ground loop field test site under testing and analysis.

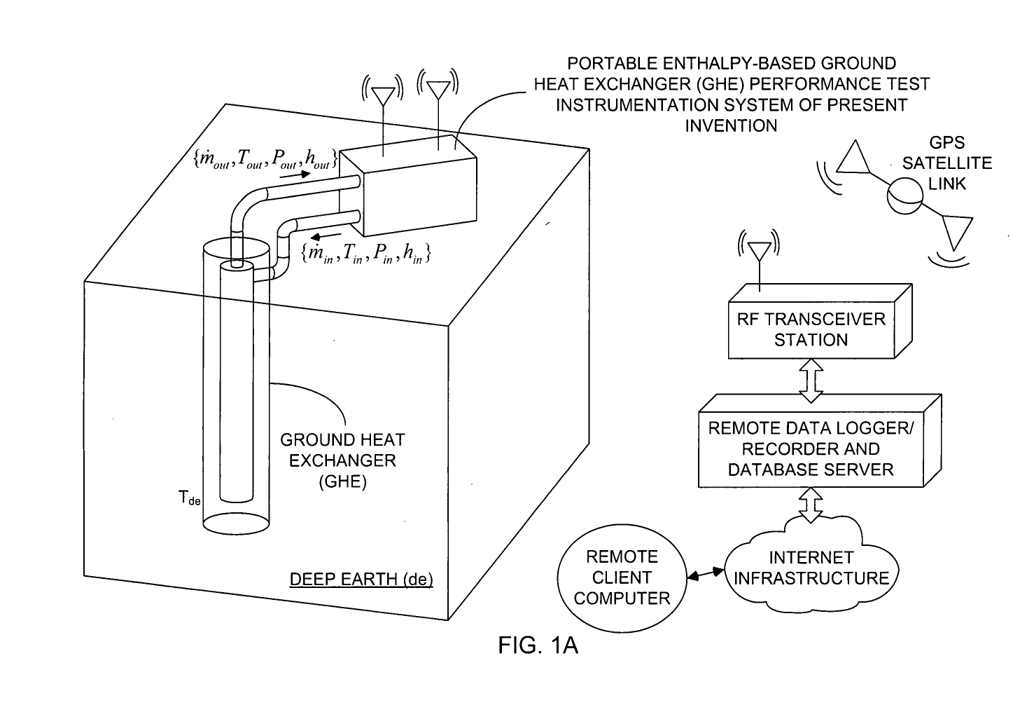

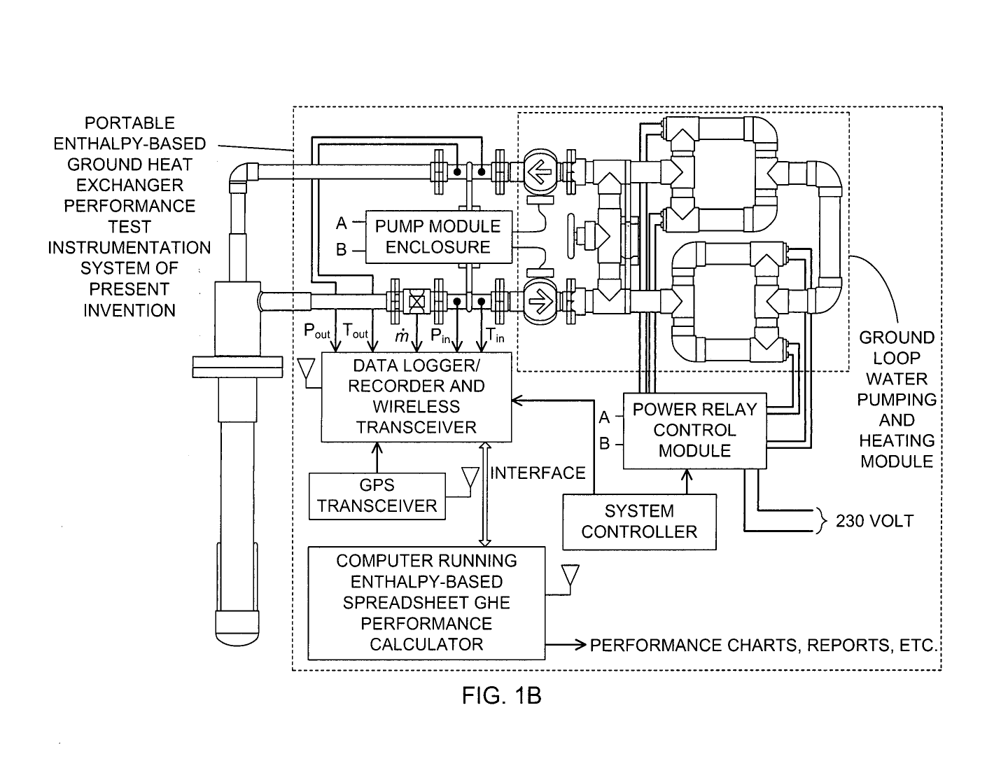

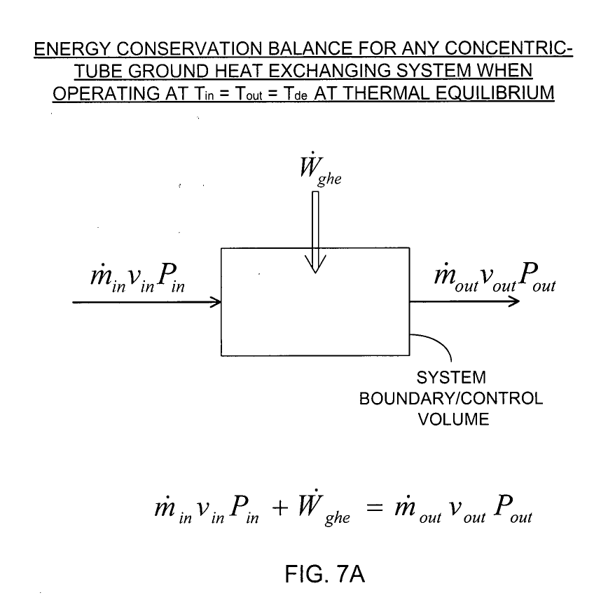

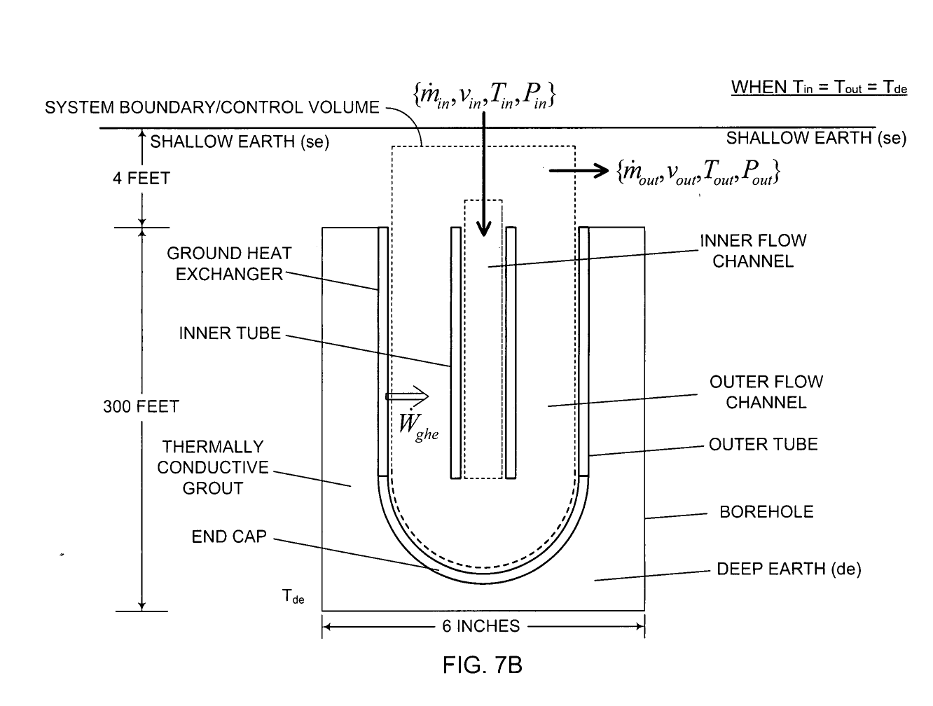

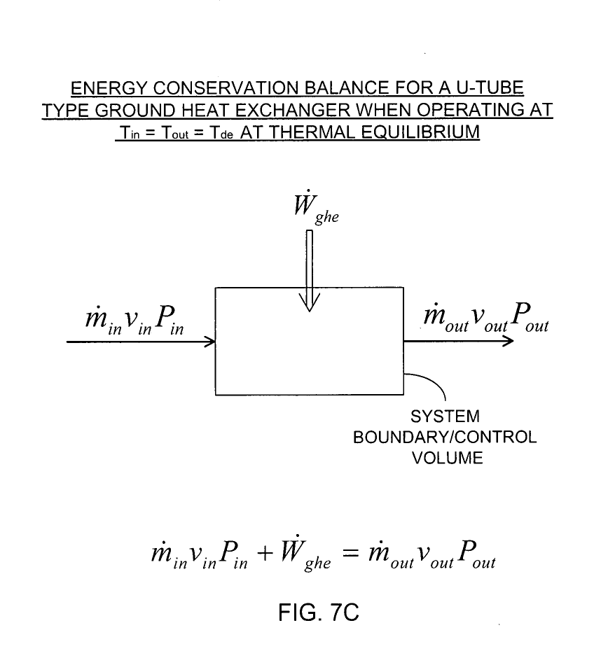

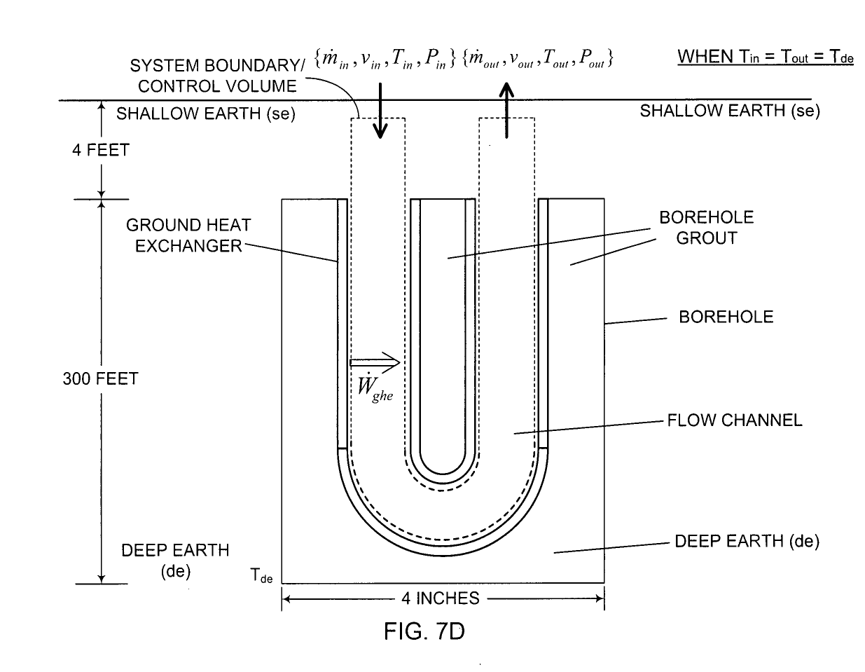

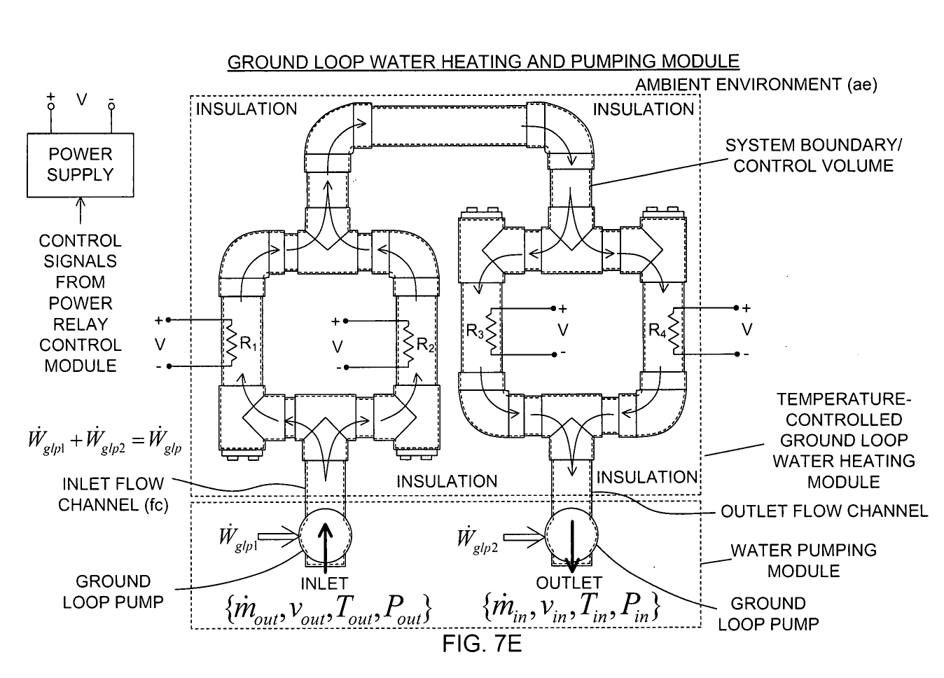

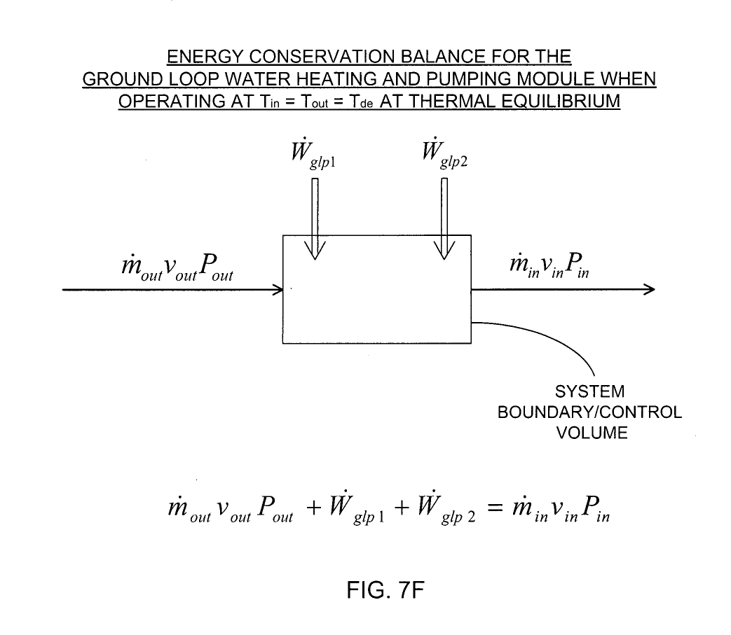

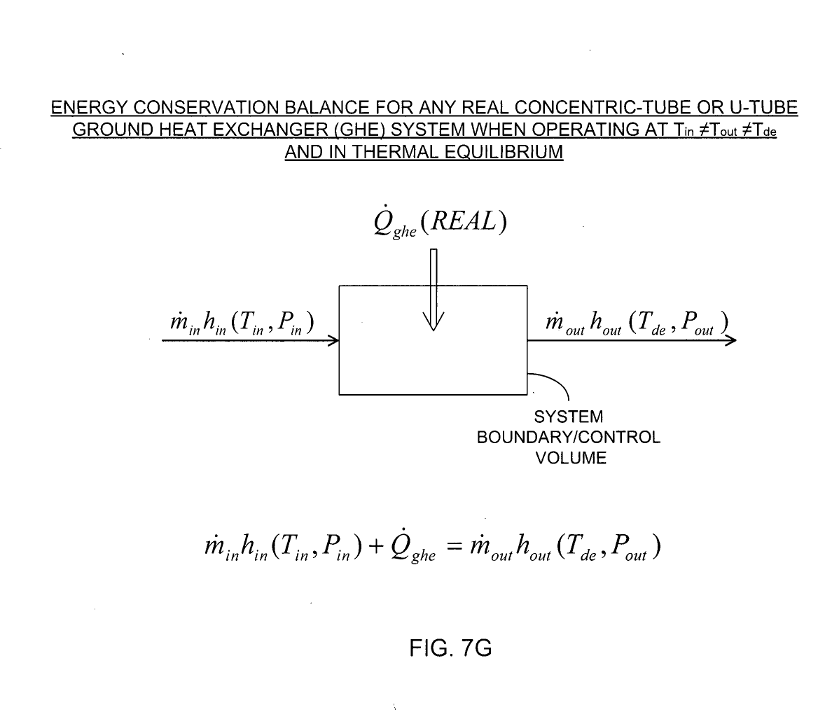

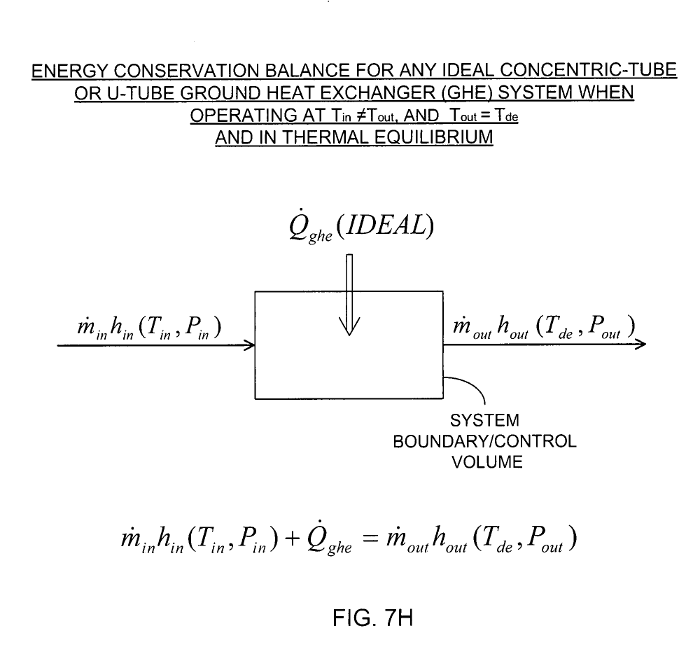

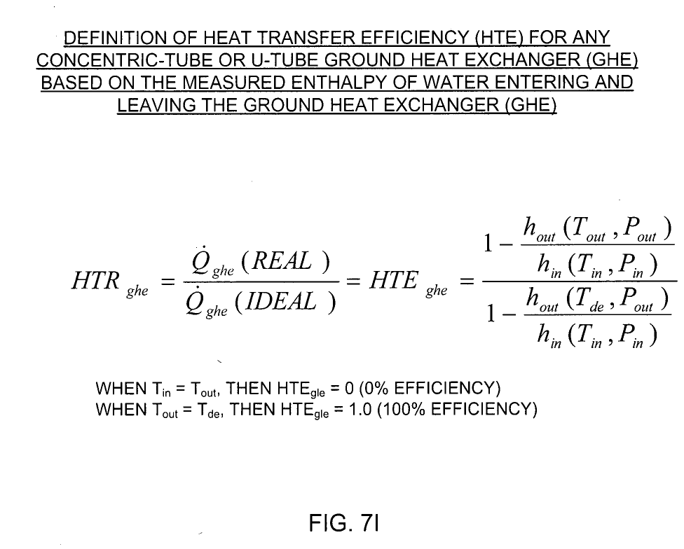

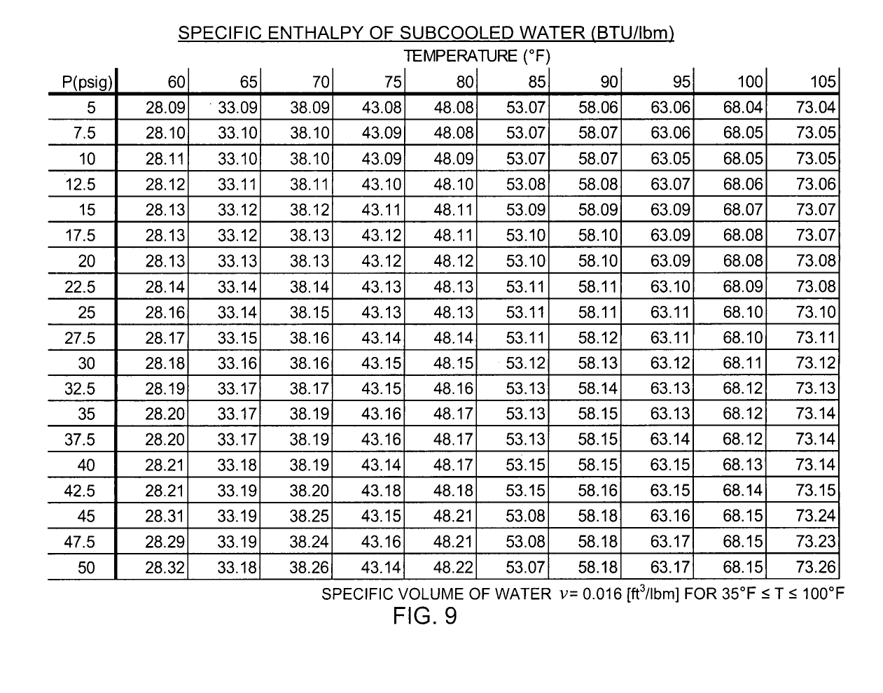

Whether practicing the library-based or recursive design/engineering methods of the present invention to be described hereinafter, it will advantageous to use of the Portable Enthalpy-Based GHE Performance Test Instrumentation System shown in FIGS. 1A through 6A, and Enthalpy-based HTR Test Method described in FIGS. 7A through 10, to perform in situ energy-based performance measurements on any type of ground heat exchanging (GHE) system installation at a specified ground loop field test site.

It is appropriate at this juncture to briefly describe the performance-based GLE) process of the present invention when using a high-performance concentric-tube turbulence-generating ground heat exchanger (GHE) technology, such as taught in U.S. Pat. Nos. 7,343,753; 7,347,059; 7,363,769; 7,370,488; 7,373,785; and 7,377,122 to Applicant, whenever designing and constructing a GLHE subsystem of any size, at any location where there is empirical knowledge that the deep Earth environment has low or moderate levels of ground water.

However, when designing and constructing a GLHE subsystem for a geothermal system having thermal loads of 15 or more Tons, then the GLE process of the present invention also calls for the use of the Portable Enthalpy-Based GHE Performance Test Instrumentation System of the present invention for measuring the HTR, FWR, EER/COP and HTE energy-based performance parameters for a GHE test installation, during a performance test conducted at the test site.

Before discussing the details of the GLE Process, it will be helpful to provide a brief overview of the GLE Process for medium-to-large scale geothermal system projects, by concisely describing the scope of each of its nine steps, in a sequential manner, below.

### Overview of the Ground Loop Engineering (GLE) Process of the Present Invention

STEP 1: Analyze and determine the Thermal Load Requirements of the Geothermal Project.

STEP 2: Visit the Test Site where the GLHE subsystem will be constructed, and install at least one GHE in the deep Earth environment for performance testing.

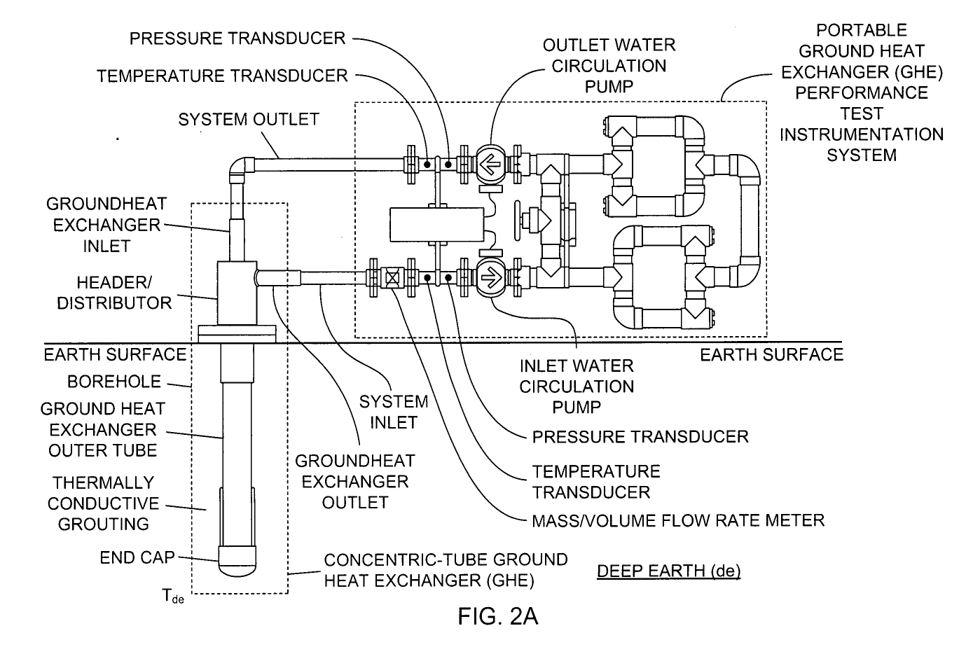

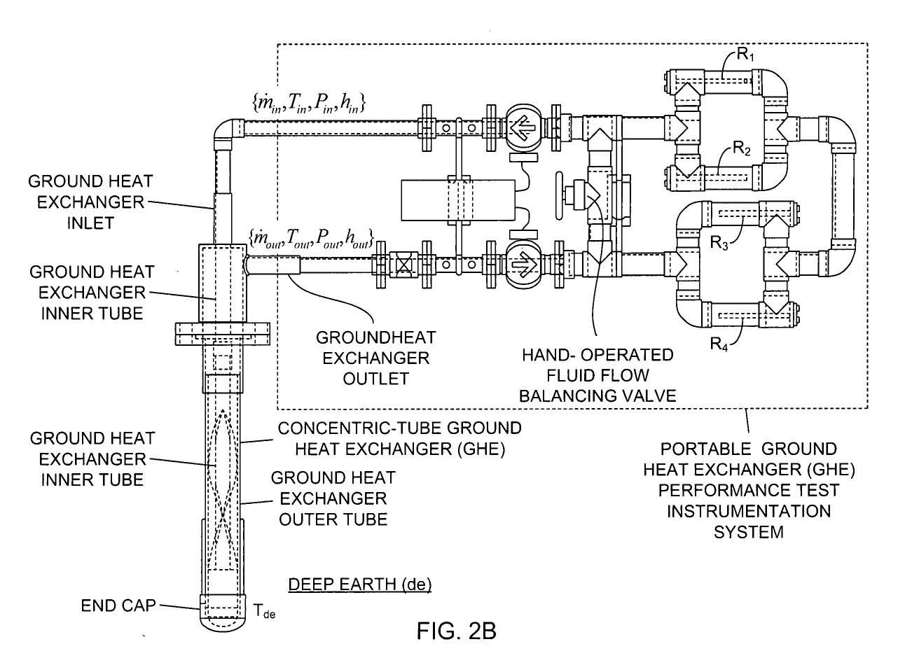

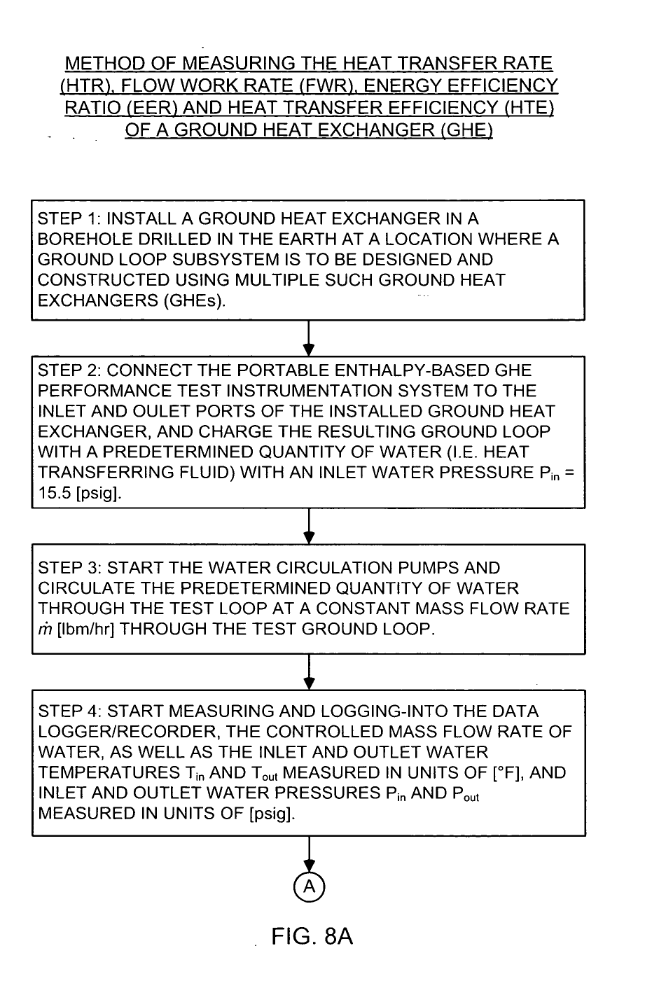

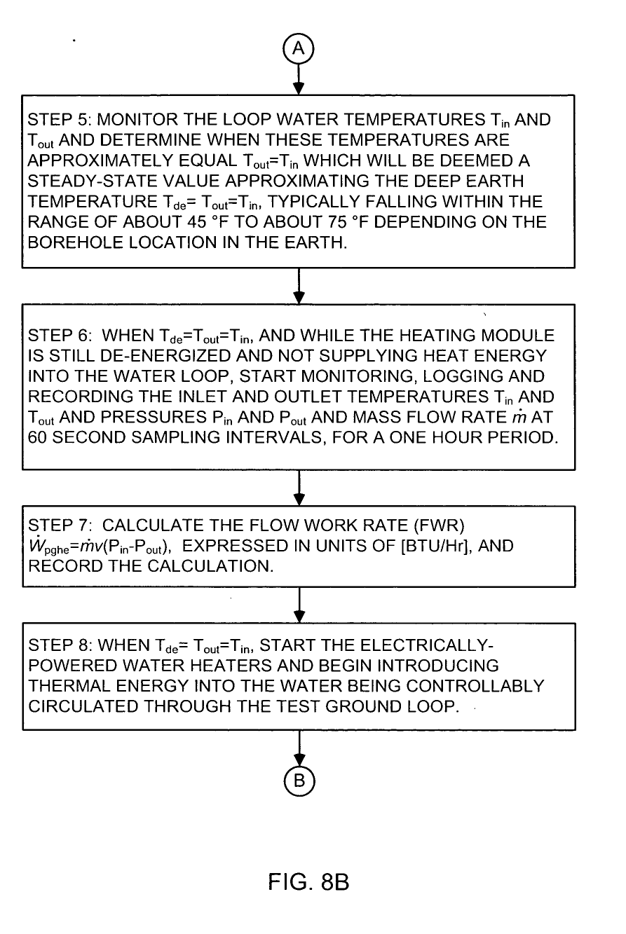

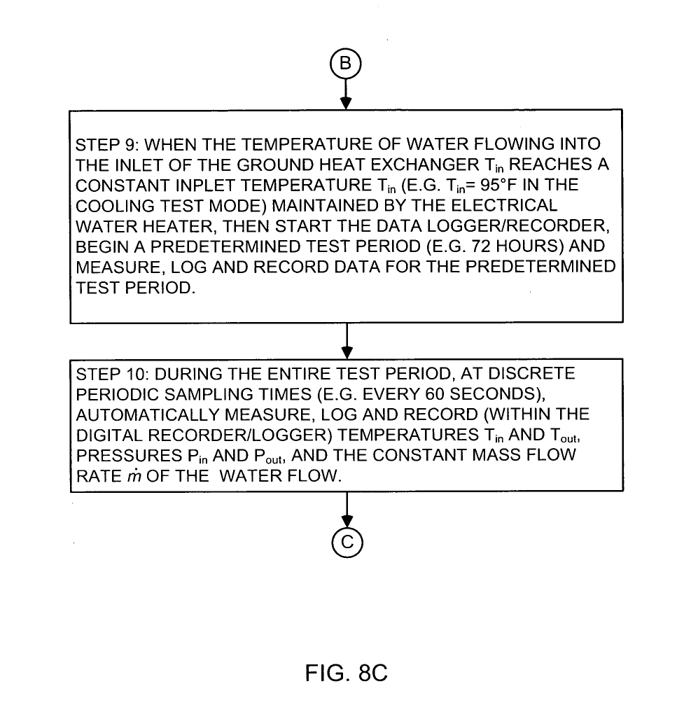

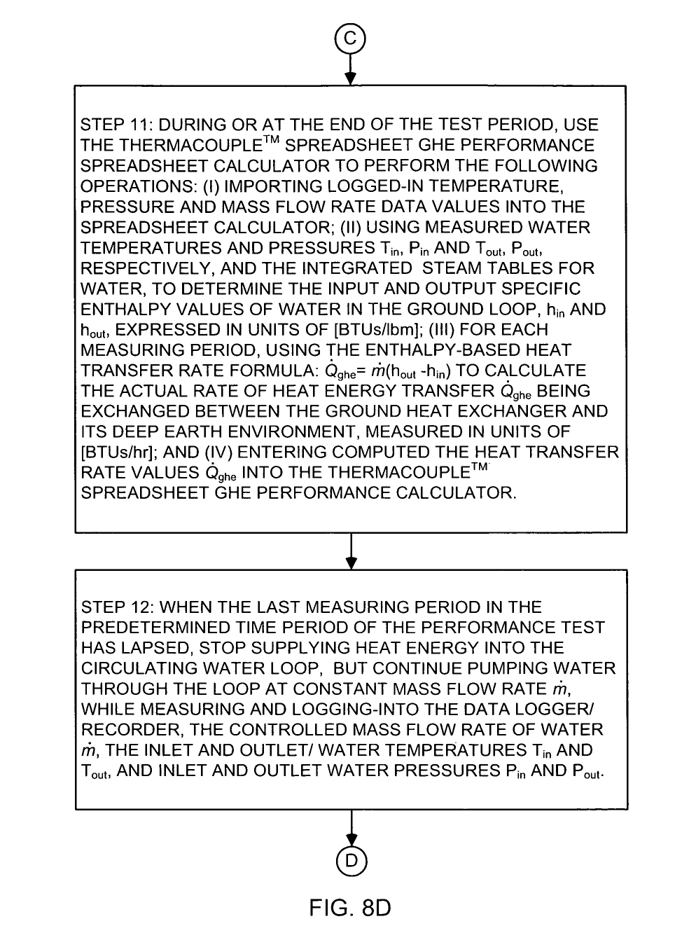

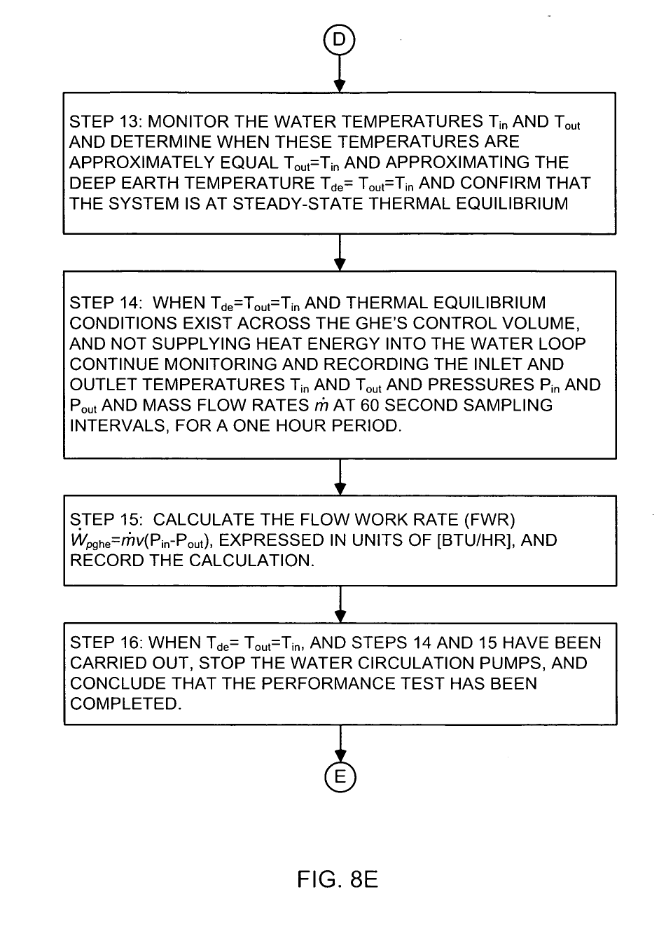

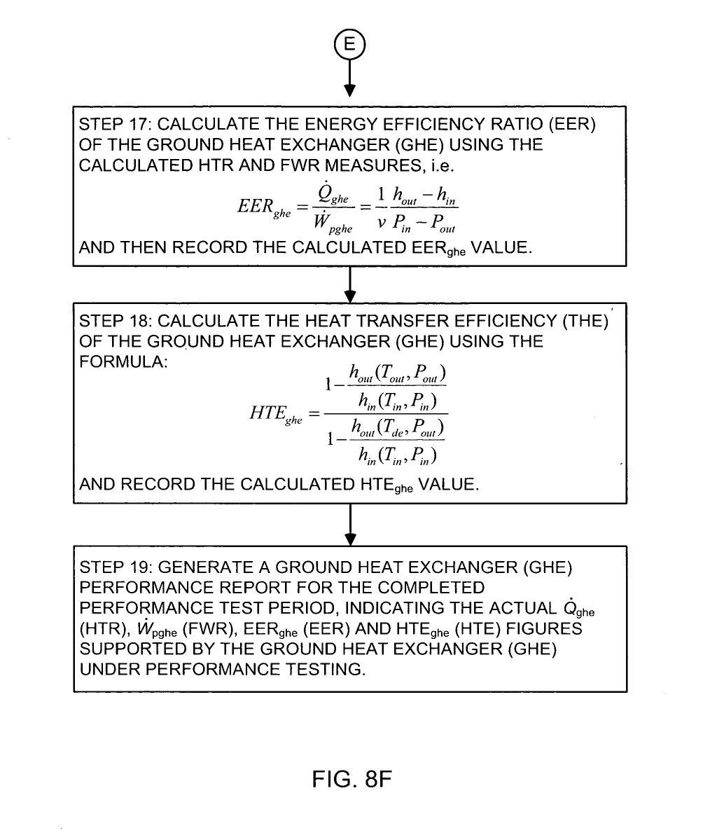

STEP 3: Connect the Portable Enthalpy-Based GHE Performance Test Instrumentation System of the present invention to the GHE installation as shown in FIGS. 1B through 2B, and then conduct a GHE Performance Test on the GHE installation and generate performance test results, in accordance with the GHE Performance Test Method specified in FIGS. 8A through 8F.

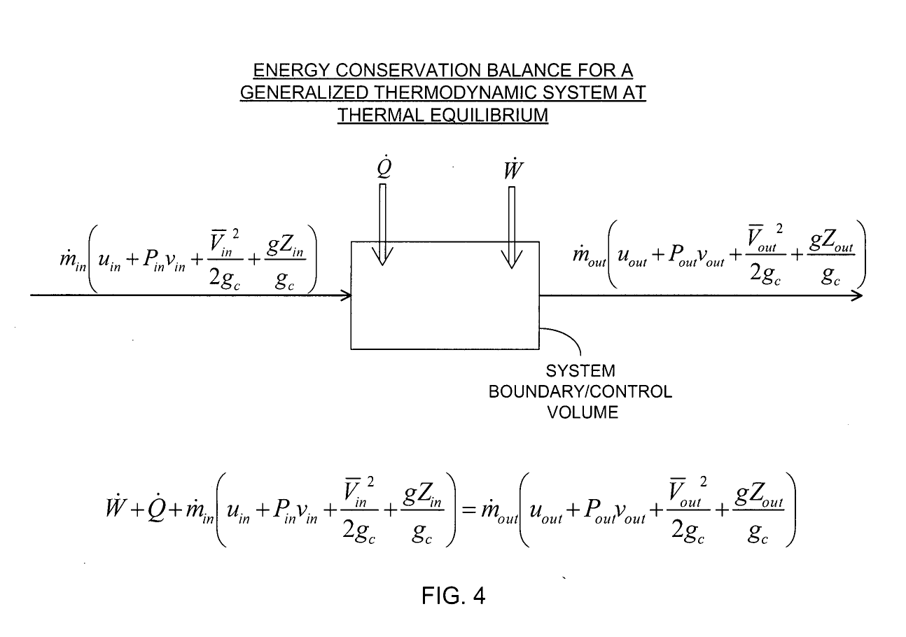

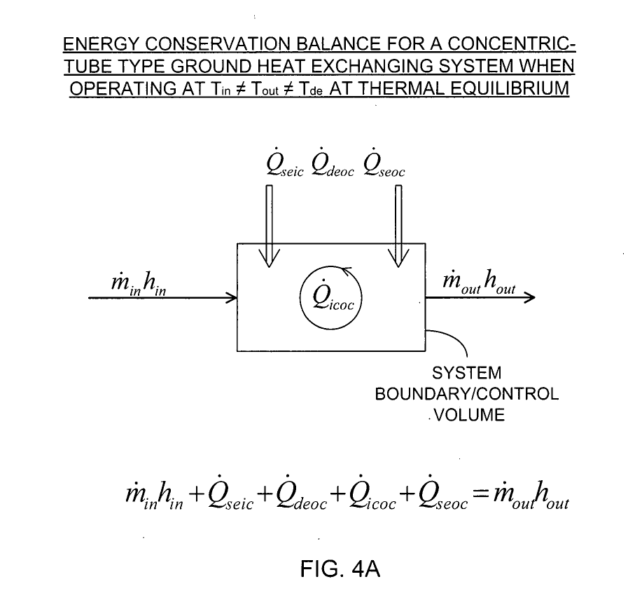

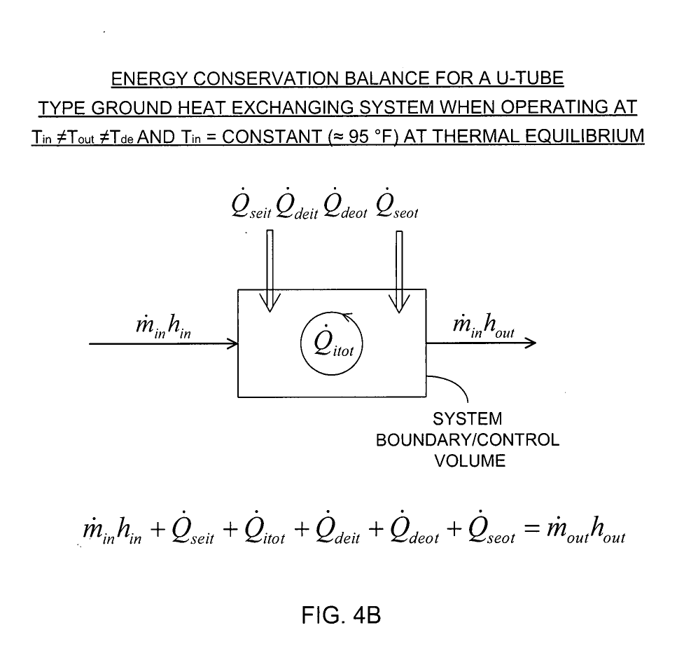

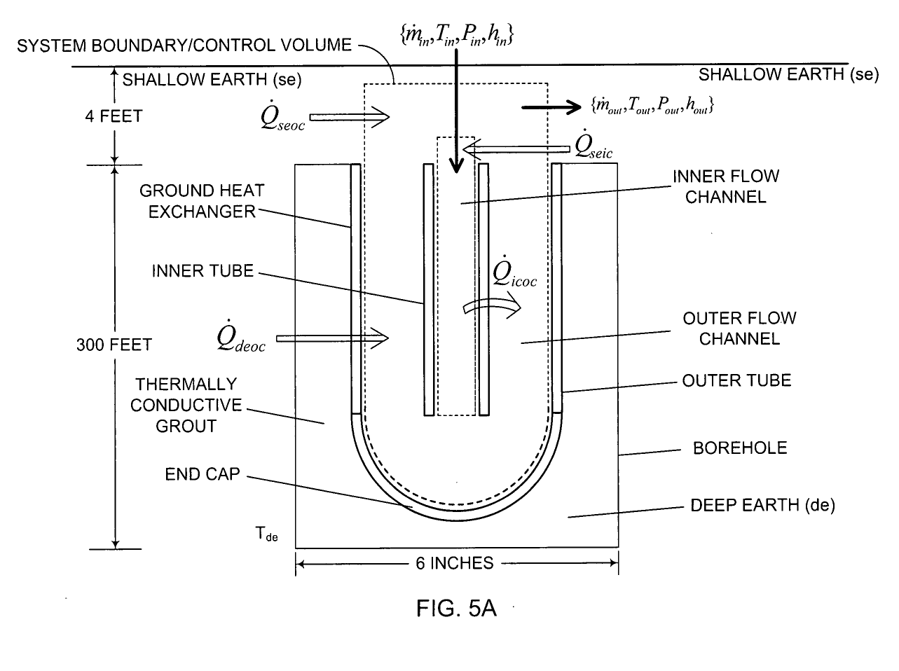

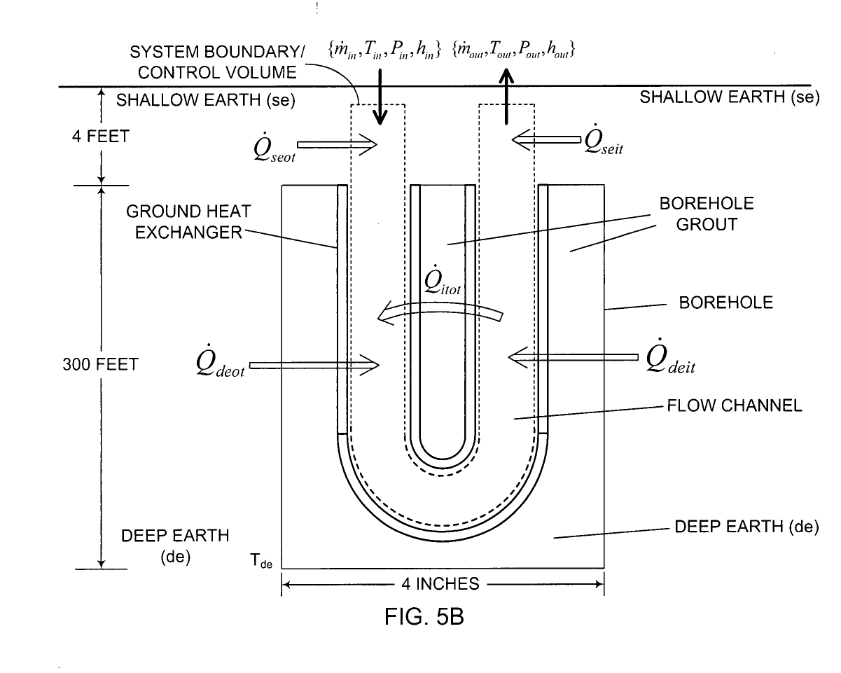

STEP 4: From the measured performance test results, generate a GHE Performance Test Report as shown in FIG. 5, including: the Deep Earth Temperature, the Heat Transfer Rate (HTR), the Flow Work Rate (FWR), the Energy Efficiency Ratio (EER), and the Heat Transfer Efficiency (HTE) of the GHE test installation, measured at specified conditions closely matching operating conditions of conventional geothermal heat pump, chiller and HVAC equipment. Mathematical models and methods used to derive all formulas used in such energy-based GHE performance figure calculations are set forth in FIGS. 4 through 7I.

STEP 5: Based on the Thermal Load Requirements of the Geothermal Project and the GHE Performance Test Report, select geothermal heat pump, chiller and/or HVAC equipment with which to design and construct a GLHE subsystem for installation on the Test Site and which will meet the Thermal Load Requirements of the Geothermal Project.

STEP 6: Design a GLHE subsystem for the Geothermal Project as described in Chapters 6 through 8, using:
(i) The Thermal Load Requirements of the Geothermal Project;
(ii) The Performance Test Results contained in the GHE Performance Test Report;
(iii) The selected geothermal heat pump, chiller and/or HVAC equipment; and
(iv) Piping, pumps, valves, manifolds, materials and standards.

STEP 7: Construct the designed GLHE subsystem on the Test Site, as described in U.S. Pat. Nos. 7,343,753; 7,347,059; 7,363,769; 7,370,488; 7,373,785; and 7,377,122, incorporated herein by reference in their entirety.

STEP 8: Set up, operate and tune the GLHE subsystem for optimum performance, as described hereinbelow.

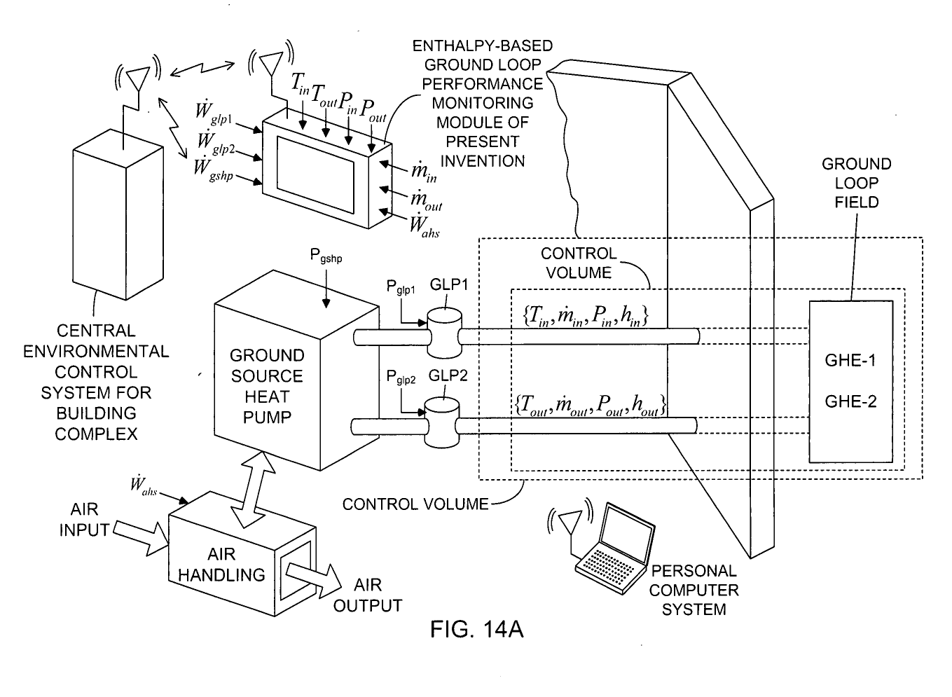

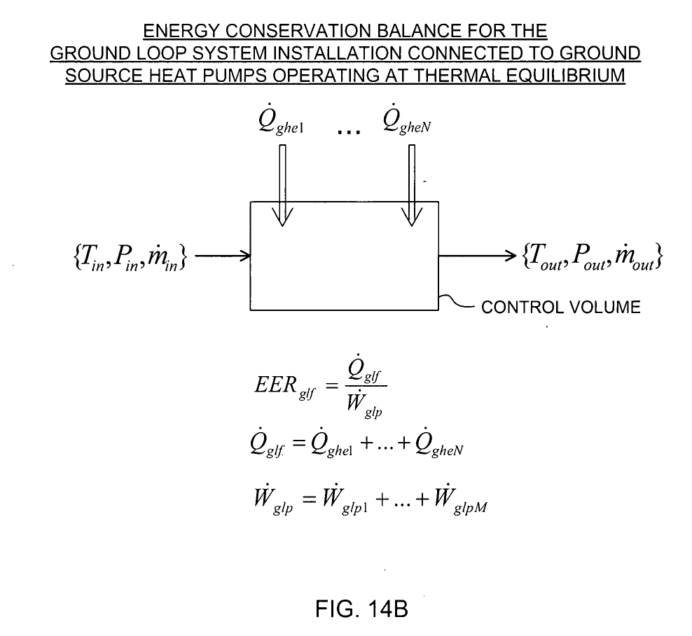

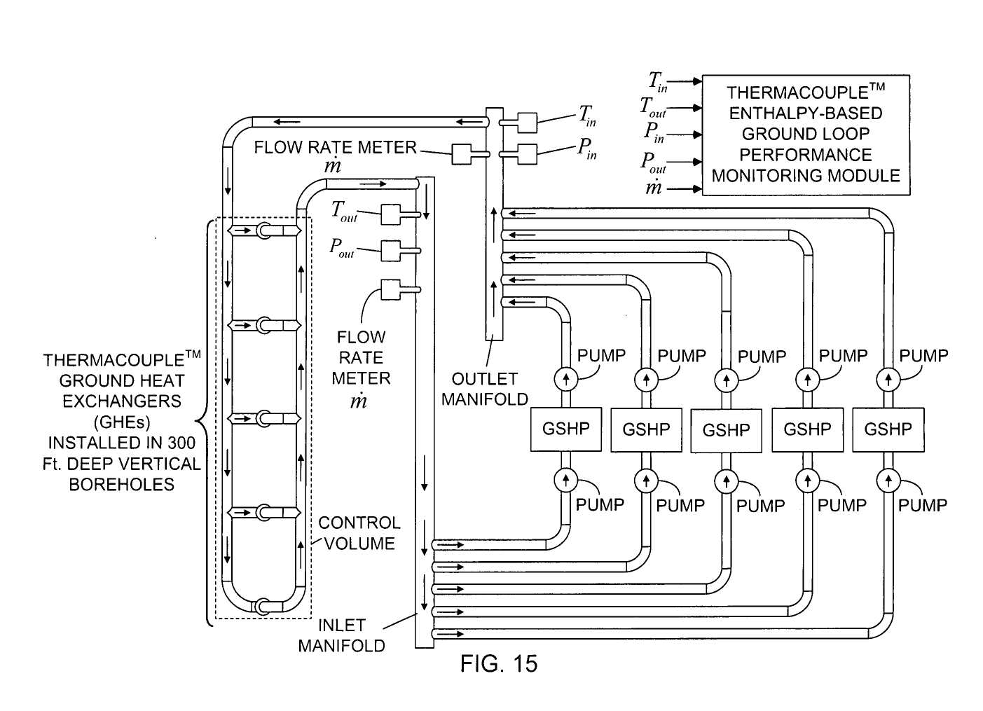

STEP 9: Install a Ground Loop Performance Monitoring Module on the Thermacouple™ GLHE subsystem, and monitor and record its performance during the lifetime of the geothermal system to which it is connected, as show in FIGS. 14A through 15.

With this overview, we are now ready to describe in greater detail, the Portable Enthalpy-Based GHE Performance Test Instrumentation System of the present invention, and the Method Of Enthalpy-Based GHE Performance Testing, which it supports at any ground loop test site.

The Portable Enthalpy-Based Ground Heat Exchanger Performance Test Instrumentation System And Method of Enthalpy-Based Heat Transfer Rate (HTR), Flow Work Rate (FWR) and Energy Efficiency Ratio (EER) Performance Testing in Accordance with the Principles of the Present Invention

In the illustrative embodiment shown in FIG. 1A, the Portable GHE Performance Test Instrumentation System of the present invention is shown connected to a generalized ground heat exchanger (GHE) installed in a borehole drilled in the deep Earth environment. Such ground heat exchangers can be closed-loop concentric-tube (i.e. coaxial-flow) type ground heat exchangers as disclosed in U.S. Pat. Nos. 7,343,753; 7,347,059; 7,363,769; 7,370,488; 7,373,785; and 7,377,122; HDPE U-tube type heat exchangers; open standing column well the ground heat exchangers; and other ground heat exchanger technologies known in the art.

As shown, the Portable GHE Performance Test Instrumentation System delivers a heat energy carrying fluid, such as water, into the ground heat exchanger, the deep Earth environment exchanges heat with the heat energy carrying fluid, and water output from the ground heat exchanger is returned to the HTR test system for reheating, along the ground test loop. As shown, the thermal properties for the input water stream Tₒᵤₜ, are input mass flow rate \dot{m}ᵢₙ, input water pressure Pᵢₙ input water temperature Tᵢₙ and input specific enthalpy hᵢₙ which is a function of input water pressure Pᵢₙ and input water temperature Tᵢₙ. The thermal properties for the output water stream are output mass flow rate \dot{m}ₒᵤₜ, output water pressure Pₒₙₜ output water temperature Tₒᵤₜ, and specific enthalpy hₒᵤₜ, which is a function of output water pressure Pₒᵤₜ, and output water temperature hₒᵤₜ, well known in the field of water thermodynamics.

In general, the Portable GHE Performance Test Instrumentation System of the present invention can be used to perform in situ heat transfer rate (HTR) performance measurements on any type of geothermal ground heat exchanger, described above. Two illustrative examples are given in FIGS. 1A, 1B and 2A and 2B.

In FIGS. 1A and 1B, an illustrative embodiment of the Portable GHE Performance Test Instrumentation System is shown connected to a close-loop concentric-tube (i.e. coaxial-flow) type ground heat exchanger, installed in a borehole drilled in the deep Earth environment. As shown, the concentric-tube type ground heat exchanging system is filled with an aqueous-based heat transfer fluid, that is contained and circulated within a sealed underground concentrically-arranged (coaxial-flow) tube assembly. In the design disclosed in U.S. Pat. No. 7,343,753, both laminar and turbulent fluid flows are employed within the tube assembly, to efficiently and safely transfer heat energy between the geothermal heat pump unit and the Earth's crust, all year round, in a highly efficient, economical and environmentally-safe manner. Typically, the concentric-tube type ground heat exchanging system is installed in a six (6) inch diameter 300 feet deep vertical borehole, but the borehole length may vary from installation to installation. Multiple ground heat exchangers of this design can be installed in 300 foot boreholes, spaced at 20 feet apart, and connected together with conventional piping below the frost-line, to meet the heat transfer rate requirements of any size geothermal heat pump or geothermal chiller project.

In FIGS. 2A and 2B, the Portable GHE Performance Test Instrumentation System of the present invention is shown connected to a conventional-based U-Tube heat exchanger, installed in a borehole drilled in the deep Earth environment. As shown, the U-Tube type ground heat exchanging system is filled with an aqueous-based heat transfer fluid, that is contained and circulated within a sealed HDPE U-tube configuration, installed in a borehole that is filled with grouting, that may have thermally enhanced properties. Typically, a U-Tube ground heat exchanger is installed in borehole of 4 to 6 inches in diameter, running in length from 100 feet up to 500 feet, and possibly deep in some applications. Multiple ground heat exchangers of this design can be installed in boreholes, also spaced at 20 feet apart, and connected together with conventional piping below the frost-line, to meet the heat transfer rate requirements of a geothermal heat pump project.

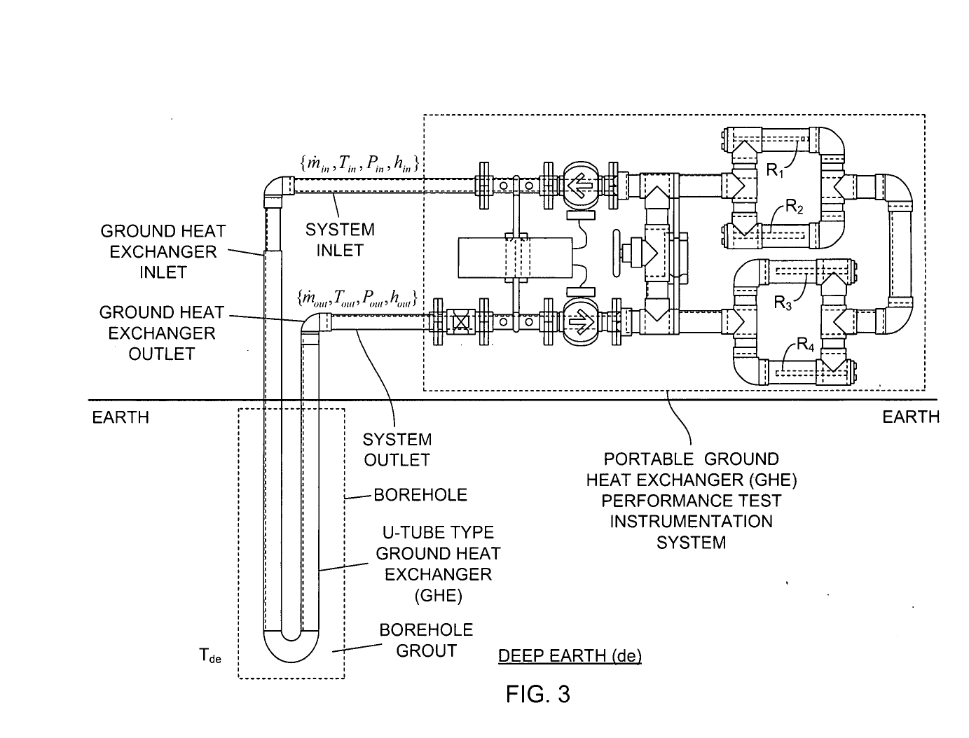

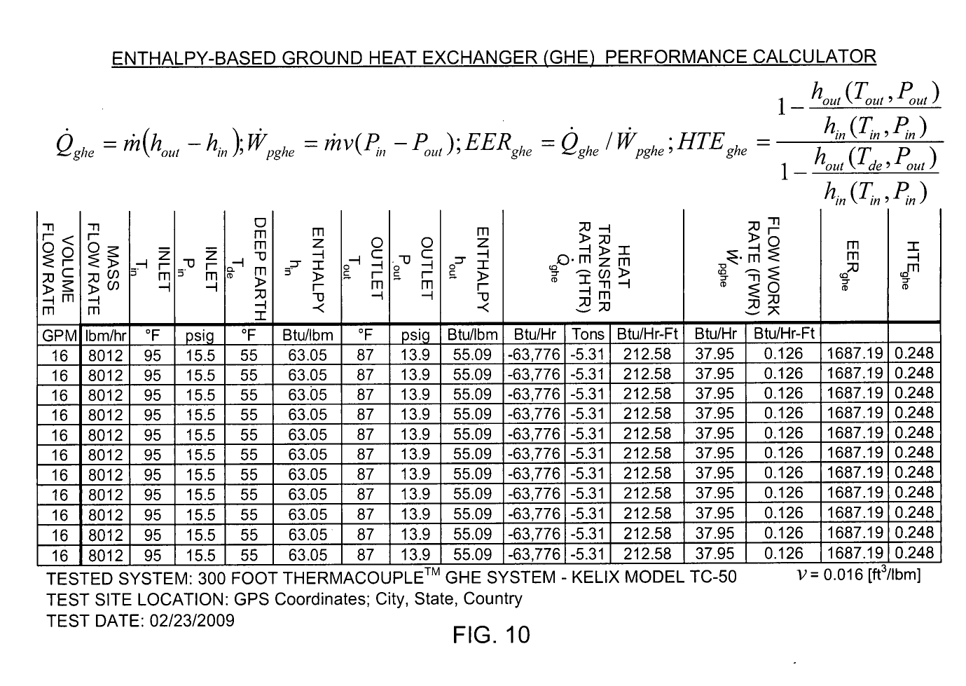

As shown in FIG. 3, the Portable GHE Performance Test Instrumentation System comprises a number of components, namely: inlet and outlet water circulation pumps associated with a pump control module for controlling the pumps so that a predetermined quantity of water (i.e. heat transferring fluid) is circulated through the test ground loop at a constant volume or mass flow rate tit during the test procedure period having a duration of at least 72 hours; ground loop water heating module consisting of a flow control tube assembly provided with a hand-operated mixing valve between the inlet and outlet flow channels, and having a pair of parallel flow water heating submodules, each having a pair of electrically-powered water heating elements, characterized by resistances R₁, R₂ and R₃, R₄ each rated to operate at output power values of at least 5.5 KW [kilowatts]; electrical power relays and associated control module for supplying the heating elements with 230V electrical power (supplied to the test site) so that the heating elements generate thermal energy and heat up the water pumped through the flow control tube assembly so that the inlet or entering water temperature Tᵢₙ is maintained at a constant input temperature measured in units of [° F.] (e.g. Tᵢₙ=95° F. in the cooling test mode of the system) during the entire 72 hour test period; a mass flow rate meter for measuring in units of [lbm/hr] the controlled mass flow rate \dot{m} of water through the test ground loop, or alternatively, a volume flow rate meter for measuring in units of [gallons/minute] the controlled volume flow rate F of water through the test ground loop, which can then be converted to a corresponding value of mass flow rate; a pair of temperature transducers (e.g. thermocouples) located on the interior surfaces of the inlet and outlet of the output ports of the apparatus, for measuring the inlet and outlet water temperature values Tᵢₙ and Tₒᵤₜ in units of [° F.] at discrete periodic sampling times; a pair of pressure sensors/transducers located on the interior surface of the output port of the apparatus, for measuring the inlet and outlet water pressures Pᵢₙ and Pₒᵤₜ in units of [psig] at discrete periodic sampling times during the 72 hour test period; a digital onboard logger/recorder for logging and recording temperatures Tᵢₙ and Tₒᵤₜ, pressures Pᵢₙ and Pₒᵤₜ, and the constant mass or volume flow rate of water flowing along the test ground loop, for each measuring period (e.g. every 60 seconds), and optionally transmitting such logged/recorded GHE data to a remote transceiver station (e.g. via WIFI, GSM or other wireless protocol), that is interfaced with a remote data logging/recorder and database server which, in turn, is operably connected to the Internet infrastructure, for remote access by one or more Web-enabled client computers, as shown in FIG. 1A; a GPS transceiver and antenna, interfaced with the digital onboard data logger/recorder, for receiving GPS signals from GPS satellites and computing the space-time position of the Portable GHE Performance Test Instrumentation System at any instant in space-time; a programmed micro-controller for controlling or managing the components on the test system during testing operations; and a Spreadsheet Enthalpy-Based GHE Performance Calculator Program illustrated in FIG. 10, running on a laptop, notebook or other portable computer system that is interfaced with the data logger/recorder using a standard data communication interface that may be wired and/or wireless, and test application requirements may require.

Preferably, the Spreadsheet GHE Performance Calculator Program illustrated in FIG. 10 has integrated a steam table for sub-cooled water over the range of measured temperature and pressure values, expected during testing operations. In the preferred embodiment of the present invention, this integrated steam table (partially) shown in FIG. 8 contains the specific enthalpy of water, known as h=f(p,T), defined as a function of temperature and pressure, in accordance with the International Association for the Properties of Water and Steam (IAPWS) Industrial Formulation 1997, known as the “IAPWSIF97” standard.

The Spreadsheet GHE Performance Calculator Program running on the portable computer system performs a number of functions, namely: (i) importing the logged-in temperature, pressure and mass (or volume) flow rate data values; (ii) determining the input and output specific enthalpy values of water hᵢₙ and hₒᵤₜ using measured water temperatures and pressures Tᵢₙ, Pᵢₙ and Tₒᵤₜ, Pₒᵤₜ, respectively, and the integrated steam table for water; (iii) using the formula \dot{W}_{pghe}=\dot{m}v(Pᵢₙ−Pₒᵤₜ) derived hereinafter to calculate the actual flow work rate (FWR), \dot{W}_{pghe} \dot{W}_{pghe} (i.e. the rate of work actually performed by the ground loop pump to pump the water through the ground heat exchanger) at the controlled volume/mass flow rate tit during steady-state temperature conditions Tᵢₙ=Tₒᵤₜ=T_{de}, during performance testing operations, expressed in units of [BTU/Hr] and [HP], and (iv) for each measuring period, using the enthalpy-based formula \dot{Q}_{ghe}=\dot{m}(hₒᵤₜ−hᵢₙ) derived hereinafter to calculate the actual rate of heat energy transfer \dot{Q}_{ghe} being exchanged between the ground heat exchanging system and the deep Earth (at T_{de}) in units of [BTUs/Hr]; (v) using the formula

$${ER}_{ghe} = \frac{{\dot{Q}}_{ghe}}{{\dot{W}}_{pghe}} = \frac{1}{v} \frac{( {h}_{out} - {h}_{in} )}{( {P}_{in} - {P}_{out} )}$$

derived hereinafter to calculate the energy efficiency ratio (EER) for the ground heat exchanger indicating how many of units of thermal power [BTUs/Hr] are exchanged with the deep Earth by the ground heat exchanger for every one (1) unit of electrical power supplied to the electrically powered pump pushing/pulling water through the ground heat exchanger; using the formula

$${HTE}_{ghe} = \frac{{\dot{Q}}_{ghe}^{real}}{{\dot{Q}}_{ghe}^{ideal}} = \frac{[ 1 - \frac{{h}_{out} ( {T}_{out} , {P}_{out} )}{{h}_{in} ( {T}_{in} , {P}_{in} )} ]}{[ 1 - \frac{{h}_{out} ( {T}_{de} , {P}_{out} )}{{h}_{in} ( {T}_{in} , {P}_{in} )} ]}$$

derived hereinafter to calculate the heat transfer (HTE) of any GHE installation, measured in dimensionless units, and equal to the ratio of (i) the actual real (empirically-determined) enthalpy difference between the inlet and outlet ports of the GHE when input and outlet water temperatures are unequal and in thermal equilibrium, to (ii) the ideal enthalpy difference between the inlet and outlet ports of the GHE when outlet water temperature is equal to and in thermal equilibrium with the deep Earth temperature about the GHE.

As will be shown in great detail hereinafter, the enthalpy-based formulas for \dot{Q}_{ghe}, \dot{W}_{glp}, EER_{ghe} and HTE_{ghe} are derived from mathematical modeling of the ground heat exchanging (GHE) system, through the application of the First Law of Thermodynamics based on energy and mass conservation and balancing principles, well known in the fields of thermodynamics and thermal and mass flow engineering.

Developing a Mathematical Model for the Ground Heat Exchanging (GHE) System and its Portable Enthalpy-Based GHE Performance Test Instrumentation System in Accordance with Thermodynamic Energy and Mass Conservation Principles

The first step to designing and developing the Enthalpy-Based GHE Performance Test Instrumentation System and method of the present invention, involves developing a mathematical model for the ground heat exchanging (GHE) system which will be connected to the system during performance test operations. To build a thermodynamic model for the system, one must first define the thermodynamic “system” which, in general, can be any quantity of matter upon which attention is focused for study. In the present invention, the thermodynamic system will be identified as the water mass flowing through the ground heat exchanger installed in the deep Earth (de) environment. Everything external to the system shall be called the thermodynamic surroundings, and the system is separated from the surroundings by the system boundaries. The system boundaries may either be fixed or movable. In the present invention, there is a need to analyze the ground heat exchanger in thermodynamic terms, involving a flow of mass into and out of the underground heat exchanging device. The thermodynamic modeling process involves specifying a control surface or volume, such as the heat exchanger tube walls, and mass, as well as that heat energy that may flow across the control surface or volume, during system operation.

In the field of thermodynamics, “systems” are classified as isolated, closed, or open, based on the possible transfer of mass and energy across the system boundaries. A control volume is a fixed region in space chosen for the thermodynamic study of mass and energy balances for flowing systems. The boundary of the control volume may be a real or imaginary envelope. The control surface is the boundary of the control volume. An isolated system is one that is not influenced in any way by the surroundings. This means that no energy in the form of heat or work may cross the boundary of the system. In addition, no mass may cross the boundary of the system. A closed system has no transfer of mass with its surroundings, but may have a transfer of energy (either heat or work) with its surroundings. An open system is one that may have a transfer of both mass and energy with its surroundings (i.e. mass, heat, and external work are allowed to cross the control boundary).

When a system is in equilibrium with regard to all possible changes in state, the system is in thermodynamic equilibrium. Steady state is that circumstance in which there is no accumulation of mass or energy within the control volume, and the properties at any point within the system are independent of time. Whenever one or more of the properties of a system change, a change in the state of the system occurs. The path of the succession of states through which the system passes is called the thermodynamic process. One example of a thermodynamic process is increasing the temperature of a fluid while maintaining a constant pressure. Another example is increasing the pressure of a confined gas while maintaining a constant temperature. Thermodynamic processes occur in most thermodynamic systems, including geothermal ground heat exchangers.

In a thermodynamic system, energy is transferred and sometimes converted into other forms of energy, yet the sum of all energies must obey the First Law of Thermodynamics. As will be described in greater detail hereinafter, the various forms of energy that might be transferred in a system include potential energy (PE), kinetic energy (KE), internal energy (U), flow energy (P-V), work (\dot{W}) and heat (\dot{Q}). Such diverse forms of energy may be measured in numerous basic units. It will be helpful to concisely summarize such units of energy measurement.

In general, there are three types of units to measure energy: (1) mechanical units, such as the foot-pound-force (ft-lbf); (2) thermal units, such as the British thermal unit (Btu); and (3) electrical units, such as the watt-second (W-sec). In the mks (meter, kilogram and second) and cgs (centimeter, grams and second) systems, the mechanical units of energy are the joule (j) and the erg, the thermal units are the kilocalorie (kcal) and the calorie (cal), and the electrical units are the watt-second (W-sec) and the erg. Although the units of the various forms of energy are different, they are equivalent.

In 1843, J. P. Joule conducted some very important experiments in science demonstrating quantitatively that there was a direct correspondence between mechanical and thermal energy. These experiments showed that one kilocalorie equals 4,186 joules. These same experiments, when performed using English system units, show that one British thermal unit (Btu) equals 778.3 ft-lbf. These experiments established the equivalence of mechanical and thermal energy. Other experiments established the equivalence of electrical energy with both mechanical and thermal energy. For engineering applications, these equivalences are expressed by the following relationships:

1 ft-lbf=1.286×10-3 Btu=3.766×10⁻⁷ kW-hr

1 Btu=778.3 ft-lbf=2.928×10⁻⁴ kW-hr

1 kW-hr=3.413×10³ Btu=2.655×10⁶ ft-lbf

1 hp-hr=1.980×10⁶ ft-lbf

These relationships can be used to convert between the various English system units for the various forms of energy.

In an energy transfer system, most computations involving the energy of the working fluid are performed in unit of Btu's. Forms of mechanical energy (such as potential energy, kinetic energy, and mechanical work) and other forms of energy (such as P-V energy) are usually given in foot-pounds-force. These forms of mechanical energy are converted to Btu's by using the conversion factor 1 Btu=778.3 ft-lbf. From this conversion factor, the mechanical equivalent of heat, denoted by the symbol J and referred to as Joule's constant, is defined as J=778 ft lbf./Btu.

Power is defined as the time rate of doing work. It is equivalent to the rate of the energy transfer. Power has units of energy per unit time. As with energy, power may be measured in numerous basic units, but the units are equivalent. In the English system, the mechanical units of power are foot-pounds-force per second or per hour (ft-lbf/sec or ft-lbf/hr) and horsepower (hp). The thermal units of power are British thermal units per hour (Btu/hr), and the electrical units of power are watts (W) or kilowatts (kW). For engineering applications, the equivalence of these units is expressed by the following relationships.

1 ft-lbf/sec=4.6263 Btu/hr=1.356×10⁻³ kW

1 Btu/hr=0.2162 ft-lbf/sec=2.931×10⁻⁴ kW

1 kW=3.413×10³ Btu/hr=737.6 ft-lbf/sec

1 Btu=778.169 ft-lbf

Horsepower is related to foot-pounds-force per second (ft-lbf/sec) by the following relationship: 1 hp=550.0 ft-lbf/sec. Also, horsepower is related to BTUs per hour by the following relationship: 1 hp=2546.4 Btu/hr. These relationships can be used to convert the English system units for power.

### Modeling the Energy and Mass Balances Across the Control Volume of the Ground Heat Exchanger and its Portable Enthalpy-Based GHE Performance Test Instrumentation System

The First Law of Thermodynamics relates to the balance of the various forms of energy as such forms of energy pertain to the specified thermodynamic system under study. Specifically, the First Law of Thermodynamics states that energy can neither be created nor destroyed, but rather transformed into various forms as the fluid or mass flow within the control volume is being studied.

In engineering, energy balances are used to quantify the energy used or produced by a system. Making an energy balance for a system is similar to making a mass balance for the system, but there are a few differences to remember, namely: that a specific system might be closed in a mass balance sense, but open as far as the energy balance is concerned; and that while it is possible to have more than one mass balance for a system, there can be only one energy balance.

The First Law of Thermodynamics addresses the total amount of energy, which consists of kinetic energy (KE), potential energy (PE) known as mechanical energy, and the internal energy (U) including flow energy (Pv), represented by specific enthalpy h of the system. For any system, energy transfer is associated with (i) mass and energy crossing the control boundary, (ii) external work and/or heat crossing the boundary, and (iii) the change of stored energy within the control volume. In general, kinetic, potential, internal, “flow” energies and the exchange of external work and/or heat energy are associated with the flow of fluid mass in the system, and must be considered during the overall energy balance of the system. In the case of the present invention, the heat transfer fluid or mass flow is water, but may be any aqueous-based fluid, in general.

To perform an energy balance for a system in accordance with the First Law of Thermodynamics, the various energies associated with water are identified as they cross the boundaries of the system, and then mathematical expressions are drawn to the energy balance of the system under analysis.

The First Law of Thermodynamics can be expressed in different ways.

The First Law of Thermodynamics states that, in an open system, all energies flowing into a system are equal to all energies leaving the system, plus the change in storage of energies within the system.

When expressed over a time interval (Δt), the First Law of Thermodynamics states that the increase in the amount of energy stored in a control volume must equal the amount of energy that enters the control volume, minus the amount of energy that leaves the control volume. When applying this principle, it should be recognized that energy can enter and leave the control volume due to heat transfer (\dot{Q}) through the boundaries, work done on a by the control volume (\dot{W}) and energy advection. For the study of heat transfer, focus should be made on thermal and mechanical forms of energy. The sum of thermal and mechanical energy is not conserved because there can be conversion between other forms of energy and thermal energy. Energy conversion results in thermal energy generation, which can be either positive or negative.

When expressed as a thermal and mechanical energy balance equation over a time interval (Δₜ), the First Law of Thermodynamics states that the increase in the amount of thermal and mechanical energy stored in the control volume must equal the amount of thermal and mechanical energy that enters the control volume, minus the amount of thermal and mechanical energy that leaves the control volume, plus the amount of thermal energy that is generated within the control volume.

As the First Law of Thermodynamics must be satisfied at each and every instant of time t, it can be formulated on as rate basis as follows: the rate of increase of thermal and mechanical energy stored in the control volume must equal the rate at which thermal and mechanical energy enters the control volume, minus the rate at which thermal and mechanical energy leaves the control volume, plus the rate at which thermal energy is generated within the control volume.

Thus, for any closed thermodynamic system, in which the rate of increase of thermal and mechanical energy stored in its control volume is zero, the First Law of Thermodynamics can be expressed in rate form as a generalized energy conservation balance, shown in FIG. 4 and given by the expression below:

$${\dot{m}}_{out} ( {u}_{out} + {P}_{out} {v}_{out} + \frac{{\overline{V}}_{out}^{2}}{2 {g}_{c}} + \frac{{gZ}_{out}}{{g}_{c}} ) = {\dot{m}}_{in} ( {u}_{in} + {P}_{in} {v}_{in} + \frac{{\overline{V}}_{in}^{2}}{2 {g}_{c}} + \frac{{gZ}_{in}}{{g}_{c}} ) + \dot{Q} + \dot{W}$$

where:
\dot{Q}=represents (all or net) heat flow rates into and out of the system (Btu/hr)
\dot{m}ᵢₙ=mass flow rate into the system (lbm/hr)
uᵢₙ=specific internal energy into the system (Btu/lbm)
Pᵢₙvᵢₙ=pressure-specific volume energy into the system (ft-lbf/lbm)=
vᵢₙ=specific volume of fluid entering the system (ft³/lbm)=
Pᵢₙ=pressure of fluid into the system (ft-lbf/ft²)
V̅ᵢₙ²/2g_{c}=KEᵢₙ=kinetic energy into the system (ft-lbf/lbm)
where
V̅ᵢₙ=average velocity of fluid into the system (ft/sec)=
g_{c}=the gravitational constant (32.17 ft-lbm/lbf-sec²)
g Zᵢₙ/g_{c}=PEᵢₙ=potential energy of the fluid entering the system (ft-lbf/lbm)
where
Zᵢₙ=height above reference level (ft) (at the surface of the Earth)
g=acceleration due to gravity (ft/sec²)
g_{c}=the gravitational constant (32.17 ft-lbm/lbf-sec²)
\dot{W}=represents (all or net) work flow rates into and out of the system (ft-lbf/hr)
\dot{m}ₒᵤₜ=mass flow rate out of the system (lbm/hr)
uₒᵤₜ=specific internal energy out of the system (Btu/lbm)
Pₒᵤₜvₒᵤₜ=pressure-specific volume energy moving out of the system (ft-lbf/lbm)
vₒᵤₜ=specific volume of fluid leaving the system (ft³/lbm)
Pₒᵤₜ=pressure of fluid out of the system (ft-lbf/ft²)
V̅ₒᵤₜ²/2g_{c}=KEₒᵤₜ=kinetic energy out of the system (ft-lbf/lbm)
wherein
V̅ₒᵤₜ=average velocity of fluid moving out of the system (ft/sec)
g Zₒᵤₜ/g_{c}=PEₒᵤₜ=potential energy out of the system (ft-lbf/lbm)
Zₒᵤₜ=height above reference level (ft) (at the surface of the Earth)

To determine which of these energy component terms are present in a ground heat exchanger of the type shown in FIGS. 1A through 2B, and should be considered in any heat transfer model, it will be helpful to briefly review the nature and properties of each of these energy components in the general model, and then develop particular energy balance models for the ground heat exchangers shown in FIGS. 1A, 1B and 2A, 2B.

### Potential Energy (PE)

Potential energy (PE) is defined as the energy of position. Using English system units, it is defined by PE=mgZ/g_{c}

where
PE=potential energy (ft-lbf)
m=mass (lbm)
Z=height above some reference level (ft)
g=acceleration due to gravity (ft/sec²)
g_{c}=gravitational constant=32.17 ft-lbm/lbf-sec²

### Kinetic Energy (KE)

Kinetic energy (KE) is the energy of motion. Using English system units, it is defined by

KE=m V̅²/2g_{c}
where:
KE=kinetic energy (ft-lbf)
m=mass (lbm)
V̅=velocity (ft/sec)
g_{c}=gravitational constant=32.17 ft-lbm/lbf-sec²

### Specific Internal Energy (U)

Potential energy and kinetic energy are macroscopic forms of energy. They can be visualized in terms of the position and the velocity of objects. In addition to these macroscopic forms of energy, a substance, such a flow of mass or fluid, possesses several microscopic forms of energy. Microscopic forms of energy include those due to the rotation, vibration, translation, and interactions among the molecules of a substance. While none of these forms of energy can be measured or evaluated directly, techniques have been developed to evaluate the change in the total sum of all these microscopic forms of energy. These microscopic forms of energy are collectively called internal energy, customarily represented by the symbol U. In engineering applications, the unit of internal energy is the British thermal unit (Btu), which is also the unit of heat.

The specific internal energy (u) of a substance is its internal energy per unit mass. It equals the total internal energy (U) divided by the total mass (m).

u=U/m

where:
u=specific internal energy (Btu/lbm)
U=internal energy (Btu)
m=mass (lbm)

### Specific P-V Energy

In addition to the internal energy (U), another form of energy, called P-V energy, arises from the pressure (P) and the volume (V) of a fluid, and represents the “flow energy” of the system. It is numerically equal to PV, the product of pressure and volume. Because energy is defined as the capacity or potential energy of a system to perform work, where pressure and volume are permitted to expand performing work on its surroundings. Therefore, a fluid under pressure has the capacity to perform work. In engineering applications, the units of P-V energy, also called flow energy, are the units of pressure multiplied by volume (pounds-force per square foot times cubic feet) which equals foot-pounds force (ft-lbf). The specific P-V energy of a substance is the P-V energy per unit mass. It equals the total P-V divided by the total mass m, or the product of the pressure P and the specific volume v, and is written as

Pv=PV/m

where:
P=pressure (lbf/ft2)
V=volume (ft3)
v=specific volume (ft3/lbm)
m=mass (lbm)
The difference in flow energy between the inlet and outlets of a system is defined as flow work which is defined as the rate of work done by the fluid at the system outlet minus the rate of work done on the fluid at the system inlet. Flow work overcomes frictional, viscous and other fluid losses, which results in an overall pressure drop.

### Specific Enthalpy (h)

Specific enthalpy (h) is defined as h=u+Pv, where u is the specific internal energy (Btu/lbm) of the system being studied, P is the pressure of the system (lbf/ft²), and v is the specific volume (ft³/lbm) of the system. Enthalpy is a thermodynamic property of a substance, like pressure, temperature, and volume, but it cannot be measured directly. Normally, the enthalpy of a substance is given with respect to some reference value. For example, the specific enthalpy of water or steam is given using the reference that the specific enthalpy of water is zero at 0.01° C. and normal atmospheric pressure. The fact that the absolute value of specific enthalpy is unknown is not a problem, however, because it is the change in specific enthalpy (Δh) and not the absolute value that is important in practical problems. Steam tables include values of specific enthalpy as part of the information tabulated, and the specific enthalpy of water, h=f(p,T) is defined as a function of temperature and pressure, in accordance with the International Association for the Properties of Water and Steam (IAPWS) Industrial Formulation 1997, known as the “IAPWSIF97” standard.

### Work (W)

Kinetic energy, potential energy, internal energy, and P-V energy are forms of energy that are properties of a system. Work is a form of energy, but it is energy in transit. Work is not a property of a system. Work is a process done by or on a system, but a system contains no work. Work is defined for mechanical systems as the action of a force on an object through a distance. It equals the product of the force (F) times the displacement (d).

W=Fd

where:
W=work (ft-lbf)
F=force (lbf)
d=displacement (ft)
The rate at which Work is performed on or by a system is defined as Work Rate, \dot{W}, and is the time derivative of Work, W. Also, it is noted that work rate \dot{W} can also be defined in rotational systems where a torque is applied at a distance to cause angular displacement, rather than linear displacement.

### Heat (Q)

Heat, like work, is energy in transit. The transfer of energy as heat, however, occurs at the molecular level as a result of a temperature difference. The symbol Q is used to denote heat. This should not be confused with the symbol \dot{Q} used to denote heat transfer rate, which the rate at which is transferred over time, the first time derivative of Q. In engineering applications, the unit of heat is the British thermal unit (Btu). Specifically, this is called the 60 degree Btu because it is measured by a one degree temperature change from 59.5 to 60.5° F.

As with work, the amount of heat transferred depends upon the path, and not simply on the initial and final conditions of the system. Also, as with work, it is important to distinguish between heat added to a system from its surroundings and heat removed from a system to its surroundings. A positive value for heat indicates that heat is added to the system by its surroundings. This is in contrast to work that is positive when energy is transferred from the system and negative when transferred to the system. The symbol q is sometimes used to indicate the heat added to or removed from a system per unit mass. The symbol q equals the total heat (Q) added or removed divided by the mass (m). The term “specific heat” is not used for q since specific heat is used for another parameter. The quantity represented by q is referred to simply as the heat transferred per unit mass.

q=Q/m

where:
q=heat transferred per unit mass (Btu/lbm)
Q=heat transferred (Btu)
m=mass (lbm)
Defining a Control Volume for the Ground Heat Exchanging System to be Tested Using the Enthalpy-Based GHE Performance Test Instrumentation System and Method of the Present Invention, and then Constructing an Energy Balance Equation According to the First Law of Thermodynamics

The control volume approach will be used to analyze the ground heat exchangers of FIGS. 1A through 2B, and then constructing an energy balance for each system. In the control volume approach, a fixed region in space is established with specified control boundaries. The energies that cross the boundary of this control volume, including those with the mass crossing the boundary, are then studied and the energy balance performed.

As shown in FIG. 4A, the control volume of the concentric-tube ground heat exchanger system in FIG. 1A, 1B can be defined as the surfaces coincident with the inner and outer surfaces of the inner tube section of the concentric-tube ground heat exchanger, the inner surfaces of the outer tube sections, and the inner surfaces of the inlet and outlet ports of the header/distributor of the ground heat exchanger, connecting with the inner and outer tube sections.

In general, the forms of energy that may cross the control volume boundary include those associated with the mass (m) crossing the boundary. Mass in motion has potential (PE), kinetic (KE), and internal energy (U). In addition, since the mass flow is normally supplied with some driving power (e.g. a pump), there is another form of energy associated with the fluid caused by its pressure, referred to as “flow energy” (i.e. Pv-work), discussed above. The thermodynamic terms thus representing the various forms of energy crossing the control boundary with the mass are given as \dot{m} (u+Pv+KE+PE).

In open and closed system analysis, the u and Pv terms occur so frequently that another property, specific enthalpy, has been defined as h=u+Pv, and has been discussed in detail above. This results in the above expression being written as \dot{m} (h+KE+PE). In addition to the mass and its energies, externally applied work (W), usually designated as shaft work, is another form of energy that may cross the system boundary. To complete and satisfy the conservation of energy relationship, energy that is caused by neither mass nor shaft work, is classified as heat energy (\dot{Q}). These relationships can be used to reformulate the Eulerian energy conservation equation as follows:

\dot{m}(hₒᵤₜ+PEₒᵤₜ+KEₒᵤₜ)=\dot{m}(hᵢₙ+PEᵢₙ+KEᵢₙ)+\dot{Q}+\dot{W}

where:
\dot{m}=mass flow rate of working fluid into and out of the system (lbm/hr)=
hᵢₙ=specific enthalpy of the working fluid entering the system (Btu/lbm)
hₒᵤₜ=specific enthalpy of the working fluid leaving the system (Btu/lbm)
PEᵢₙ=specific potential energy of working fluid entering the system (ft-lbf/lbm)
PEₒᵤₜ=specific potential energy of working fluid leaving the system (ft-lbf/lbm)
KEᵢₙ=specific kinetic energy of working fluid entering the system (ft-lbf/lbm)
KEₒᵤₜ=specific kinetic energy of working fluid leaving the system (ft-lbf/lbm)
\dot{W}=net rate of work done by the system (ft-lbf/hr)
\dot{Q}=net heat transfer rate into the system (Btu/hr)

When the thermodynamic system (e.g. heat transferring fluid being studied) changes its properties (i.e. temperature, pressure, volume) from one value to another as a consequence of work or heat or internal energy exchange, then it is said that the fluid has gone through a “process.” In some processes, the relationships between pressure, temperature, and volume are specified as the fluid goes from one thermodynamic state to another. The most common processes are those in which the temperature, pressure, or volume is held constant during the process. These would be classified as isothermal, isobaric, or isovolumetric processes, respectively. If the fluid passes through various processes and then eventually returns to the same state it began with, then the system is said to have undergone a cyclic process.

In the geothermal ground heat exchanging systems under consideration, the potential and kinetic energy terms PE and KE and work rate term \dot{W} are recognized as being negligible and thus considered zero, and the mass flow rate entering the system equals the mass flow rate leaving the system \dot{m}ᵢₙ=\dot{m}₂=\dot{m}, greatly simplifying the energy balance equation for each ground heat exchanging system, as follows:

\dot{m}hₒᵤₜ=\dot{m}hᵢₙ+\dot{Q}

With algebraic manipulation, the energy balance equation can be expressed as:

\dot{Q}=\dot{m}(hₒᵤₜ−hᵢₙ)

At this stage, it is helpful to recognize the different heat transfer rate components operating within each type of ground heat exchanging system, however small or negligible they may be, and thereafter decide to eliminate particular such terms from the model based on rational analysis, consistent with observable facts.

The potential heat transfer rate terms associated with a concentric-tube type ground heat exchanger are identified as \dot{Q}_{seic} \dot{Q}_{icoc}\dot{Q}_{icoc} \dot{Q}_{seoc} as shown in FIG. 4A, and graphically illustrated in the model of FIG. 5A.

Notably, the terms \dot{Q}_{seic} and \dot{Q}_{seoc} will be negligible in concentric-tube ground heat exchanging systems constructed using HPDE header/distributor components and HDPE piping between ground heat exchangers, because HDPE plastic has an extremely low thermal conductivity (i.e. high thermal resistivity). Also, the cross flow channel heat transfer term \dot{Q}_{icoc} will be negligible when concentric-tube ground heat exchanging systems employ PVC inner tubes and supports laminar flows along the inner flow channel, as taught in U.S. Pat. No. 7,343,753, supra, incorporated herein by reference. The reason is because PVC has an extremely low thermal conductivity (i.e. high thermal resistivity) and laminar flow along the inner flow channel (oc) of the inner tube of the concentric-tube ground heat exchanger will create sufficient thermal boundary layers, and establish very low heat transfer coefficients for convective and conductive forms of heat flow, from the inner flow channel to the outer flow channel (via the inner tube wall). Based on such rational analysis, the energy balance equation for the concentric-tube ground heat exchangers employing laminar and turbulence flows, as taught in U.S. Pat. No. 7,343,753, reduces to the following expression:

\dot{Q}_{deoc}=\dot{m}(hₒᵤₜ−hᵢₙ)

By definition, the heat transfer rate for the concentric-tube ground heat exchanger can be then defined as \dot{Q}_{ghe} and provided by the following equation:

\dot{Q}_{ghe}=\dot{m}(hₒᵤₜ−hᵢₙ)

This enthalpy-based heat transfer rate formula will hold for values of mass flow rates, and entering and leaving temperatures and pressures for which the U-tube ground heat exchanger has been designed to operate. Also this enthalpy-based heat transfer rate equation will be used in the method of heat transfer rate testing described in FIGS. 8A through 8F when testing the heat transfer rate performance of any concentric-tube ground heat exchanger in accordance with the principles of the present invention.

The potential heat transfer rate terms associated with a U-Tube type ground heat exchanger include \dot{Q}ₛₑᵢₜ \dot{Q}ᵢₜₒₜ \dot{Q}_{deit} Q_{deot} \dot{Q}ₛₑₒₜ as shown in FIG. 4B, and graphically illustrated in the model of FIG. 5B.

Notably, the terms \dot{Q}ₛₑᵢₜ and \dot{Q}ₛₑₒₜ will be negligible in U-tube type ground heat exchanging systems constructed using HDPE piping between ground heat exchangers, because HDPE plastic has an extremely low thermal conductivity (i.e. high thermal resistivity). However, the cross tube heat transfer term \dot{Q}ᵢₜₒₜ will not be negligible when U-tube ground heat exchanging systems employ HDPE and thermally conductive grouting, resulting in thermal short-circuiting and reduction in efficiency of the U-tube ground heat exchanger. This is because typically the temperature gradient between the HDPE inlet tube (it) and the HPDE outlet tube (ot) will not insignificant due to the relatively close spacing between these tubes and the presence of thermally-conductive grouting disposed therebetween. In effect, such thermal short-circuiting caused by heat transfer rate \dot{Q}ᵢₜₒₜ will reduce the net effect of positive heat transfer rates \dot{Q}_{deit} and \dot{Q}_{deot} supported between the deep Earth (at temperature T_{de}) and the inlet tube (it) and outlet tube (ot) of any U-tube ground heat exchanger construction, and can be considered a net heat transfer rate between the U-tube ground heat exchanger and the deep Earth, represented by the net heat transfer rate term \dot{Q}_{ghe}=\dot{Q}_{deit}+\dot{Q}_{deot}+\dot{Q}ᵢₜₒₜ. Based on such rational analysis, the energy balance equation for the U-tube ground heat exchanger also reduces to the following expression:

\dot{Q}=\dot{m}(hₒᵤₜ−hᵢₙ)

This enthalpy-based heat transfer rate formula will hold for values of mass flow rates, and entering and leaving temperatures and pressures for which the U-tube ground heat exchanger has been designed to operate. This same heat transfer rate equation will be also used in the method of heat transfer rate testing illustrated in FIGS. 8A through 8F when testing the performance of any U-tube type ground heat exchanger, or other type of geothermal ground heat exchanger, in accordance with the principles of the present invention.
Defining the Control Volume for the Portable Enthalpy-Based Ground Heat Exchanger (GHE) Performance Test Instrumentation System of the Present Invention, and then Constructing an Energy Balance Equation According to the First Law of Thermodynamics

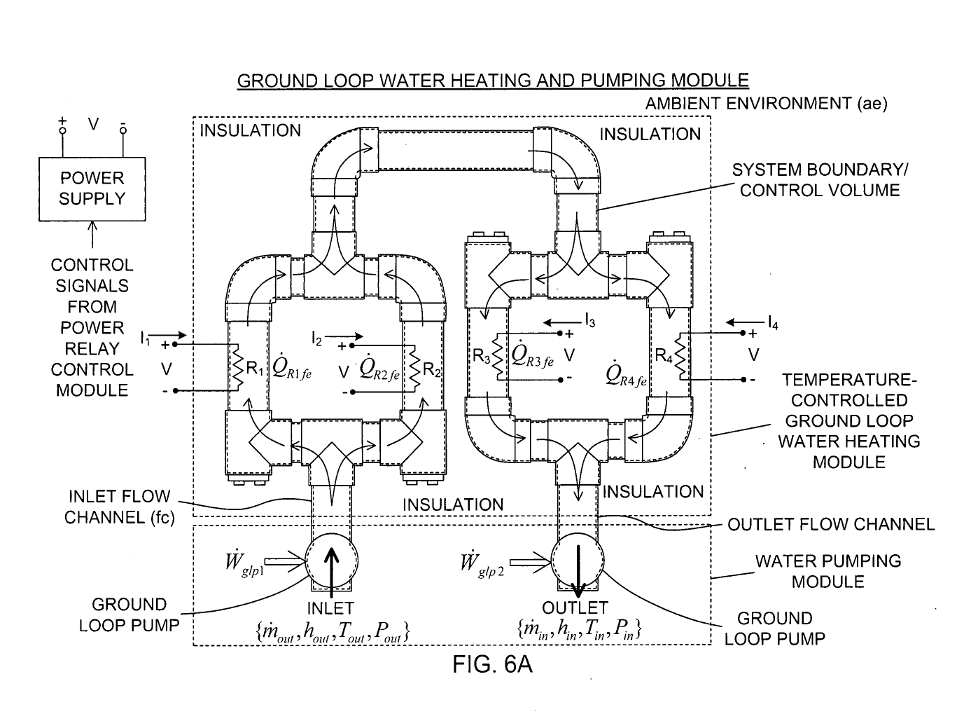

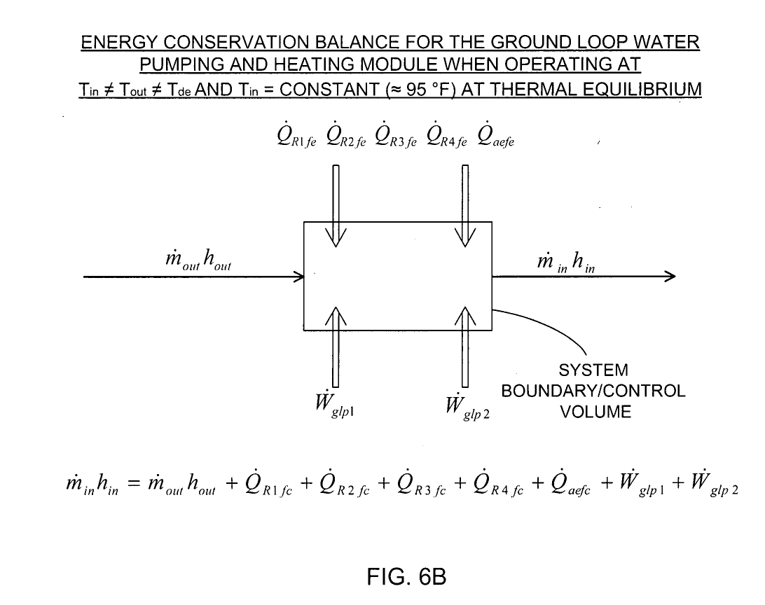

The control volume approach will be used to analyze the Portable Enthalpy-Based GHE Performance Test Instrumentation System of FIG. 6A, and then an energy balance equation will be derived for the system. From the energy balance equation, a heat transfer rate equation will be derived which describe the rate of heat energy which will need to be generated by the electrically-driven heating elements R₁ through R₄, supplied with electrical power supplies P₁ through P₄, respectively, so that the temperature state of the water entering the ground heat exchanger will remain substantially constant during the long-term HTR performance testing operations in a ground loop field test site.

As shown in FIG. 6A the control volume of the GHE Performance Test System are defined as the surfaces coincident with the outer surfaces of flow tube sections of ground loop heating module, which are surrounded by thermal insulation material to minimize heat transfers between the flow channels and the ambient environment (ae). Along these flow channels (fe), the four heating elements are mounted so that water flows thereabout at a constant mass flow rate \dot{m}ₒᵤₜ=\dot{m}ᵢₙ controlled by the pair of water pumps provided in the HTR test system.

As illustrated in FIG. 6A, the state properties of water returning from the ground loop heat exchanger, and entering the temperature-controlled ground loop water heating module, are defined by {\dot{m}ₒᵤₜ, Tₒᵤₜ, Pₒᵤₜ, hₒᵤₜ}, whereas the state properties of water exiting the water heating module and entering the ground heat exchanger under testing, are defined by {\dot{m}ᵢₙ, Tᵢₙ, Pᵢₙ, hᵢₙ}.

Applying the rate form of the First Law of Thermodynamics to the control volume of this system, results in the following energy balance equation:

\dot{m}ᵢₙhᵢₙ=\dot{m}ₒᵤₜhₒᵤₜ+\dot{Q}_{R1 fc}+\dot{Q}_{R2 fc}+\dot{Q}_{R3 fc}+\dot{Q}_{R4 fc}+\dot{Q}_{aefc}+\dot{W}_{glp1}+\dot{W}_{glp2}

The heat transfer flow rate from the ambient environment to the flow channels of the water heating apparatus, \dot{Q}_{aefc}, will be negligible when packing the tubes of the apparatus in thermal insulation, as specified in FIG. 6A. Also, the heat generation rates for each of the four heating elements along the flow channels of the water pumping and heating module, are denoted by \dot{Q}_{R1 fc} \dot{Q}_{R2 fc} \dot{Q}_{R3 fc} \dot{Q}_{R4 fc}, respectively.

Through excellent heat convection design, and material science, very high energy conversion rates can be achieved, to efficiently introduce heat energy into the constant mass flow of the system (across its control volume), according to the following electrical-thermal energy conversion formulas:

$${VI}_{1} = \frac{{V}^{2}}{{R}_{1}} = {\dot{Q}}_{R 1 fc}$$

$${VI}_{2} = \frac{{V}^{2}}{{R}_{2}} = {\dot{Q}}_{R 2 fc}$$

$${VI}_{3} = \frac{{V}^{2}}{{R}_{3}} = {\dot{Q}}_{R 3 fc}$$

$${VI}_{4} = \frac{{V}^{2}}{{R}_{4}} = {\dot{Q}}_{R 4 fc}$$

wherein total power supplied to the water heating elements R₁, R₂, R₃ and R₄ is equal to the total power supplied to the water heating module, providing the power equation P_{Heater}=VI₁+VI₂+VI₃+VI₄, where V is a constant voltage supplied across each heating element, and electrical currents I₁, I₂, I₃ and I₄ flow through heating elements R₁, R₂, R₃ and R₄, respectively, during water heating operations.

Also, ignoring heat losses and inefficiencies associated with the pump modules, the total power supplied to the pump modules is equal to \dot{W}_{glp1,2}=VI_{glp1}+VI_{glp2} where V is a constant voltage supplied across each pump module, and electrical currents I_{glp1}, I_{glp2} flow through the respective pump modules during water pumping conditions.

The sum of the four heat generation processes \dot{Q}_{R1 fc} \dot{Q}_{R2 fc} \dot{Q}_{R3 fc} \dot{Q}_{R4 fc} can be denoted as \dot{Q}ₕₑₐₜₑᵣ and the energy balance equation for the Portable Enthalpy-Based GHE Performance Test System be expressed as:

\dot{m}ᵢₙhᵢₙ=\dot{m}ₒᵤₜhₒᵤₜ+\dot{Q}ₕₑₐₜₑᵣ+\dot{W}_{glp1}+\dot{W}_{glp2}

As the inlet and outlet mass flow rates are constant, \dot{m}₁=\dot{m}₂=\dot{m}, the energy balance equation above can be expressed as follows:

\dot{Q}ₕₑₐₜₑᵣ=\dot{m}(hᵢₙ−hₒᵤₜ)−\dot{W}_{glp1}−\dot{W}_{glp2}

Using algebraic manipulation, the energy balance equation can be expressed as:

\dot{Q}ₕₑₐₜₑᵣ+\dot{W}_{glp1}+\dot{W}_{glp2}=−\dot{m}(hₒᵤₜ−hᵢₙ)

Recognizing that \dot{Q}_{ghe}=\dot{m}(hₒᵤₜ−hᵢₙ), the energy conservation balance can be reduced to the expression:

\dot{Q}ₕₑₐₜₑᵣ+\dot{W}_{glp1}+\dot{W}_{glp2}=−\dot{Q}_{ghe}

which states that the rate of “heat energy” introduced into the ground loop water stream by the heater, \dot{Q}ₕₑₐₜₑᵣ, plus the rate of work done by (i.e. flow energy introduced into) the ground loop pumps in the Portable Enthalpy-Based GHE Performance Test System, \dot{W}_{glp1}+\dot{W}_{glp2}, equals the rate of heat energy exchanged by the test ground heat exchanger (GHE) with the deep Earth, \dot{Q}_{ghe}, during ground heat exchanger test operations. However, as the expected rate of heat energy introduced into the water stream by the heating elements will be substantially greater than the rate of “flow energy” introduced into the water stream by the pumps (e.g. by a factor of 10 or more), the above energy balance equation can be formulated by the following approximation:

\dot{Q}ₕₑₐₜₑᵣ−\dot{Q}_{ghe}

Notably, this approximated energy balance equation governs the resultant system formed by the GHE Performance Test System connected to the ground heat exchanger (GHE) under testing, and states that: during ground heat exchanger test operations, when the GHE Performance Test System is operating in its cooling mode where Tᵢₙ>Tₒᵤₜ>T_{de}, the rate of heat energy \dot{Q}ₕₑₐₜₑᵣ introduced into the constant water (mass) flow (i.e. control volume) by the water pumping and heating module, is substantially equal to the rate of heat energy −\dot{Q}_{ghe} moving away from the heated water in the ground heat exchanger and into the deep Earth, in accordance with the First Law of Thermodynamics and consistent with design specifications for the Portable Enthalpy-Based GHE Performance Test System. This energy balance holds true for any type ground heat exchanger connected to the GHE Performance Test System during performance testing operations.
Modeling the Energy and Mass Balances Across the Control Volume for a Concentric-Tube Ground Heat Exchanger when Operating in a State of Thermal Equilibrium where Inlet and Output Temperatures Equal the Deep Earth Temperature

In addition to measuring the actual heat transfer rate (HTR) of a ground heat exchanger \dot{Q}_{ghe} during ground loop design process, the designer and engineer also have a need to know exactly the rate of work expressed in [BTUs/Hr] \dot{W}_{pghe} which the ground loop water circulation pump(s) must perform to push and/or pull water through each ground heat exchanger (GHE) in the ground loop design, so as to maintain a particular volume/mass flow rate through each ground heat exchanger. Also, it is noted that this flow work rate (FWR) for each ground heat exchanger \dot{W}_{pghe} will depend on the frictional and other fluid pressure losses generated within the ground heat exchanger, during performance testing operations.

At this stage, it is essential to derive a formula for the flow work rate (FWR) of any ground heat exchanger \dot{W}_{pghe} that might be tested by the GHE Performance Testing System of the present invention, in accordance with the First Law of Thermodynamics and energy and mass conservation principles, reviewed in detail above.

For any closed thermodynamic system, in which the rate of increase of thermal and mechanical energy stored in its control volume is zero, the First Law of Thermodynamics can be expressed in rate form as a generalized energy conservation balance, shown in FIG. 4 and given by the previously defined expression set forth again below for convenience:

$$\dot{Q} + \dot{W} + {\dot{m}}_{in} ( {u}_{in} + {P}_{in} {v}_{in} + \frac{{\overline{V}}_{in}^{2}}{2 {g}_{c}} + \frac{{gZ}_{in}}{{g}_{c}} ) = {\dot{m}}_{out} ( {u}_{out} + {P}_{out} {v}_{out} + \frac{{\overline{V}}_{out}^{2}}{2 {g}_{c}} + \frac{{gZ}_{out}}{{g}_{c}} )$$

For modeling purposes, there is a need to express all assumptions relating to the ground heat exchanger when it is connected to the Portable Enthalpy-Based GHE Performance Test Instrumentation System of the present invention, and operating in its flow work rate (FWR) test mode.

Firstly, the water circulation pumps that will be employed in the ground loop system under design will be mounted at ground level along with the ground heat exchanger(s), so that the potential energy terms (PEᵢₙ and PEₒᵤₜ) associated with the water flow through the ground heat exchanger will be negligible and thus reduce KEᵢₙ=KEₒᵤₜ=0. Consequently, during testing operations, the Portable GHE Performance Test Instrumentation System will also be located at ground level (Zᵢₙ=Zₒᵤₜ=0) where the ground heat exchanger under testing has been installed, to simulate actual circulation pump operations.

Secondly, during FWR testing operations, the heating section of the Enthalpy-Based GHE Performance Test Instrumentation System will be de-energized (i.e. not powered), and the water circulation pumps fully energized and operated so that water circulates through the ground heat exchanger at a constant mass/volume flow rate such that V̅ᵢₙ= V̅ₒᵤₜ, \dot{m}=\dot{m}₁=\dot{m}₂, and thus reducing the kinetic energy terms KEᵢₙ and KEₒᵤₜ also to zero.

Thirdly, during the FWR test mode, the circulation pumps in the Portable Enthalpy-Based GHE Performance Test Instrumentation System will circulate the water through the test loop so that steady-state temperature conditions are attained when the condition Tᵢₙ=Tₒᵤₜ=T_{de} exists, indicating that the temperature of water leaving the ground heat exchanger equals the temperature of the water leaving the ground heat exchanger, which is equal to the deep Earth temperature. Under such operating conditions, the heat transfer rate for the system in this state is negligible \dot{Q}=0, and the temperature-dependent internal energy states (U) of the flow of KE water entering and leaving the ground heat exchanger will be equal, i.e. \dot{m}ᵢₙuᵢₙ=\dot{m}ₒᵤₜuₒᵤₜ.

Fourthly, water entering and leaving the system during such conditions is essentially incompressible and therefore vᵢₙ=vₒᵤₜ=v.

Taking the above assumptions into consideration, the energy balance equation for a control volume drawn about the water flow path through the GHE is illustrated in FIGS. 7A and 7B and expressed as:

\dot{m}ᵢₙvᵢₙPᵢₙ+\dot{W}_{ghe}=\dot{m}ₒᵤₜvₒᵤₜPₒᵤₜ

where \dot{W}_{ghe} is the work rate performed by the GHE upon the flowing water mass, entering the GHE with input flow energy rate \dot{m}ᵢₙ(Pᵢₙvᵢₙ), and leaving the GHE with an output flow energy rate \dot{m}ₒᵤₜ (Pₒᵤₜvₒᵤₜ), reduced in energy rate by the frictional and viscous forces presented \dot{W}_{ghe}=\dot{m}v(Pₒᵤₜ−Pᵢₙ) along the flow path of the GHE.

After algebraically manipulating the above energy balance/conservation equation and making substitutions based on the assumptions above, the work rate expression for the ground heat exchanger is derived as follows:

\dot{W}_{ghe}=\dot{m}v(Pₒᵤₜ−Pᵢₙ)

Under normal HTR and FWR test conditions, Pᵢₙ>Pₒᵤₜ and the net work done by the GHE on the water flowing through the GHE will be a negative figure, indicating that the ground heat exchanger (GHE) performed negative work against the water flow, decreasing its flow energy rate (through frictional, viscous and other fluid pressure losses) as the fluid moves through the GHE, without a change in its potential or kinetic energies.

A similar energy balance can be performed for a U-tube type ground heat exchanger, which also results in a similar work rate expression for the ground heat exchanger as follows:

\dot{W}_{ghe}=\dot{m}v(Pₒᵤₜ−Pᵢₙ)

Notably, while the same mathematical expression is derived for the work rate of the concentric-tube ground heat exchanger and any U-tube ground heat exchanger, one can expect such work rate figures to be significantly less for the concentric-tube ground heat exchanger designs than for U-tube GHE designs, due to the fact that a GHE construction produces a significantly lower pressure drop across its inlet and outlet ports, on a per linear foot basis, than does a conventional U-tube ground heat exchanger construction.
Modeling the Energy and Mass Balances Across the Control Volume for the Ground Loop Water Pumping and Heating Module of the Enthalpy-Based GHE Performance Test System, when Operating in a State of Thermal Equilibrium where Inlet and Output Temperatures Equal the Deep Earth Temperature

Referring to FIG. 7E, the control volume is defined for the water pumping and heating modules in the Portable Enthalpy-Based GHE Performance Test Instrumentation System is schematically depicted during the FWR test mode, when the circulation pumps in the GHE Performance Test Instrumentation System circulate the water through the test loop so that steady-state temperature conditions are attained when the condition Tᵢₙ=Tₒᵤₜ=T_{de} exists, indicating that the temperature of water leaving the ground heat exchanger equals the temperature of the water leaving the ground heat exchanger, which is equal to the deep Earth temperature.

During such steady-state thermal equilibrium conditions, and using notation and naming conventions used in representing the energy balance of the ground heat exchanger(s), the energy balance equation for the system depicted in FIG. 7E is represented in FIG. 7F and expressed below as follows:

\dot{m}ₒᵤₜvₒᵤₜPₒᵤₜ+\dot{W}_{glp1}+\dot{W}_{glp2}=\dot{m}ᵢₙvᵢₙPᵢₙ

Applying algebraic manipulation, and the relations \dot{m}ᵢₙ=\dot{m}ₒᵤₜ=\dot{m}, vᵢₙ=vₒᵤₜ=v, the following expression can be expressed as:

W_{glp1}+\dot{W}_{glp2}=\dot{m}v(Pᵢₙ−Pₒᵤₜ)

Renaming \dot{W}_{glp1}+\dot{W}_{glp2}=\dot{W}_{pghe}, the total rate of work done by the pumps can be computed to push/pull fluid through the single ground heat exchanger under testing, the following formula is obtained:

\dot{W}_{pghe}=\dot{m}v(Pᵢₙ−Pₒᵤₜ)

This formula is used in the Spreadsheet GHE Performance Calculator of FIG. 10, to compute the performance figure (FWR) from actually measured variables {m, Pᵢₙ, Pᵢₙ} and {m, Pₒᵤₜ, Pₒᵤₜ} and the specific volume of water v which is constant for water in its incompressible liquid state over the operating pressures and temperatures during performance testing. This performance figure provides a precise measure of the actual power required by a ground loop pump to circulate (push/pull) water through the single test ground loop exchanger, during the FWR test operations, indicated in Steps 6 and 7 in FIG. 8A, to overcome frictional, viscous and other losses in the GHE to maintain the continuous flow of the water through the control volume of the GHE without any change in kinetic or potential energy of the water flowing through the GHE.

Expressed in units of [BTU/hr], this computed FWR figure will appear significantly low in most practical GHE applications, as it only represents the rate of work required by the pump to overcome frictional, viscous and other losses along a single GHE, and does not account for the work rate (and time duration) that was actually required to move the volume of water in the GHE from an original stationary state, to a state in which the water is flowing through the GHE at a specified volume flow rate (e.g. 16 GPM). For this reason, it should be clearly understood that the FWR figure for a given GHE is, by itself, insufficient to specify the horsepower and mass/volume pump rate that will be actually required by the ground loop circulation pumps, to adequately transport water through the overall ground loop subsystem under design and construction, at the required rates required by any given application. Engineers skilled in the fluid transfer and hydraulic arts will know how to properly design for the water pumping requirements of any particular ground loop system, taking into consideration: pressure drops across all piping components employed in the ground loop subsystem, including ground heat exchangers; necessary work rates required to overcome changes in potential and/or kinetic energy that may exist along the ground loop under design and construction; and other factors well known in the fluid transfer and hydraulic arts.

Engineers should appreciate that the FWR figure, measured in situ for each ground heat exchanger (GHE) under performance testing, is used in computing the Energy Efficiency Ratio (EER) for a GHE installed at a particular test site, as taught hereinbelow. Notably, this empirically-determined FWR figure has been selected for the EER definition as it represents the actual rate of work (energy) that the ground loop pump must do on the water flowing through the GHE, to overcome frictional, viscous and other energy losses and maintain the continuous flow of water through the control volume of the GHE, without incurring losses in kinetic or potential energy as water flows through the GHE.

Defining an Energy Efficiency Ratio (EER) for the Ground Heat Exchanger (GHE) in Accordance with the Principles of the Present Invention

Having derived equations for both the heat transfer rate (HTR) and the power work rate (FWR) functions of concentric-tube and U-tube ground loop exchangers, it is appropriate to point out that ground loop engineers also need to know, in quantitative terms, how much more or less energy efficient any particular ground heat exchanger (GHE) construction is (i) relative to the same type of ground heat exchanger construction but installed at a different geological environment, (ii) relative to a different type of ground heat exchanger construction installed at the same geological location, and/or (iii) relative to a different type of ground heat exchanger construction installed at a different geological location. Such a third figure of performance should assist the ground loop engineers in rationally deciding on a particular type of ground loop heat exchanger technology for any particular geothermal system project, as well as for a particular geological ground loop location where a ground loop subsystem has been planned out for design and construction.

In order to determine how many units of heat energy are actually transferred between an installed ground heat exchanger and the Earth, for each unit of energy utilized by the ground loop pump to circulate water through the ground heat exchanger, per unit length of drilled borehole, it will be helpful to define a new performance figure, called the Energy Efficiency Ratio (EER_{ghe}), which is similar to a Coefficient of Performance (COP_{ghe}) shall be an empirically measured figure of performance for each and every ground heat exchanger installation, defined by the following formula:

$${EER}_{ghe} = \frac{{\dot{Q}}_{ghe}}{{\dot{W}}_{pghe}} = {COP}_{ghe}$$

where both \dot{Q}_{ghe} and \dot{W}_{pghe} are calculated on a “per linear foot of drilled borehole” basis, to normalize the EER figure and enable fair and reliable comparisons between different types of ground source heat exchangers installed at the same geological location.
The EER figure above can be expressed in terms of measured inlet and outlet temperatures and pressures, as follows:

$${EER}_{ghe} = \frac{{\dot{Q}}_{ghe}}{{\dot{W}}_{pghe}} = \frac{\dot{m} ( {h}_{out} - {h}_{in} )}{\dot{m} v ( {P}_{in} - {P}_{out} )}$$

Through simple factoring, the empirically determined ground heat exchanger Energy Efficiency Ratio (EER_{ghe}) is measured by the following formula, expressed only as a function of measured inlet and outlet temperatures and pressures, independent of the mass/volume flow rate of the water passing through the ground heat exchanger.

$${EER}_{ghe} = \frac{{\dot{Q}}_{ghe}}{{\dot{W}}_{pghe}} = \frac{1}{v} \frac{( {h}_{out} - {h}_{in} )}{( {P}_{in} - {P}_{out} )}$$

### Defining the Heat Transfer Efficiency (HTE) for any Ground Heat Exchanger (GHE) Installed in a Deep Earth Environment, Based on the Empirically Measured Enthalpies of Water Entering and Leaving the Ground Heat Exchanger (GHE)

In addition to the figures of GHE performance, such as heat transfer rate (HTR), the flow work rate (FWR), and Energy Efficiency Ratio (EER_{ghe}), engineers also need to know, in quantitative terms, how efficient any “real” ground heat exchanger (GHE) construction is, in the “heat transfer” sense, relative to an “ideal” ground heat exchanger installed in the same deep Earth environment, and operating at similar ground loop conditions (i.e. having the same inlet water temperature T_{de}).

What is meant by an “ideal” ground heat exchanger (GHE) is a GHE that is installed in a deep Earth temperature having a deep Earth temperature T_{de} which is fed with water at an inlet water temperature Tᵢₙ and where the outlet water temperature Tₒᵤₜ is always equal to the deep Earth temperature Tₒᵤₜ (i.e. Tₒᵤₜ=T_{de}).

Such operating characteristics exemplify ideal heat transfer performance in a GHE (i.e. independent of the size or dimensions of the heat exchanging surfaces or heat transfer fluid flow rates might be necessary to achieve such ideal heat transfer performance characteristics) causing the heat energy of the inlet water, at temperature Tᵢₙ, to be exchanged with the deep Earth environment so that the temperature of outlet water Tₒᵤₜ is equal to the temperature of the deep Earth environment T_{de}.

In essence, the heat transfer performance of an idea GHE is limited only by the difference in temperature between (i) the inlet water temperature Tᵢₙ and (ii) the deep Earth temperature T_{de}, and nothing else—which is why the ideal GHE is selected as the reference for measuring heat transfer efficiency (HTE) of any ground heat exchanger (GHE) installed in a deep Earth environment.

This fourth figure of performance should assist engineers in better understanding how well any particular ground heat exchanger (GHE) installation is in harnessing the available potential energy existing between the entering water flowing into a ground heat exchanger, and its deep Earth temperature.

Referring now to FIG. 7G, an energy conservation balance is shown for any type of “real” concentric-tube or U-tube ground heat exchanger (GHE) operating in thermal equilibrium when the inlet water temperature Tᵢₙ is not equal to the outlet water temperature Tₒᵤₜ, which is not equal to the deep Earth temperature T_{de} (i.e. Tᵢₙ≠Tₒᵤₜ≠T_{de}).

As shown, the energy and mass balance equation for the control volume of this real GHE system is given by the following expression:

\dot{Q}_{ghe}^{real}=\dot{m}[hₒᵤₜ(Tₒᵤₜ,Pₒᵤₜ)−hᵢₙ(Tᵢₙ,Pᵢₙ)]

where hᵢₙ(Tᵢₙ, Pᵢₙ) is the enthalpy of the inlet water to the real GHE obtained from the steam table using state variables (Tᵢₙ, Pᵢₙ), and where hₒᵤₜ (Tₒᵤₜ, Pₒᵤₜ) is the enthalpy of the outlet water to the real GHE obtained from the steam table using state variables (Tₒᵤₜ, Pₒᵤₜ).

For this closed system, \dot{m}ᵢₙ=\dot{m}ₒᵤₜ=\dot{m}, and the above expression can be rewritten as follows:

\dot{Q}_{ghe}^{real}=\dot{m}[hₒᵤₜ(Tₒᵤₜ,Pₒᵤₜ)−hᵢₙ(Tᵢₙ,Pᵢₙ)]=HTR_{ghe}^{real}

where the heat transfer rate between the GHE and the deep Earth environment can be represented as: \dot{Q}_{ghe}^{real}=HTR_{ghe}^{real}.

Referring to FIG. 7H, an energy conservation balance is shown for an “ideal” concentric-tube or U-tube ground heat exchanger (GHE) operating in thermal equilibrium when the inlet water temperature Tᵢₙ is not equal to the outlet water temperature Tₒᵤₜ, but where the outlet water temperature Tₒᵤₜ is equal to the deep Earth temperature T_{de} (i.e. Tᵢₙ≠Tₒᵤₜ=T_{de}).

As shown, the energy and mass balance equation for the control volume of this ideal GHE system is given by the following expression:

\dot{m}ᵢₙhᵢₙ(Tᵢₙ,Pᵢₙ)+\dot{Q}_{ghe}^{ideal}=\dot{m}ₒᵤₜhₒᵤₜ(T_{de},Pₒᵤₜ)

where hᵢₙ(Tᵢₙ, Pᵢₙ) is the enthalpy of the inlet water to the ideal GHE obtained from the steam table using state variables (Tᵢₙ, Pᵢₙ), and where hₒᵤₜ (T_{de}, Pₒᵤₜ) is the enthalpy of the outlet water to the ideal GHE obtained from the steam table using state variables (T_{de},Pₒᵤₜ).

For this closed system, \dot{m}ᵢₙ=\dot{m}ₒᵤₜ=\dot{m}, and the above expression can be rewritten as follows:

\dot{Q}_{ghe}^{ideal}=\dot{m}[hₒᵤₜ(T_{de},Pₒᵤₜ)−hᵢₙ(Tᵢₙ,Pᵢₙ)]

where the heat transfer rate between the GHE and the deep Earth environment can be represented as: \dot{Q}_{ghe}^{ideal}=HTR_{ghe}^{ideal}.

Now, as shown in FIG. 7I, by definition, the heat transfer efficiency of any real GHE, notated as HTE_{ghe} (Tᵢₙ,T_{de}), or simply HTE_{ghe}, shall be defined as the ratio of:
(i) the heat transfer rate HTR_{ghe}^{real}=\dot{Q}_{ghe}^{real} of the real GHE installed in a deep Earth environment, and
(ii) the heat transfer rate HTR_{ghe}^{ideal}=\dot{Q}_{ghe}^{ideal} of the ideal GHE installed in a deep Earth environment;

wherein the real GHE is operated at the temperature differential defined by the inlet water temperature and the deep Earth temperature (Tᵢₙ,T_{de}), and ideal GHE is also operated at the same temperature differential defined by the inlet water temperature and the deep Earth temperature (Tᵢₙ, T_{de}).

Formally, the heat transfer efficiency HTE can be expressed as follows:

$${HTE}_{ghe} = \frac{{\dot{Q}}_{ghe}^{real}}{{\dot{Q}}_{ghe}^{ideal}} = \frac{\dot{m} [ {h}_{out} ( {T}_{out} , {P}_{out} ) - {h}_{in} ( {T}_{in} , {P}_{in} ) ]}{\dot{m} [ {h}_{out} ( {T}_{de} , {P}_{out} ) - {h}_{in} ( {T}_{in} , {P}_{in} ) ]}$$

This expressed can be simplified to provide:

$${HTE}_{ghe} = \frac{[ {h}_{out} ( {T}_{out} , {P}_{out} ) - {h}_{in} ( {T}_{in} , {P}_{in} ) ]}{[ {h}_{out} ( {T}_{de} , {P}_{out} ) - {h}_{in} ( {T}_{in} , {P}_{in} ) ]}$$

And with some algebraic manipulation, the above equation can be rewritten as a complex ratio of enthalpy values for the inlet and outlet water streams into the real and ideal GHEs, given as follows:

$${HTE}_{ghe} = \frac{[ \frac{{h}_{out} ( {T}_{out} , {P}_{out} )}{{h}_{in} ( {T}_{in} , {P}_{in} )} - 1 ]}{[ \frac{{h}_{out} ( {T}_{de} , {P}_{out} )}{{h}_{in} ( {T}_{in} , {P}_{in} )} - 1 ]}$$

Let's consider two extreme operating conditions and see how this performance figure works.

When Tᵢₙ=Tₒᵤₜ then HTE_{ghe}=0 and this represents the lowest performance case where a real GHE is operating at 0.0% heat transfer efficiency with the deep Earth environment. When Tₒᵤₜ=T_{de} then HTE_{ghe}=1.0 and this represents the highest (ideal) performance case where a real GHE is operating at 100.0% heat transfer efficiency with the deep Earth environment, which is not attainable in reality, but does represent the ideal case towards which all GHE designs and constructions should strive. In practice, real GHEs will perform somewhere between these two extremes (i.e. 0.0<HTE_{ghe}<1.0)

To provide a sense for this figure of performance consider the case of Kelix's 300 foot Theramcouple™ GHE (Model TC50) installed in a deep Earth environment having an average deep Earth temperature about the borehole of about T_{de}=55F. Based on performance testing, the average empirically-determined HTR_{ghe} for the Thermacouple™ GHE TC50 is about 60,000 [BTU/Hr] or 5 [Tons]. When operating the Theramcouple™ TC50 GHE at an inlet water temperature Tᵢₙ=95F, with a resulting outlet water temperature of Tₒᵤₜ=85F when the mass flow rate into and of the TC50 GHE is about 8012 [LBM/HIR] (i.e. when the volumetric flow rate is 16 [GPM]), the heat transfer efficiency for the GHE measures HTE_{ghe} 0.248 representing about 25% heat transfer efficiency, measured against the ideal GHE standard depicted in FIG. 7H

In summary, the empirically measurable figures for the HTR of the ground heat exchanger, its associated flow work rate (FWR), its Energy Efficiency Ratio (EER) and Heat Transfer Efficiency (HTE) defined above provides ground loop engineers with three new and essential GHE performance figures for use in rationally deciding on a particular type of ground loop heat exchanger technology to implement on a particular geothermal system project, and how to accurately size the actual energy requirements for pumping water through the ground heat exchanger during its heat transfer operations with its deep Earth environment.

For further details regarding thermodynamics, heat transfer and fluid and mass flow principles related to the present invention, reference is made to: DOE Fundamentals Handbook: Thermodynamics, Heat Transfer, And Fluid Flow, Volumes 1, 2 and 3, DOE-HDBK-1012/1-92, June 1992, DOE-HDBK-1012/2-92, June 1992 and DOE-HDBK-1012/3-92, June 1992; Thermodynamics: An Engineering Approach (Seventh Edition) by Yunus A. Cengel and Michael A. Boles, McGraw-Hill, 2010; Thermodynamics: Concepts and Applications, by Stephen R. Turns, Cambridge University Press 2006; Fundamentals of Heat and Mass Transfer (Sixth Edition) by F. P. Incropera, D. P. Dewitt, T. L. Bergmann, and A. S. Lavine, John Wiley & Sons, 2007; and A Heat Transfer Textbook (Third Edition) by John H. Lienhard IV and John H. Lienhard V, Phlogiston Press, Cambridge Mass., 2008; wherein each said reference is incorporated herein by reference.

### Method of Measuring the Heat Transfer Rate (HTR), Flow Work Rate (FWR), Energy Efficiency Ratio (EER), and Heat Transfer Efficiency (HTE) of a Ground Heat Exchanger (GHE) Installed in a Deep Earth Environment

Based on thermodynamic and energy and mass conservation principles, a mathematical formula for the heat transfer rate between the ground heat exchanger (GHE) under testing and its deep Earth environment, \dot{Q}ghe=\dot{m}(hₒᵤₜ−hᵢₙ) has been derived, employing measured values of input and output temperatures and pressures, and mass flow rates across the ground heat exchanger. Also, mathematical formulas for flow work rate \dot{W}_{pghe}=\dot{m}v(Pᵢₙ−Pₒᵤₜ), energy efficiency ratio,

$${EER}_{ghe} = \frac{{\dot{Q}}_{ghe}}{{\dot{W}}_{pghe}} ,$$

and heat transfer efficiency (HTE_{ghe}),

$${HTE}_{ghe} = \frac{[ \frac{{h}_{out} ( {T}_{out} , {P}_{out} )}{{h}_{in} ( {T}_{in} , {P}_{in} )} - 1 ]}{[ \frac{{h}_{out} ( {T}_{de} , {P}_{out} )}{{h}_{in} ( {T}_{in} , {P}_{in} )} - 1 ]}$$

have also been derived as additional figures of energy-based performance, based on empirical measurements taken in the ground loop field test site.

It is now appropriate at this juncture, to describe a novel method of measuring the heat transfer rate, flow work rate, energy efficiency ratio and heat transfer efficiency of a ground heat exchanger (GHE) installed in a deep Earth environment, illustrated in FIGS. 8A through 8F, and involving the use of the above formulas described above.

STEP 1: install a ground heat exchanger (GHE) in a borehole drilled in the Earth at a location where a ground loop subsystem is to be designed and constructed using multiple ground heat exchangers (GHEs). Preferably, the GHE is a concentric-tube turbulence-generating GHE as disclosed on Applicant's U.S. Pat. Nos. 7,343,753; 7,347,059; 7,363,769; 7,370,488; 7,373,785; and 7,377,122, each patent being incorporated herein by reference.

STEP 2: connect the portable heat transfer rate testing system to the input and output ports of the installed ground heat exchanger, and charging the resulting ground loop with a predetermined fixed quantity of water (i.e. heat transferring fluid) with an inlet water pressure Pᵢₙ=15.5 [psig].

STEP 3: start the water circulation pump and circulating the predetermined quantity of water through the test loop at a constant mass flow rate \dot{m} [lbm/hr] through the test ground loop.

STEP 4: start monitoring and logging-into the data logger/recorder, the controlled mass flow rate of water \dot{m}, as well as the inlet and outlet/return water temperatures Tᵢₙ and Tₒᵤₜ measured in units of [° F.], and inlet and outlet/return water pressures Pᵢₙ and Pₒᵤₜ measured in units of [° F.].

STEP 5: monitor the loop water temperatures Tᵢₙ and Tₒᵤₜ and determine when these temperatures are approximately equal Tₒᵤₜ=Tᵢₙ which will be deemed a steady-state thermal equilibrium value approximating the deep Earth temperature T_{de}=Tₒᵤₜ=Tᵢₙ, which typically will fall within the range of about 45° F. to about 75° F. depending on the borehole location in the planet Earth.

Notably, Steps 3 through 5 provide a way to estimate the time-response characteristics of the ground heat exchanger to store up thermal energy in the mass of its heat transfer fluid (e.g. water), physical structure and surrounding borehole Earth environment, for subsequent release to the geothermal system (e.g. ground source heat pump) during heating modes of operation.

STEP 6: when T_{de}=Tₒᵤₜ=Tᵢₙ, and while the water heating module is still de-energized and not supplying heat energy into the water loop, start monitoring and recording the inlet and outlet temperatures Tᵢₙ, Tₒᵤₜ and pressures Pᵢₙ, Pₒᵤₜ and mass flow rate at 60 second sampling intervals, for a one hour period.

STEP 7: calculate the flow work rate (FWR) using the formula \dot{W}_{pghe}=\dot{m}v(Pᵢₙ−Pₒᵤₜ) expressed in units of BTU/Hr or HP, for ground heat exchanger pump powering requirements, and record the calculation. This FWR figure represents the rate of work performed by the water circulation pumps (in the GHE Performance Test System) on the heat transferring fluid (i.e. water), in order to overcome frictional, viscous and other energy losses and maintain the flow of the heat transferring fluid through the GHE, without any change in kinetic or potential energy of the water while flowing through the control volume of the GHE.

STEP 8: when T_{de}=Tₒᵤₜ=Tᵢₙ, start the electrically-powered water heaters and begin to introduce thermal energy into the water being controllably circulated through the test ground loop.

STEP 9: determine when the temperature of water flowing into the inlet of the ground heat exchanger T₁ reaches a constant input temperature Tᵢₙ (e.g. Tᵢₙ=95° F. in the Cooling Test Mode) maintained by the electrical water heater and its control circuitry, and when this condition is detected, then send a start test command to the data logger/recorder to begin a predetermined test period (e.g. 72 hours) and start indexing/logging recorded test data as being part of the test data set.

STEP 10: automatically measure, log and record within the digital recorder/logger, inlet and outlet temperatures Tᵢₙ and Tₒᵤₜ, pressures Pᵢₙ and Pₒᵤₜ, and the constant mass flow rate of water \dot{m} [lbm/hr] or its volume flow rate F [gallons/minute], at discrete periodic sampling times (e.g. every 60 seconds), during the entire test period.

STEP 11: use the Thermacouple™ Spreadsheet Enthalpy-Based GHE Performance Calculator, as illustrated in FIG. 5, with its integrated steam table for sub-cooled water over the range of measured temperature and pressures values (shown in FIG. 4), to perform the following operations, during or at the end of the test period:

(i) importing logged-in temperature, pressure and mass flow rate data values into the spreadsheet GHE performance calculator;

(ii) using measured water temperatures and pressures Tᵢₙ, Pᵢₙ and Tₒᵤₜ, Pₒᵤₜ, respectively, and the steam tables for water, to determine the input and output enthalpy values of water in the ground loop, hᵢₙ and hₒᵤₜ, expressed in units of [BTUs/lbm];

(iii) for each measuring period, using the enthalpy-based heat transfer rate formula \dot{Q}_{ghe}=\dot{m}(hₒᵤₜ−hᵢₙ) and enthalpy table of FIG. 4 to calculate the actual rate of heat energy transfer being exchanged between the ground heat exchanger and its deep Earth environment, measured in units of [BTUs/Hr]; and

(iv) entering the computed heat transfer rate values Q_{ghe} into the spreadsheet GHE performance calculator.

STEP 12: determine when the last measuring period in the predetermined time period of the performance test has lapsed, and when this event has been detected, then stop the electrically-powered water heaters from supplying heat energy into the circulating water loop but continue pumping water through the loop at constant mass flow rate \dot{m}, while measuring and logging-into the data logger/recorder, the controlled mass flow rate of water \dot{m}, the inlet and outlet/return water temperatures Tᵢₙ and Tₒᵤₜ, and inlet and outlet/return water pressures Pᵢₙ and Pₒᵤₜ.

STEP 13: monitor the loop water temperatures Tᵢₙ and Tₒᵤₜ and determine when these temperatures are approximately equal Tₒᵤₜ=Tᵢₙ which will be deemed a steady-state value approximating the deep Earth temperature T_{de}=TₒᵤₜTᵢₙ.

STEP 14: determine when T_{de}=Tₒᵤₜ=Tᵢₙ, and when this thermal equilibrium condition is detected, and while the water heating module is still de-energized and not supplying heat energy into the water loop, monitor, log and record the inlet and outlet temperatures Tᵢₙ and Tₒᵤₜ and pressures Pᵢₙ and Pₒᵤₜ and mass flow rate \dot{m} at 60 second sampling intervals, for a one hour period.

Steps 13 and 14 above provide a way to estimate the time-response characteristics of the ground heat exchanger during the release thermal energy stored up in the mass of its heat transfer fluid (e.g. water), physical structure and surrounding borehole Earth environment, to the geothermal system (e.g. ground source heat pump) during heating modes of operation.

STEP 15: calculate, once again, the flow work rate (FWR) using the formula \dot{W}_{pghe}=\dot{m}v(PᵢₙPₒᵤₜ) expressed in units of BTU/Hr or HP, for ground heat exchanger pump powering requirements, and record the results of the calculation.

STEP 16: determine when T_{de}=Tₒᵤₜ=Tᵢₙ, and Steps 14 and 15 above have been carried out, and then stop the water loop pumps, and conclude that the performance test has been completed.

STEP 17: calculate the energy efficiency ratio of the ground heat exchanger using the formula

$${EER}_{ghe} = {COP}_{ghe} {EER}_{ghe} = \frac{{\dot{Q}}_{ghe}}{{\dot{W}}_{pghe}} = {COP}_{ghe}$$

where the figures \dot{Q}ghe, \dot{W}_{pghe} have been calculated on a per linear foot of drilled borehole basis, and then record the EER_{ghe} value.

STEP 18: calculate the Heat Transfer Efficiency (HTE) of the ground heat exchanger (GHE) using the formula:

$${HTE}_{ghe} = \frac{{\dot{Q}}_{ghe}^{real}}{{\dot{Q}}_{ghe}^{ideal}} = \frac{[ 1 - \frac{{h}_{out} ( {T}_{out} , {P}_{out} )}{{h}_{in} ( {T}_{in} , {P}_{in} )} ]}{[ 1 - \frac{{h}_{out} ( {T}_{de} , {P}_{out} )}{{h}_{in} ( {T}_{in} , {P}_{in} )} ]}$$

and then record the calculated HTE_{ghe} value.

STEP 19: generate a heat transfer rate performance report or chart for the completed performance test period, indicating the actual HTR, FWR, and EER performance figures supported by the ground heat exchanger under performance testing.

The calculated HTR figure provides the engineer with an empirical measure on the rate of heat energy (expressed in BTU/Hour) that a single installed ground heat exchanger of specific borehole length can be expected to actually transfer (i.e. exchange) between the Earth and the geothermal heat pump or chiller system to which the ground heat exchanger is connected, where such in situ heat transfer rate testing is performed. Also, such HTR measurements provides the ground loop engineer with an empirical measure on the rate of heat energy that a linear foot of ground heat exchanger can be expected to actually transfer (i.e. exchange) between the heat transferring fluid and the Earth, expressed in units of [BTU/hr ft].

The calculated FWR figure provides a performance measure indicating how much (or little) work, measured in [BTUs/Hr], is actually required by the ground loop pump to push and pull water through the inlet and outlet ports of each tested ground heat exchanger (GHE). While typically not a significant figure with respect to other pressure-dissipating components in a ground loop subsystem, this figure provides an actual measure of work continuously supplied to a GHE, which is required when computing the EER_{ghe}=COP_{ghe} figure discussed below.

The calculated EER_{ghe}=COP_{ghe} figure provides a performance measure indicating how many heat transfer rate (HTR) units are achieved by the GHE for a each unit of flow work rate (FWR) supplied to the working fluid moving through the GHR, and allowing for simple performance comparisons among different ground loop technologies tested at any given loop field test site, or between different loop field test sites.

The calculated HTE_{ghe} figure provides the engineer with a performance measure indicating how close to an “ideal” ground heat exchanger (GHE), a particular GHE under testing is performing in its deep Earth environment, under particular operating conditions. Notably, this energy-based performance figure is a function of inlet water temperature and deep Earth temperature, and thus varies when these parameters change.

Method of and Apparatus for Measuring Changes in Deep Earth Temperature about a Ground Heat Exchanger in Response to Thermal Loads on Neighboring Ground Heat Exchangers

During the ground loop engineering process, there might come a time when the thermal conductivity properties of the deep Earth environment might be brought into serious question, especially when a very large project is involved. In such instances, Kelix recommends that multiple Portable Enthalpy-Based GHE Performance Test Instrumentation Systems described above be used to carry out a thermal response measurement test involving installation of four Thermacouple™ ground heat exchangers (TC50s GHEs) at a particular test site, on which a ground loop subsystem is being planned for design and construction. The purpose of such a test arrangement is to measure changes in deep Earth temperature (ΔT_{de}) about a ground heat exchanger (GHE-1) in response to thermal loads on neighboring ground heat exchangers (GHE-2, GHE-3 and GHE-4). In most geological test environments, the thermal properties of the deep Earth mass, and underground water resources, are such as to rapidly disperse and distribute heat energy from neighboring ground heat exchangers at a rate as to not cause any significant increase in deep Earth temperature throughout the year.

As shown in Step 1 of FIG. 6B, the method involves installing one “thermally-passive” Thermacouple™ ground heat exchanger (GHE-1) in a 300 foot deep borehole drilled in the middle of the test site, and then installing three “thermally-active” Thermacouple™ ground heat exchangers (GHE-2, GHE-3 and GHE-4) in three 300 foot deep boreholes drilled twenty (20) feet away from the centrally drilled borehole for GHE-1, so that ground heat exchangers GHE-2, GHE-3 and GHE-4 are each spaced apart from each other by 20 feet and arranged at 120 degrees from each other about GHE-1, in a star-like configuration as illustrated in FIG. 6A.

Step 2 of the method involves connecting a first Portable Enthalpy-Based GHE Performance Test Instrumentation System (S1) to the first ground heat exchanger GHE-1, and configuring for test operation; then connecting a second Portable Enthalpy-Based GHE Performance Test Instrumentation System (S2) to the second ground heat exchanger GHE-2, and configuring it for test operation; then connecting a third Portable Enthalpy-Based GHE Performance Test Instrumentation System (S3) to the third ground heat exchanger GHE-3, and configuring it for test operation; and then connecting a fourth Portable Enthalpy-Based GHE Performance Test Instrumentation System (S4) to the fourth ground heat exchanger GHE-4, and configuring it for test operation.

Step 3 of the method involves supplying electrical power to the ground loop water pumping module of each Portable Test Instrumentation System to circulate heat transferring fluid (water) through each ground heat exchangers GHE-1 through GHE-4, continuously monitoring, logging and recording the inlet and outlet temperatures and pressures and mass flow rates of each ground heat exchanger, and to detect when the inlet and outlet water temperatures of each ground heat exchanger equal the deep Earth temperature, T_{de}, and “deep Earth” thermal equilibrium has been attained.

Step 4 of the method involves, recording at thermal equilibrium, the steady state deep Earth temperatures T_{de}(GHE-1) through T_{de}(GHE-4) measured at the inlet and outlet ports of ground heat exchangers GHE-1 through GHE-4, respectively, and when the thermal equilibrium state has been attained after about 60 minutes or more of water pumping operations, identifying this steady state deep Earth temperature as a “reference” temperature for measuring changes in deep Earth temperature T_{de} about GHE-1 after a long term exposure of heat energy into the deep Earth during Step 4, below.

Step 5 of the method involves, when thermal equilibrium has been attained, supplying electrical power to the water heating module of Portable Test Instrumentation Systems S2, S3 and S4, but not S1, heating the water flow through GHE-2, GHE-3 and GHE-4, and continuously monitoring, logging and recording inlet and outlet temperatures, pressures and mass flow rates into all GHEs, during the entire test period (e.g. 150 hours).

Step 6 of the method involves using the first Test Instrumentation System (S1) to measure any detected difference in the deep Earth temperature T_{de} relative to the reference temperature T_{de} (GHE-1 initial state), and log and record any temperature differences, each sampling interval, which may occur as a result of thermal response characteristics associated with the deep Earth and selected borehole spacing at the particular test site under performance testing.

Step 6 of the method involves carefully reviewing any detected changes in deep Earth temperature during the long-term test period, and reconsidering increasing or decreasing the spacing (i.e. distance) between drilled boreholes for ground heat exchanger installations planned for the ground loop system being design for construction at the test site.

Ideally, the longer the test period, the better, but practical considerations and temperature trends detected over a 150 hour test period should typically indicate little need to extend the period beyond this time frame.

In Earth environments where there is sufficient ground water and adequate thermal conductivity, differences in deep Earth temperature should measure relative low, if not negligible, during steady-state long term conditions.

It is expected that for most geological environments, where there is sufficient ground water, borehole distances of about 20 or more feet will result in deep Earth temperature changes that are negligible, indicating that the deep Earth environment under testing has the capacity to dissipate and distribute heat energy from the ground loop subsystem, throughout the mass of the surrounding deep Earth so as not appreciably alter the average deep Earth temperature throughout the year, from season to season.

### Globally-Extensive, Mobile-Wireless GPS-Tracking Ground Heat Exchanger (GHE) Performance Test Instrumentation Network of the Present Invention

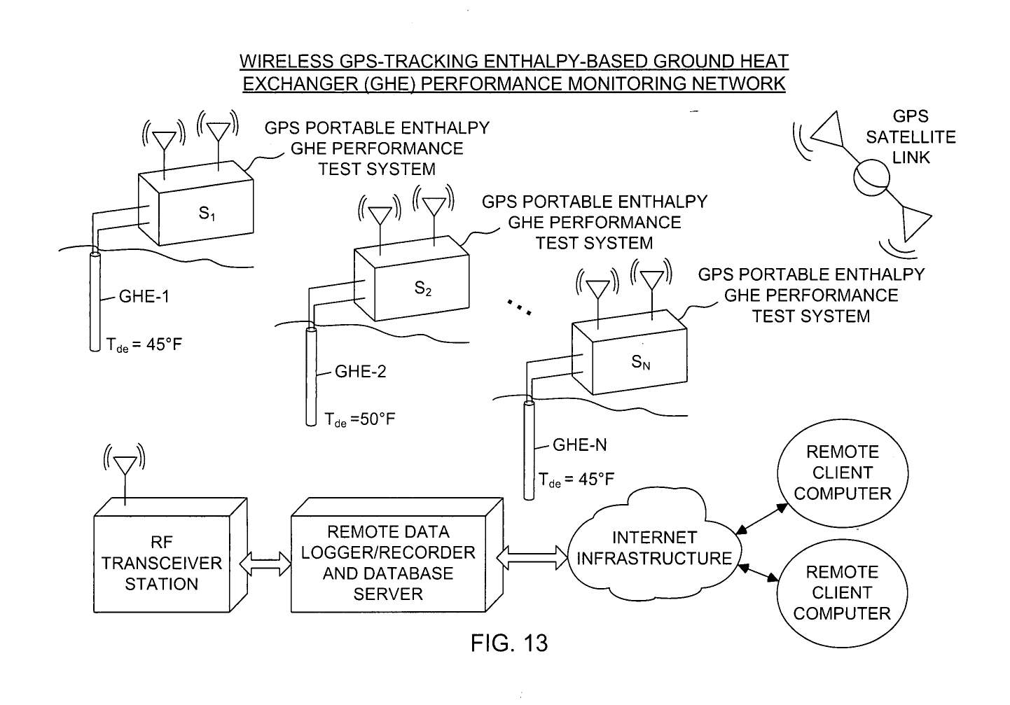

FIG. 13 shows the globally-extensive, Mobile-Wireless GPS-Tracking Ground Heat Exchanger (GHE) Performance Test Instrumentation Network of the present invention as comprising: a plurality of wireless Portable GPS-Based Enthalpy-Based GHE Performance Test Instrumentation Systems described hereinabove.

As shown, each such Mobile GHE Performance Test System is connected to a ground heat exchanger (GHE) installation, and is capable of monitoring and logging GPS-indexed performance test data on the installed ground heat exchanger, and transmitting such performance test data from the Portable Test System to a remotely situated RF transceiver station, operably connected to a remote data logger/recorder and database server. In turn, the remote data logger/recorder and database server is operably connected to the infrastructure of the Internet, in a conventional manner.

One or more GPS satellites transmit GPS signals which are received and processed by a GPS transceiver/processor in each GPS-Based Enthalpy-Based GHE Performance Test System, to resolve its location using GPS techniques well known in the art. Remote client systems, running the Spreadsheet Enthalpy-Based GHE Performance Calculator of the present invention, can access and import logged and recorded test data from the database server, and then calculate the performance figures (e.g. HTR, FWR and EER) using the Spreadsheet Enthalpy-Based GHE Performance Calculator.

Alternatively, the functionalities of the Spreadsheet Enthalpy-Based GHE Performance Calculator can be integrated into the database server, allowing remote client systems to use a Web-based browser to directly access calculated HTR, FWR and EER performance figures on a particular ground heat exchanger test installation.

Using the Instrumentation Network of the present invention shown in FIG. 13, ground loop engineers and hydro-geologists working together can easily create a GPS-indexed heat transfer rate (HTR) performance database using empirically obtained heat transfer rate (HTR) performance surveys taken using a closed-loop concentric-type ground heat exchanger and GPS-tracking enthalpy-based HTR performance test instrumentation. By doing so, geothermal engineers have empirical knowledge of the potential capacity of specific regions of Earth mass to exchange heat energy with such types of ground heat exchangers, based on scientific research and empirical investigation.

Also, using the Instrumentation Network of FIG. 13, ground loop engineers and others can easily create a GPS-indexed heat transfer rate (HTR) performance database, by combining empirical heat transfer rate (HTR) measurements with spatially corresponding hydro-geological measurements of underground ground water conditions.

Such objectives will be readily apparent in view of the present disclosure.

### The Enthalpy-Based Ground Loop Performance Monitoring Module of the Present Invention

FIG. 14A shows a first completed geothermal heat pump system being monitored by an Enthalpy-Based Ground Loop (GLHE) Performance Monitoring Module constructed in accordance with the principles of the present invention. As shown, the Ground Loop Performance Monitoring Module is mounted within the pump room of a building in which the completed geothermal heat pump system has been installed and is operating. The geothermal heat pump system is connected to an air handling subsystem, under the control of the central environmental control system of the building. As shown, state variables {Tᵢₙ, Pᵢₙ, \dot{m}ᵢₙ} and {Tₒᵤₜ, Pₒᵤₜ, \dot{m}ₒᵤₜ} are monitored for water flowing into and out of the GLHE subsystem and fed into the Ground Loop Performance Monitoring Module for calculation of the net heat transfer rate (HTR) for the control volume about the entire ground loop field (GLHE) using enthalpy-based HTR calculation techniques taught herein.

As shown, the Ground Loop Performance Monitoring Module also uses formulas defined in FIG. 14B to calculate EER and HTE for the system control volume indicated in FIG. 14B.

FIG. 15 shows a second completed geothermal heat pump system being monitored by an Enthalpy-Based Ground Loop Performance Monitoring Module constructed in accordance with the principles of the present invention. As shown, the geothermal heat pump system includes a ground loop subsystem constructed from multiple ground heat exchangers, connected to multiple, individually zoned ground source heat pumps (GSHPs), by an input and output manifold structures, at which transducers and instruments are installed for measuring the inlet and outlet temperature, pressure and mass flow rates of the heat exchanging fluid (i.e. water), to provide state variables {Tᵢₙ, Pᵢₙ, \dot{m}ᵢₙ} and {Tₒᵤₜ, Pₒᵤₜ, \dot{m}ₒᵤₜ} which are fed into the Ground Loop Performance Monitoring Module for calculation of the net heat transfer rate (HTR) for the entire ground loop field (GLHE) using enthalpy-based HTR calculation techniques taught herein.

### Overview On Methods of Designing and Constructing Ground Loop Heat Exchanging (GLHE) Subsystems According to the Principles of the Present Invention

When using the ground loop engineering (GLE) process of the present invention, the ground loop engineer works with average heat transfer rates (HTR) that have been empirically determined by the GHE's manufacturer, and/or its geothermal consulting team, for a particular model of ground heat exchanger (GHE) (e.g. Kelix Model TC50) when installed in diverse kinds of geological environments and conditions, generally characterized by the presence of low to moderate levels of ground water at borehole depths ranging between 30-300 feet deep.

For example, the empirically determined heat transfer rate for a single 300 foot ground heat exchanger (GHE) is specified in the Manufacturer's Ground Heat Exchanger (GHE) Design Library schematically depicted below, represents the “estimated” capacity of a particular GHE model to extract heat energy from or inject heat energy into the deep Earth environment (i.e. 30-300 feet deep), at the specified rate, expressed in units of Tons, or BTU/Hr, and alternatively, in units of BTU/Hr, per linear foot of the ground heat exchanger [BTU/Hr-ft].

Ground Heat Exchanger (GHE) Design Library

| Kelix Model | Linear Length | HTR* [BTU/ [symbol] | HTR* [BTU/hr-ft] |
|---|---|---|---|
| TC50 | 300 | ~60,000 | ~200.0 |
| TC40 | 280 | ~48,000 | ~171.4 |
| TC30 | 260 | ~36,000 | ~138.5 |

*Empirically Estimated Heat Transfer Rate (HTR) [symbol]
indicates data missing or illegible when filed

For small-scale projects (e.g. less than 15 Tons of heating or cooling), the GLE process recommends ground loop designer or engineer to use a library of empirically-estimated heat transfer rate (HTR) figures, published by the GLE Design Library set forth above.

Designers and engineers use such published heat transfer rate (HTR) figures to estimate how many ground heat exchangers (GHEs) of a particular length (by a particular manufacturer), when installed 20 or so feet apart from each other in the loop field, will be required to construct a ground loop heat exchanging (GLHE) subsystem having a sufficient capacity to exchange heat energy with the deep Earth environment, and meet the requirements of the geothermal heat pump system to which it is connected. This average or estimated heat energy transfer rate (HTR) of a single ground heat exchanger (GHE), provides a reliable measure on the heat transfer rate (HTR) capacity of a single ground heat exchanger (GHE).

For medium-to-large scale projects (e.g. greater than 15 Tons of heating or cooling), the GLE process recommends the ground loop engineer to conduct an in situ heat transfer rate (HTR) test on a single test ground heat exchanger (GHE) installed at the loop field test site.

The heat transfer rate test is best carried out using the Portable Enthalpy-Based GHE Performance Test System disclosed herein, or other system employing the Enthalpy-Based Heat Transfer Rate (HTR) Method taught herein. The purpose of the in situ heat transfer rate (HTR) test is to empirically determine the “actual” rate of heat transfer performance of a single ground heat exchanger (GHE), expressed in BTU/Hr, when constructed/installed in the particular loop field under construction.

Using this empirically determined (actual) heat transfer rate figure for the given loop field under construction expressed in [BTU/Hr], or alternatively in an equivalent heat transfer rate per linear foot of ground heat exchanger [BTUs/hr-ft], the geothermal designer/engineer can then quickly determine the optimal number (or linear feet) of ground heat exchanger (GHE) that must be installed in the specified loop field to construct a ground loop heat exchanging (GLHE) subsystem having a sufficient heat transfer rate capacity, in the most economical manner technically possible.

Ground loop engineers are encouraged to allow for extra heat transfer rate (HTR) capacity in each ground loop heat exchanger (GLHE) subsystem design, because this will provide a desired degree of thermal storage/banking to the resulting GLHE subsystem under design and construction.

Method of Designing and Constructing Small-Scale Geothermal Ground Loop Subsystems in Accordance with the Principles of the Present Invention

Multiple ground heat exchangers (GHEs) can be coupled together to construct small-scale geothermal ground loop heat exchanger (GLHE) subsystems (e.g. requiring less than 15 Tons of heat transfer rate performance). In such size geothermal system projects, a “library-based” design/engineering method is recommended, as described below.

STEP 1: determine the total thermal load of the geothermal system under design. In cooling dominant locations, this is achieved by computing the total HVAC thermal energy load (including Peak and Block Load calculations) of the building project.

STEP 2: divide the total HVAC thermal energy load by the average empirically-determined heat transfer rate (HTR) of a single ground heat exchanger (e.g. 5 Tons or 60,000 BTU/Hr), to compute the total number of ground heat exchangers (GHEs) required to construct a small-scale ground loop subsystem that meets the maximum heat transfer rate requirements of the building project, in the cooling or heating dominant location, as the case may be.

Notably, the average empirically-determined HTR value for a particular GHE is specified in the Manufacturer's Ground Heat Exchanger (GHE) Library, schematically depicted above.

For a Model TC50 300 foot Thermacouple™ GHE, its HTR value is used to compute the total number of 300 foot Thermacouple™ ground heat exchangers (Model TC50) that will be required to construct a small-scale ground loop subsystem that will meet the maximum heat transfer rate requirements of the building project, in the cooling dominant location.

When designing a GLHE subsystem for heating dominant locations, the ground loop designer or engineer should confirm that the total factory-specified heating capacity of the ground source heat pump(s), and other supplementary, or auxiliary heating equipment sources to be used, are added up to meet the building heating load requirement.

Once this is achieved, the ground loop designer or engineer divides this load figure by the average empirically-determined HTR value for a single ground heat exchanger (GHE) model, specified in the Manufacturer's GHE Library. Then this average HTR value is used to compute the total number of ground heat exchangers (GHEs) required to meet the maximum heat transfer rate requirements of the building project in the heating dominant location.

At this stage, it is highly recommended that the ground loop engineer consult a local hydro-geologist with expertise in and knowledge of the local hydrogeology of the land on which the ground loop subsystem under design is being planned for construction/installation.

Also, it is highly recommended that the hydro-geologist consult with federal, state and local authorities who may have actual knowledge, and/or recorded evidence of the hydro-geological conditions on the proposed ground loop field, including aquifers and ground water formations and resources present in the terrestrial aquatic environment in which ground heat exchangers (GHEs) will be installed.

STEP 3: use the average number of ground heat exchangers (GHEs) to layout the ground loop field using suitable computer-assisted 2D or 3D geometry modeling tools, such as AUTOCAD MEP® software from Autodesk, Inc.

Ground loop fields are designed in various shapes and sizes, depending on the thermal loading requirements of the geothermal HVAC or chiller systems, to which the ground loops are connected. Also, most ground loop fields are configured to fit within the available real estate property boundaries of the buildings being served.

As a general rule, a 20 foot borehole-spacing distance is recommended between neighboring boreholes of ground heat exchangers (GHEs), to achieve sufficient thermal isolation between neighboring ground heat exchangers (GHEs), in the resulting ground loop subsystem under design and construction. However, it is understood that greater borehole spacing distances (e.g. 25 feet borehole spacing) is preferred, if and wherever possible. The reason is that additional borehole/GHE spacing beyond 20 feet will increase the capacity of the deep Earth environment about each ground heat exchanger to quickly absorb and disperse thermal energy within the semi-infinite deep Earth environment in which it is installed, without a measurable or significant change in the average deep Earth temperature T_{de} in the vicinity of the ground heat exchanger, over long periods of time.

Placing ground heat exchangers too closely (i.e. significantly less than 20 feet apart) runs the risk of changing the deep Earth temperature over long periods of time, and degrading the local temperature gradients about each ground heat exchanger (GHE). In accordance with the laws of heat transfer, strong local temperature gradients are required for the rapid transfer of heat energy (i) from ground heat exchanger into the deep Earth environment during cooling modes, and (ii) from the deep Earth environment into the ground heat exchanger during heating modes of operation.

Also, at this stage, it is recommended that the ground loop designer or engineer consult a local hydro-geologist with expertise in and knowledge of the local hydrogeology of the land on which the ground loop subsystem under design is being planned for construction/installation. The hydro-geologist should consult with federal, state and local authorities who may have actual knowledge, and/or recorded evidence of the hydro-geological conditions on the proposed ground loop field, including aquifers and ground water formations and resources present in the terrestrial aquatic environment in which ground heat exchangers (GHEs) will be installed.

STEP 4: design a ground loop zoning and piping arrangement that meets the requirements of the ground loop layout designed in STEP 3.

In connection with ground loop layout design, it is understood that that are many ways to layout out a predetermined number of ground heat exchangers about the premises of a building or building complex. The ground loop field designer will consider the number of “Heating/Cooling Zones” being provided for in the building environment whose space is to be automatically controlled, and also the maximum thermal load that each such Heating/Cooling Zone must handle by design.

The ground loop field designer and engineers should also consider ways of intelligently (i) organizing groups of ground heat exchangers (GHEs) into “Ground Loop Zones,” (ii) assigning one or more “Heating/Cooling Zones” to a Ground Loop Zone, and (iii) then connecting these Heating/Cooling Zones to the Ground Loop Zones by networks of fluid piping, including water circulation pumps, valves, manifolds and other controls and measures.

When designing, constructing and testing such underground fluid piping networks, reference should be made to GHE Manufacturer's Installation Instructions. Such documents will provide technical guidance and instruction required to design, construct and test such underground fluid piping networks using conventional materials, methods and standards. When properly designed and constructed, such underground fluid piping networks should interconnect installed ground heat exchangers together, along with water circulation pumps, valves, manifolds and controls, to form Ground Loop Zones that are connected to geothermal heat pumps, the unloading sections of chillers, or other thermal conditioning equipment, to complete any ground loop heat exchanging (GLHE) subsystem.

STEP 5: construct the finally designed GLHE subsystem at the specified test site using the average number of GHEs determined in STEP 3, the ground loop field layout determined in STEP 3, and ground loop piping arrangement determined in STEP 4.

STEP 6: test and tune the installed GLHE subsystem as taught herein.

STEP 7: install and configure an Enthalpy-Based Ground Loop Performance Monitoring Module in accordance with the principles and procedures taught herein.

### Method of Designing and Constructing Medium-to-Large Scale Geothermal Ground Loop Subsystems

Multiple ground heat exchangers (GHEs) can be coupled together to construct medium-to-large scale ground loop heat exchanging (GLHE) subsystems (e.g. requiring more than 15 Tons of heat transfer rate performance). In such size geothermal system projects, a “recursive-type” design/engineering method is recommended, as described below.

STEP 1: compute the total thermal (HVAC) load of the geothermal system under design, as explained above.

STEP 2: divide the total HVAC thermal energy load by the average empirically-determined heat transfer rate (HTR) of a single ground heat exchanger GHE (e.g. 5 Tons or 60,000 BTU/Hr) to compute an “approximate” number of ground heat exchangers (GHEs) from a particular manufacturer, to construct the ground loop subsystem for the geothermal system, where each ground heat exchanger (GHE) is to be spaced at least 20 feet apart at the ground loop field location.

Notably, the average empirically-determined HTR value for a particular GHE is specified in the Manufacturer's Ground Heat Exchanger (GHE) Library, illustrated above For a Model TC50 300 foot Thermacouple™ GHE, its HTR value is used compute the total number of 300 foot Thermacouple™ GHEs (Model TC50) that will be required to construct a small-scale ground loop subsystem that will meet the maximum heat transfer rate requirements of the building project, in the cooling dominant location.

STEP 3: use the “approximated” number of ground heat exchangers (GHEs) to layout the ground loop field using suitable computer-assisted 2D or 3D geometry modeling tools, such as, for example, AUTOCAD MEP® software from Autodesk, Inc.

Ground loop fields are designed in various shapes and sizes, depending on the thermal loading requirements of the geothermal HVAC or chiller systems, to which the ground loops are connected. Also, most ground loop fields are configured to fit within the available real estate property boundaries of the buildings being served.

As a general rule, a 20 foot borehole-spacing distance is recommended between neighboring boreholes of ground heat exchangers, to achieve sufficient thermal isolation between neighboring ground heat exchangers, in the resulting ground loop subsystem under design and construction. However, it is understood that greater borehole spacing distances (e.g. 25 feet borehole spacing) is preferred, if and wherever possible. The reason is that additional borehole/GHE spacing beyond 20 feet will increase the capacity of the deep Earth environment about each ground heat exchanger, to quickly absorb and disperse thermal energy with the semi-infinite deep Earth environment in which it is installed, without a measurable or significant change in the average deep Earth temperature T_{de} in the vicinity of the ground heat exchanger, over long periods of time.

Placing ground heat exchangers too closely (i.e. significantly less than 20 feet apart) runs the risk of changing the deep Earth temperature over long periods of time, and degrading the local temperature gradients about each ground heat exchanger. In accordance with the laws of heat transfer, strong local temperature gradients are required for rapid transfer of heat energy (i) from ground heat exchanger into the thermal mass of the deep Earth environment during cooling modes, and (ii) from the deep Earth environment into the ground heat exchanger during heating modes of operation.

Also, at this stage, it is recommended that the engineer consult a local hydro-geologist with expertise in and knowledge of the local hydrogeology of the land on which the ground loop subsystem under design is being planned for construction/installation. The hydro-geologist should consult with federal, state and local authorities who may have actual knowledge, and/or recorded evidence of the hydro-geological conditions on the proposed ground loop field, including aquifers and ground water formations and resources present in the terrestrial aquatic environment in which ground heat exchangers (GHEs) will be installed.

STEP 4: determine the actual number of boreholes to be drilled at the loop field location, and in which ground heat exchangers will be installed, to construct an optimize ground loop heat exchanger (GLHE) subsystem for the estimated thermal load of the geothermal system.

This step is carried out by (i) installing at least one ground heat exchanger at the actual loop field location for the project, and then (ii) empirically measuring the actual maximum heat transfer rate of the ground heat exchanger at the particular loop field location. The GLE Process recommends that the Portable Enthalpy-Based GHE Performance Test System and Method described above be used to carry out this step of the ground loop engineering process, to empirically determine a heat transfer rate (HTR) performance measure for the test ground heat exchanger installed at the ground loop field site.

The empirically determined heat transfer rate (HTR) measurement of the single Thermacouple™ ground heat exchanger represents the capacity of a single Thermacouple™ ground heat exchanger installation to extract a maximal rate of heat energy from or inject a maximal rate of heat energy into the deep Earth environment, in which it is installed.

The geothermal system designer/engineer then uses the measured heat transfer rate (HTR) for the test ground heat exchanger (GHE) to accurately determine the optimal number of ground heat exchangers that will required to construct the complete GLHE subsystem for the geothermal project, at the given loop field location.

Based on this optimal number of ground heat exchangers (GHEs), calculated using an empirically determined HTR value, the ground loop designer can modify the initial layout of the ground loop field as required.

When revising the ground loop field layout, an inter-borehole spacing of at least 20 feet should be assumed, based on empirical testing by the GHE manufacturer. However, under exceptional circumstances (e.g. when ground loop field space and thermal load requirements are urging for significantly less than 20 foot borehole spacing), deep Earth temperature response testing should be seriously considered using the test method indicated in STEP 5 below, to empirically determine (short-term) effects of borehole distance on GHE thermal coupling.

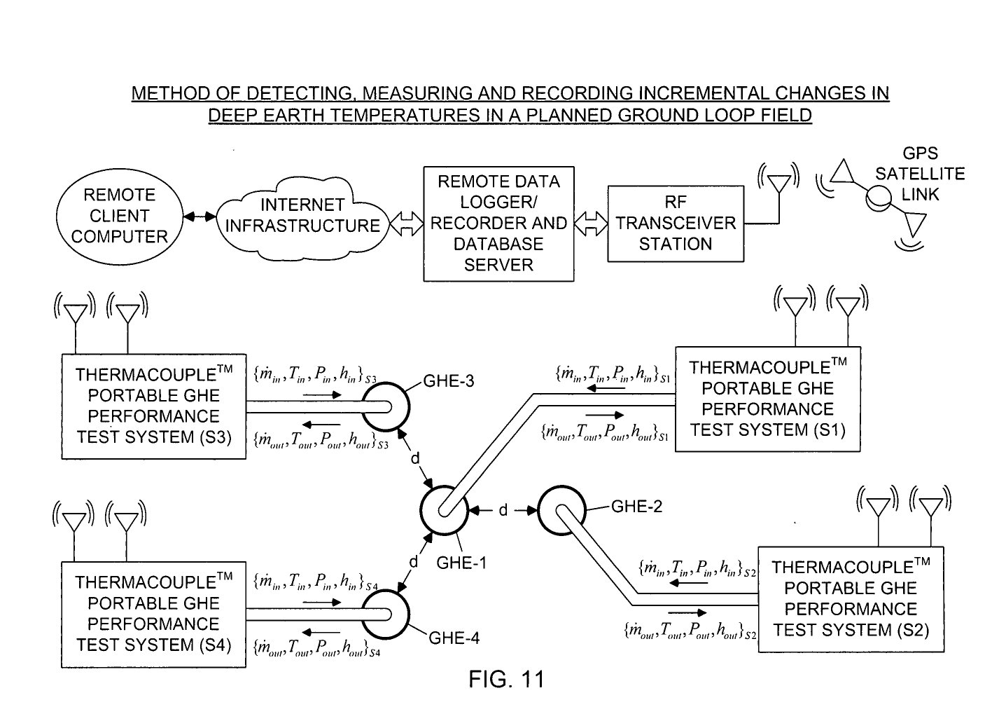

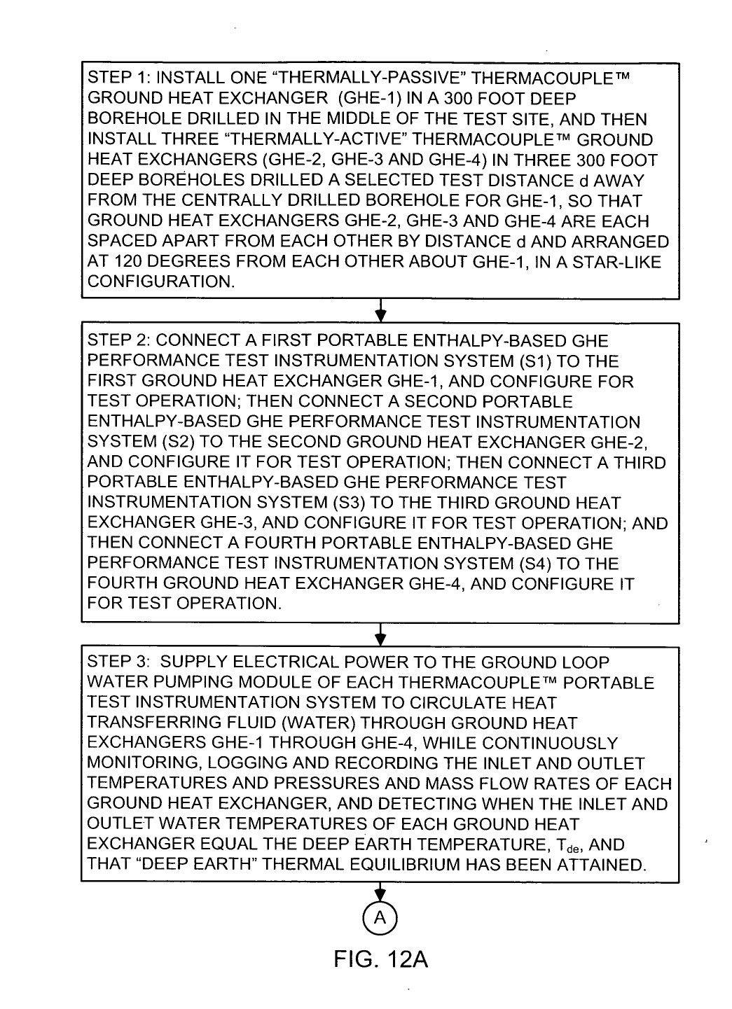

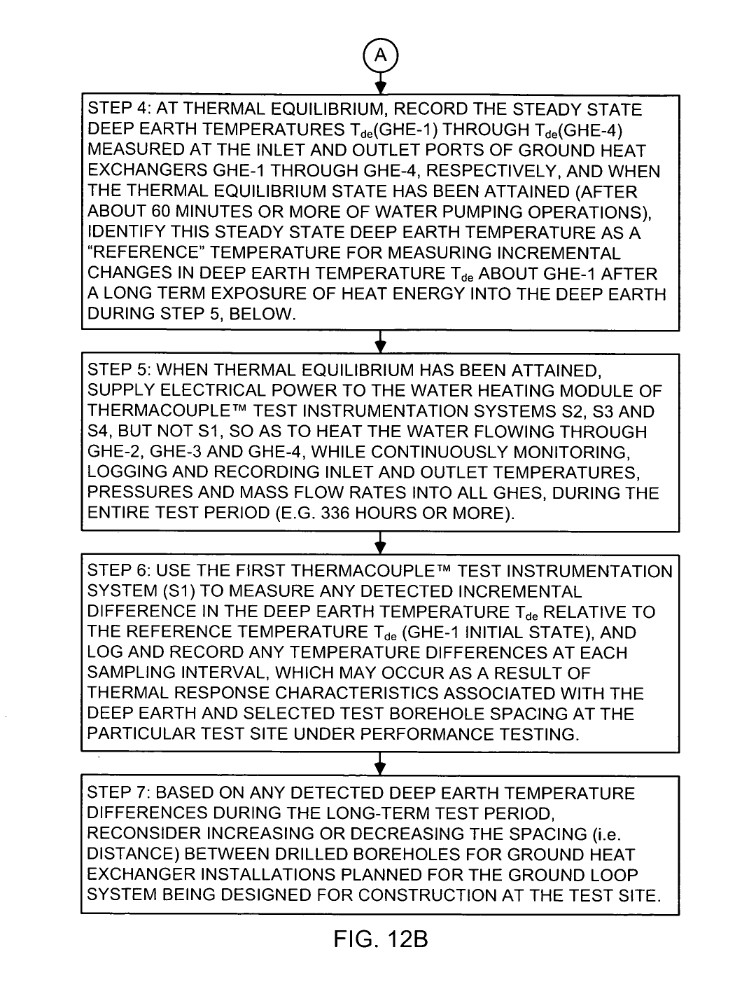

STEP 5: only when the thermal conductivity properties of the deep Earth environment have been brought into serious question for a very large project, planned on a relatively small parcel of land, use multiple Portable Enthalpy-Based GHE Performance Test Systems to carry out a “Deep Earth Temperature Response Test” as illustrated in FIGS. 11 and 12B.

The sole purpose of this test, which will require at least one week to perform, for reliable test results, will assist the ground loop engineer in determining on the minimal borehole spacing, in which ground heat exchangers (GHEs) can to be installed in a high density manner, in the particular ground loop environment, without adversely affecting the performance of such ground heat exchangers.

STEP 6: design a ground loop zoning and piping arrangement that meets the requirements of the ground loop layout designed in STEP 5.

In connection with ground loop layout design, it is understood that that are many ways to layout out a predetermined number of ground heat exchangers (GHEs) about the premises of a building or building complex.

The ground loop field designer should consider the number of “Heating/Cooling Zones” being provided for in the building environment whose space is to be automatically controlled, and also the maximum thermal load that each such Heating/Cooling Zone must handle by design.

The ground loop field designer and engineers should also consider ways of intelligently (i) organizing groups of ground heat exchangers into “Ground Loop Zones,” (ii) assigning one or more “Heating/Cooling Zones” to a Ground Loop Zone, and (iii) then connecting these Heating/Cooling Zones to the Ground Loop Zones by networks of fluid piping, including water circulation pumps, valves, manifolds and other controls and measures.

When designing, constructing and testing such underground fluid piping networks, reference should be made to Manufacturer's GHE Installation Instructions, and other documentation, described below, that will provide technical guidance and instruction required to design, construct and test such underground fluid piping networks using conventional materials, methods and standards. When properly designed and constructed, such underground fluid piping networks should interconnect installed ground heat exchangers together, along with water circulation pumps, valves, manifolds and controls, to form Ground Loop Zones that are connected to geothermal heat pumps, the unloading sections of chillers or other thermal conditioning equipment, to complete any GLHE subsystem.

STEP 7: construct the finally designed ground loop subsystem in the specified test site using the determined number of ground heat exchangers (GHEs), and ground loop field layout determined in Step 4, and piping arrangement determined in Step 6.

STEP 8: test and tune the installed GLHE subsystem taught herein.

STEP 9: install and configure an Enthalpy-Based Ground Loop Performance Monitoring Module in accordance with the principles of the present invention.

How to Interconnect Thermacouple™ Ground Heat Exchangers with Water Circulation Pumps and Geothermal Equipment Using Conventional Piping Materials, Methods and Standards

The integrity of any fluid piping network, employed in the construction of any ground loop heat exchanging (GLHE) subsystem, will depend on many factors including design and construction considerations, methods, materials, and workmanship.

By virtue of its composition, a fluid piping network is comprised of many components, including, for example, pipes, flanges, supports, gaskets, bolts, valves, strainers, flexible and expansion joints. In general, such components can be made from a variety of materials, in different types and sizes, and may be manufactured to common national standards or according to a manufacturer's proprietary specifications. Such standards include, but are not limited to piping codes and standards established by ASME, ANSI, ASTM, AGA, API, AWWA, BS, ISO, and DIN.

In any event, when constructing a fluid piping network for a GLHE subsystem, the following guidelines should be followed closely and carefully:

GUIDELINE 1: refer and conform to the Manufacturer's GHE Installation Instructions, with regard to designing, constructing and testing of such ground heat exchangers (GHEs).

GUIDELINE 2: design and install all piping systems in accordance with ASME B31.9 Building Services Piping standards, which relates to piping typically found in institutional, commercial, and public buildings, multi-unit residences, geothermal heating systems, and district heating and cooling systems.

GUIDELINE 3: install all piping components in accordance with the manufacturer's installation instructions.

GUIDELINE 4: refer and conform to the International Mechanical and the International Plumbing Codes for useful references to materials and methods used in piping construction.

GUIDELINE 5: refer and conform to the pump manufacturer's installation instructions regarding volume flow rates (GPM settings), electrical specifications, and optimum pump sizing. Standard installation practices are advised in regard to pipe sizing and friction losses.

GUIDELINE 6: whenever possible, avoid the use of pipe size reducers, and ells, at or near circulation pumps, which contribute to system wide energy efficiency losses.

GUIDELINE 7: refer and conform to the ASME B31.9 building standard setting forth requirements for Piping that conducts water or antifreeze solutions used for heating and cooling, as such additives can reduce the specific gravity of the heat transferring fluid circulated through a geothermal heat pump system, and may adversely effect the performance of components employed in a GLHE subsystem. Refer to the Manufacturer's GHE Installation Instructions concerning antifreeze solutions.

GUIDELINE 8: underground piping materials and connections must conform to recognized plumbing codes adopted by state and local code rules and regulations.

### Measuring The HTR, FWR, EER and HTE Performance of a Ground Loop Heat Exchanging (GLHE) Subsystem Connected to a Geothermal Heat Pump or Chiller System, Using an Enthalpy-Based Ground Loop Performance Monitoring Module of the Present Invention

FIG. 14B presents an energy conservation balance across the control volume for a ground loop subsystem that is connected to a geothermal heat pump system(s), and monitored by the enthalpy-based GHE performance monitoring module shown being used in the applications of FIGS. 14A and 15.

In general, the ground loop subsystem might be configured to operate with any type of geothermal HVAC or chiller system as shown, for example, in FIGS. 14A and 15, or anywhere heat energy is exchanged with the deep Earth environment through a ground loop subsystem, regardless of its design and/or construction.

The energy balance equation across the control volume defined in FIGS. 14A and 14B is given by the expression:

\dot{m}ₒᵤₜhₒᵤₜ=\dot{m}ᵢₙhⁱⁿ+\dot{Q}_{ghe1}+ . . . +\dot{Q}_{gheN}

This expression can be rewritten as:

\dot{m}ₒᵤₜhₒᵤₜ=\dot{m}ᵢₙhᵢₙ+\dot{Q}_{glf}

where the total or net heat transfer rate between the N number of GHEs and their deep Earth environment is given by the formula \dot{Q}glf=\dot{Q}_{ghe1}+ . . . +\dot{Q}_{gheN}, and by substitution, the energy balance can be rewritten as follows:

\dot{m}ₒᵤₜhₒᵤₜ=\dot{m}ᵢₙhᵢₙ+\dot{Q}_{glf}

By algebraic manipulation, this energy balance can be rewritten as follows:

\dot{Q}_{glf}=\dot{m}(hₒᵤₜ−hᵢₙ)

This expression for \dot{Q}_{glf} provides a formula for measuring the actual heat transfer rate (HTR_{glf}) between the deep Earth environment and the ground loop field system represented by the control volume in FIGS. 14A, 14B and 15.

Referring now to the pump side of the geothermal system under analysis, where M number of circulation pumps are provided, the total work rate performed by M number of circulation pumps on heat transferring fluid flowing through a control volume about this system, can be summed up by the following equation:

\dot{W}_{glp}=\dot{W}_{glp1}+ . . . +\dot{W}_{glpM}

This expression represents the total work rate of the M number of ground loop pumps pushing/pulling heat transferring fluid (water) through the control volume of the ground loop field.

Using flow energy analysis, as performed in Appendix C above, the total amount of flow work performed by these M pumps to move water through the N GHEs is given by the following expression:

\dot{W}_{glp}=mv(Pᵢₙ−Pₒᵤₜ)

This expression for \dot{W}_{glp} provides a formula for measuring the actual flow work rate (EER_{glf}) performed by the M circulation pumps to move water through the ground loop field system, defined by the control volume in FIGS. 14A, 14B and 15, without a change in potential or kinetic energy of the water flow.

Finally, using the formulas derived for HTR_{glf} and FWR_{glp} above, an Energy Efficiency Ratio (EER_{glf}) can be rewritten for the ground loop field (GLF) comprising N number of GHEs, through which water is pumped by M number of circulation pumps, as follows:

$${EER}_{glf} = \frac{{HTR}_{glf}}{{FWR}_{glp}} = \frac{{\dot{Q}}_{glf}}{{\dot{W}}_{glp}}$$

Making substitutions for the net heat transfer rate and the net flow work in the above expression, the Energy Efficiency Ratio (EER) for the ground loop field can be expressed in terms of measurable inlet and outlet enthalpies and pressures, as follows:

$${EER}_{glf} = \frac{( {h}_{out} - {h}_{in} )}{v ( {P}_{in} - {P}_{out} )}$$

Notably, the above formula for EER_{glf} holds for any control volume about a ground loop field comprising N number of GHEs, driven by M number of ground loop circulation pumps, provides an accurate measure of the actual energy efficiency of the ground loop field.

Moreover, this EER performance figure is expressed in terms of (i) the empirically measureable rate of heat energy exchange between the ground loop field (GLHE) and the deep Earth environment, and (ii) the empirically measurable rate of energy supplied to maintain water flowing through the loop field against frictional and viscous losses, without losses in potential or kinetic energy of the water flowing through the ground loop field, and will include losses associated with piping between the GHEs, as well as the inherent losses of each GHE due to internal fluid frictional losses.

In addition, the heat transfer efficiency (HTE) performance measured can be found for this ground loop heat exchanging (GLHE) subsystem using the following formula:

$${HTE}_{glf} = \frac{{\dot{Q}}_{glf}^{real}}{{\dot{Q}}_{glf}^{ideal}} = \frac{[ 1 - \frac{{h}_{out} ( {T}_{out} , {P}_{out} )}{{h}_{in} ( {T}_{in} , {P}_{in} )} ]}{[ 1 - \frac{{h}_{out} ( {T}_{de} , {P}_{out} )}{{h}_{in} ( {T}_{in} , {P}_{in} )} ]}$$

where \dot{Q}_{glf}^{real} and \dot{Q}_{glf}^{ideal} are measured at the control volume of the ground loop (GLHE) as indicated in sir FIGS. 14A and 15, in the illustrative embodiments

The Enthalpy-Based Ground Loop Performance Module shown in FIGS. 14A and 15, comprises: a programmed microprocessor; a system bus; a memory architecture including RAM, FLASH ROM, etc; and high-speed I/O interface, for receiving the inputs from temperature and pressure transducers, fluid rate meters, GPS receiver, and other data inputs indicated in the spreadsheet of FIG. 10; LCD display panel with touch-screen data input and selection functions; communication circuits (GSM, WIFI, and Ethernet) and communication interface/ports; antennas for supporting the communication circuits; and a compact wall-mountable housing for containing all of the system components. The mathematical formulas derived above for HTR_{glf}, FWR_{glp} EER_{glf} and HTE_{glf} are programmed into the micro-computing architecture of the Enthalpy-Based Ground Loop Performance Module in a manner well known in the data monitoring, logging and recording art.

How to Use the Thermacouple™ Spreadsheet Enthalpy-Based Ghe Performance Calculator Program to Measure the Heat Transfer Rate (HTR) Performance of any Ground Heat Exchanger (GHE) or Ground Loop Heat Exchanging (GLHE) System, Coupled to a Geothermal Heat Pump Operating within a Building Environment

In many geothermal heat pump system applications, building owners and energy engineers need to know, in objective quantifiable terms, how well a particular ground loop subsystem is performing in relation to its geothermal heat pump unit to which it is connected and operating within a building environment. The Spreadsheet Enthalpy-Based GHE Performance Calculator Program illustrated in FIG. 10, and its functions described certain steps of FIGS. 8A through 8F, can be run on any computer system to help measure the heat transfer rate (HTR) performance of the ground loop subsystem while coupled to a geothermal heat pump and operating within a building environment.

STEP 1: install the Spreadsheet Enthalpy-Based GHE Performance Calculator Program on any computer system.

STEP 2: define a control volume (CV) around the ground heat exchanger (GHE) or ground loop heat exchanger (GLHE) subsystem as shown in FIGS. 14A and 15, into which and out of which ground loop water flows at a constant mass or volume flow rate, and across the boundaries of which, heat energy is transferred with the deep Earth environment and achieves a state of thermal equilibrium or quasi-equilibrium.

STEP 3: monitor, log and record temperature and pressure values of entering and returning water flows in the ground loop, along with volume/mass flow rates of the water flow.

STEP 4: import the recorded data into the Spreadsheet Enthalpy-Based GHE Performance Calculator Program, and process the data to calculate the actual heat transfer rate (HTR) performance of the GHE or GLHE system.

In such HTR performance monitoring applications, the entering water temperature (i.e. the enthalpy of entering water) will not maintained substantially constant, as otherwise achieved when using the Enthalpy-Based GHE Performance Test System during performance testing operations. Also, the volume/mass flow rates may also vary over time, particularly when using variable-speed ground loop water circulation pumps. However, the energy rates into and out of the ground heat exchanging system must satisfy the First Law of Thermodynamics, in one form or another, and a new state of thermal equilibrium or quasi-thermal equilibrium will be attained as water flows through the ground loop after one or more ground loop system parameters may have been changed during operation of the overall geothermal system.

For such reasons, the enthalpy-based heat transfer rate (HTR) equation employed in the Spreadsheet Enthalpy-Based GHE Performance Calculator should provide a true and accurate measure of the rate of heat transfer entering or leaving any ground heat exchanging subsystem, in [BTUs/Hr], while performance monitoring—provided temperature, pressure and volume flow rate measurements are taken during states of thermal equilibrium or quasi-thermal equilibrium.

When using the Spreadsheet Enthalpy-Based GHE Performance Calculator Program for such GHE or GLHE performance measurements, any commercially available data logging and recording system can be used, such as the HOBO-U30 Remote Monitoring System, from Onset Computer Corporation, along with conventional temperature and pressure transducers, and mass/volume flow rate meters. However, care must be undertaken to ensure that all incoming (analog and digital) data feeds are properly converted to units of measure required by the Spreadsheet Enthalpy-Based GHE Calculator, particularly when implemented using a Microsoft® Excel® Programming environment.

Monitoring, Logging and Recording the Performance of a Tuned Ground Loop Heat Exchanger (GLHE) Subsystem Using the Enthalpy-Based GLHE Performance Monitoring Module, or the Enthapy-Based GHE Performance Calculator Program Running on a Portable Computer System

Once a geothermal system (e.g. geothermal heat pump or chiller system) and its ground loop heat exchanging (GLHE) subsystem have been installed at a particular loop field location, and operating according to manufacturer specifications, it will be useful to monitor the actual performance of the geothermal ground loop subsystem in terms of its actual heat transfer rate (HTR), flow work rate (FWR), energy efficiency ratio (EER) and heat transfer efficiency (HTE) performance in connection with the building environment which the geothermal system serves. Monitoring the HTR, FWR, EER and HTE performance of the GLHE subsystem can be easily accomplished by the following method.

STEP 1: install inlet and outlet temperature and pressure transducers, and a volume flow rate meter(s) at the inlet and outlet manifolds of the ground loop subsystem, as shown in the first exemplary geothermal system shown in FIG. 14A, or the second exemplary geothermal system shown in FIG. 15. As shown in FIG. 14A, the geothermal heat pump system is connected to an air handling subsystem, under the control of the central environmental control system of the building. In FIG. 15, the ground loop field is connected to multiple geothermal heat pumps each having an integrated air handling subsystem.

STEP 3: use the Enthalpy-Based GLHE Performance Monitoring Module to periodically monitor the inlet and outlet temperatures and pressures at a defined control volume of the ground loop system, as well as the volume/mass flow rate through the control volume, {Tᵢₙ, Pᵢₙ, \dot{m}ᵢₙ} and {Tₒᵤₜ, Pₒᵤₜ, \dot{m}ₒᵤₜ} and log and record such data values within either (i) memory aboard the GLHE Performance Monitoring Module, (ii) mass storage in a remotely situated RF data logging and recording station, illustrated in FIG. 1A, and/or (iii) within a portable computer system running the Enthalpy-Based Spreadheet GHE Performance Calculator, shown in FIG. 10.

STEP 4: use either the Enthalpy-Based GLHE Performance Monitoring Module (or the Enthalpy-Based GHE Performance Calculator Program) to process logged and recorded data, and calculate the actual heat transfer rate (HTR), flow work rate (FWR), energy efficiency ratio (EER) and heat transfer efficiency (HTE) figures for the monitored GLHE subsystem, at periodic moments in time, and record these performance figures in a Ground Loop Performance Database maintained within the enterprise of the building which is being served by the ground loop subsystem. The Ground Loop Performance Database can be realized using almost any computer system, but a dedicated server, with automated backup provisions, would be preferred.

After being logged and recorded in the Ground Loop Performance Database, these HTR, FWR, EER and HTE performance figures can be sent to the building's environmental control system, if such a system has been installed, and used in the overall energy management system deployed in the building to improve operations efficiency. These HTR, FWR, EER and HTE performance figures will provide building owners, managers, energy performance managers, and geothermal system maintenance technicians alike, with valuable information on how well any particular ground loop subsystem, and its geothermal heat pump, have been and are currently performing, from season to season, year to year.

The building environmental control system can be programmed to periodically interrupt normal heating and cooling equipment operation of the building, while allowing continuous fluid circulation to a number of independently piped Ground Loop Field Zones, illustrated in FIG. 15, measure, detect and record any incremental changes in the deep Earth temperature of those Ground Loop Field Zones when the inlet and outlet water temperature of those zones are in a state of thermal equilibrium (i.e. Tᵢₙ=Tₒₙᵢ). Periodic deep Earth temperatures, and detected incremental changes therein, can be stored in the Ground Loop Performance Database, along with other performance data maintained on the ground loop throughout its lifetime.

Collectively, the historical performance data records on the ground loop, maintained in the Ground Loop Performance Database, can be used to confirm ground loop performance expectations or projections (with respect to thermal loads), as well as perform diagnostic operations, if and when situations requiring the same should arise.

Modifications that Readily Come to Mind

Having the benefit of the present invention disclosure, several modifications thereto readily come to mind.

For example, in the illustrative embodiments of the Portable GHE Performance Test Instrumentation System of the present invention, the water heating module has been realized using a plurality of electrically-powered individually-switchable water heating elements, preferably powered by a 230 Volt/100 Amp service delivered to the test site using J-cord, a portable electrical power generator or the like. However, in alternative embodiments of the present invention, it is possible to realize the water heating module using natural gas, propane or other combustion-type devices for heating the stream of water flowing through the GHE Performance Test Instrumentation System to maintain a substantially constant inlet temperature Tᵢₙ while the water flow is maintained a constant flow rate during the long term testing operations. Alternatively, it is possible to realize the water heating module using a water-to-water heat pump unit that has been adapted to supply heat energy to the water stream flowing through the water pumping module of the GHE Performance Test Instrumentation System, to maintain a substantially constant inlet temperature Tᵢₙ at a substantially constant mass flow rate through the GHE.

In the illustrative embodiment, the Portable GHE Performance Test Instrumentation System of the present invention has been operating in a “cooling mode” meaning that its water heating module adds heat energy the heat transferring fluid (i.e. water) so that it attains a constant inlet temperature (e.g. Tᵢₙ=95° F.) during performance testing operations, while the mass of the deep Earth environment is allowed to absorb the heat energy at a rate to be empirically measured by the enthalpy-based heat transfer rate measurement techniques practiced by the GHE Performance Test Instrumentation System of the present invention.

However, in alternative embodiments, it is understood that the Portable GHE Performance Test Instrumentation System may be readily adapted to operate in a “heating mode”, meaning that its water heating module would be replaced with a water cooling module, so that the heat transferring fluid (i.e. water) is automatically cooled (rather than heated) as the fluid flows through its pumps to a predetermined constant inlet temperature Tᵢₙ, e.g. 35 [° F.], while flowing through the GHE at a constant mass flow rate during performance testing operations. In such alternative embodiments, the water cooling module can be realized by integrating a refrigeration unit or a water-to-water heat pump with the water pumping module for the purposes of cooling the heat transferring fluid to a substantially constant inlet temperature Tᵢₙ=35 [° F.], at a constant mass flow rate, during performance test operations.

Also, while the illustrative embodiments of the GHE Performance Test Instrumentation System and method of the present invention have been described in connection with concentric-tube (i.e. coaxial-flow) and HDPE U-Tube type ground heat exchangers, it is understood that the test instrumentation methods and apparatus of the present invention can be used to measure the in situ HTR, FWR and EER performance of other closed types of ground heat exchangers, as well as open-type standing column well ground heat exchangers, well known in the art. Such open-type systems will require several modifications to the test system and method, including its energy balance model, to address the “open” nature of the system in which a constant flow of used ground water is being pumped out of the system, while a fresh source of ground water is being pumped into the system, while the mass flow rates of water into and out of the system is maintained substantially constant.

Also, it is understood that the heat transfer rate test method of the present invention, including its enthalpy-based spreadsheet-based GHE performance calculator can be readily adapted for measuring the performance of all kinds of geothermal ground loop subsystems that have been engineered for used with ground source heat pumps, HVAC chillers, and other types of heat transferring machines and systems, working to control the temperature and/or enthalpy of fluids, and/or spatial environments associated with machines, systems, buildings and the like.

It is understood that the HTR, FWR and EER performance test apparatus and methodologies of the present invention may be modified in various ways which will become readily apparent to those skilled in the art of having had the benefit of exposure to the novel teachings disclosed herein. All such modifications and variations of the illustrative embodiments thereof shall be deemed to be within the scope and spirit of the present invention, as defined by the Claims to Invention appended hereto.

1-7. (canceled)

8. A mobile-wireless GPS-tracking ground heat exchanger (GHE) performance test instrumentation network comprising;
a plurality of wireless portable GPS-enabled enthalpy-based GHE performance test instrumentation systems, each being connectable to a ground heat exchanger (GHE) installation, and capable of collecting GPS-indexed performance data relating to at least the heat transfer rate (HTR), and flow work rate (FWR) of said GHE installation under performance testing.

9-10. (canceled)

11. The mobile-wireless GPS-tracking GHE performance test instrumentation network of claim 8, wherein each said portable UPS-enabled enthalpy-based GHE performance test instrumentation system comprises:
a ground loop pumping module for pumping aqueous-based heat transfer fluid through said GHE installation;
a ground loop heating module for heating said aqueous-based heat transfer fluid flowing into said GHE installation;
a power relay control module for controlling said ground loop heating module so that said aqueous-based heat transfer fluid entering said GHE installation is maintained substantially constant during predetermined time intervals during GHE performance testing;
a data logger/recorder for recording data representation of the temperature and pressure of aqueous-based heat transfer fluid entering and existing said GHE installation during performance testing operations; and
a computer system interfaced with said data logger/recorder and running an enthalpy-based spreadsheet GHE performance calculator program for processing said data recorded by said data logger/recorder.

12. The mobile-wireless GPS-tracking GHE performance test instrumentation network of claim 11, which further comprises temperature and pressure transducers and mass/volume flow rate meter, and the various subcomponents of each said GHE installation under performance testing.

13. The mobile-wireless enthalpy-based GHE performance test instrumentation system of claim 12, which further comprises:
a RF transceiver station to receive measured inlet and outlet temperatures and pressures and mass flow rates through the ground loop; and
a remote database server, operably connected to the infrastructure of the Internet, for processing collected data and computing performance measures so that one or more Web-enabled remote client computers can access such performance data and generated reports for ground loop engineering purposes.

14-24. (canceled)

25. The mobile-wireless GPS-tracking GHE performance test instrumentation network of claim 13, which further comprises: a centralized data logging and recording station, and accessible by a remote database server and a plurality of client systems supporting Web-based communication interfaces.

26-38. (canceled)
